(19) United States
(12) Patent Application Publication
(10) Pub. No.: US 2023/0342728 A1
(43) Pub. Date: Oct. 26, 2023

(54) METHOD OF OPERATING A CONTAINER CARRIER TERMINAL

(71) Applicant: Portchain ApS, København K (DK)

(72) Inventors: Michael Lindahl, København K (DK); Anders Olivarius, Frederiksberg C (DK); Thor Thorup, Vedbek (DK); Niels Adam Hedeager Kristiansen, København K (DK)

(73) Assignee: Portchain ApS, København K (DK)

(21) Appl. No.: 18/005,282

(22) PCT Filed: Jul. 9, 2021
(86) PCT No.: PCT/DK2021/050237

§ 371 Date: Jan. 12, 2023

(30) Foreign Application Priority Data
Jul. 13, 2020 (DK) PA 2020 70484

(51) Int. Cl. G06Q 10/20; G06Q 10/0631

(52) U.S. Cl. CPC G06Q 10/20; G06Q 10/06315

(57) ABSTRACT

The invention relates to a method of operating a container carrier terminal, comprising the steps of: providing a container carrier terminal system comprising a model, said model comprising representations of terminal resources and terminal constraints, wherein said terminal resources comprise a plurality of quay cranes; inputting, in said container carrier terminal system a plurality of container carrier entries, each container carrier entry relating to a container carrier and associated with a preliminary terminal resource demand; allocating a respective subset of said terminal resources to each container carrier entry to obtain a preliminary terminal resource plan, wherein said step of allocating terminal resources comprises automatically validating said allocated terminal resources, wherein the validating includes automatically establishing whether the allocated terminal resources comply with said preliminary terminal resource demand and said terminal constraints, wherein said terminal constraints comprises maintenance.

### FIELD OF THE INVENTION

The present invention relates to a container carrier terminal system, a container carrier terminal, and a method of operating a container carrier terminal.

### BACKGROUND OF THE INVENTION

Operating a container carrier terminal is a complex task. Such terminals are well-known and spread around the world located at relevant locations so as to facilitate container carried distribution of goods around the world. Over the last many years, container carriers have increased in size and, alongside this, the entire logistic system associated with these carriers has developed in size, capacity and complexity. A result of this development is that the available container terminals need to be operated in a way that allows container carriers to arrive and depart from the terminals in a manner where conflicting port calls are kept at a minimum, and where quayside operations in terminals to move containers to and from the carriers are performed with minimal delays. Different management tools have been provided to facilitate this. Such tools include both long term and short-term execution tools. A challenge related to such known tools is that such tools lack the technical ability to assist the planning and execution in an efficient way.

Since operations of container carrier terminals relate to use of heavy machinery which at driven to run as efficiently as possible, breakdowns and maintenance of critical terminal resources, such as quay crane are essential to ensure effective operations. However, since operations at terminals are typically follow a complex schedule, maintenance can be challenging to integrate, without disturbing operations.

### SUMMARY OF THE INVENTION

The inventors have identified the above-mentioned problems and challenges related to container carrier terminals, and subsequently made the below-described invention which may improve operations.

The invention relates to a method of operating a container carrier terminal, comprising the steps of:
providing a container carrier terminal system comprising a model of said container carrier terminal executed on data processing equipment, said model comprising representations of terminal resources and terminal constraints relating to said terminal resources,
wherein said terminal resources comprise a plurality of quay cranes;
said representations of terminal resources including representations of said plurality of quay cranes;
inputting, in said container carrier terminal system a plurality of container carrier entries, each container carrier entry relating to a container carrier and associated with a preliminary terminal resource demand including a tentative arrival time, wherein said tentative arrival time is indicative of arrival of said container carrier to said container carrier terminal;
allocating a respective subset of said terminal resources to each container carrier entry of said plurality of container carrier entries to obtain a preliminary terminal resource plan of allocated terminal resources, wherein said step of allocating terminal resources comprises automatically validating said allocated terminal resources of the container carrier entries,
the allocated terminal resources including a subset of said plurality of quay cranes,
wherein the validating includes automatically establishing whether the allocated terminal resources of the container carrier entries comply with said terminal constraints and said preliminary terminal resource demand associated with said plurality of container carrier entries, wherein said terminal constraints comprises maintenance.

Creating a terminal resource plan, e.g. a berth plan, is a very complex task since there are multiple resources that need to be deployed, e.g. quays, quay cranes and gangs among several container carriers in order to meet the demands of container carriers. Even for a single container carrier berthing at a quay of a container carrier terminal and being serviced by two quay cranes there are thousands of possible ways of deploying the resources to the container carrier; the two quay cranes may begin loading/unloading of shipping containers at different times, they may operate at different productivity rates (e.g. gross moves per hour), and they may be allocated to the container carrier for different time durations. For a typical container carrier terminal comprising more than two quay cranes and berthing positions for multiple container carriers, the complexity of the planning increases significantly and the number of ways of allocating resources among the container carriers increases so much that not even the most skilled planner would, in practice, be able to identify which way of allocating resources is the optimal, i.e. which plan has the highest utilization rate of the terminal resources. This complexity of planning typically results in an inefficient allocation of resources short term, but also a short planning horizon since the complexity of planning increases dramatically when planning horizon increases, also causing that most planning is operational and short-sighted. Typically, even skilled planners are not able to reach high utilization rates even for short-term planning of a few days, such as one or two days.

A crucial factor, both in long-term and short-term planning, is maintenance. Maintenance of terminal resources is crucial for ensuring stable and efficient operation. Well-timed and well-planned maintenance of terminal resources such as quay cranes may ensure that the risk of breakdown is minimized. And whenever breakdowns do happen, rapid planning of maintenance of redistribution of resources may be required.

In complex planning environments such as container carrier terminals, both short-term and long-term planning of maintenance is challenging to implement. Resources such as cranes are almost always in demand, and if breakdowns occur, redistribution of resources is complicated, since terminal resources may already be allocated.

By incorporating maintenance as a constraint upon which allocated terminal resources are validated, the invention permits that maintenance adhere to allocation of terminal resources, and vice versa.

The above-described method according to the present invention may be advantageous for several other reasons. First, by allocating terminal resources based on a preliminary terminal resource demand, a preliminary terminal resource plan may be provided, extending far into the future. As the validation or even the distribution of terminal resources is performed automatically, e.g. by the container carrier terminal system, a high utilization rate of terminal resources may be achieved even on a long-term basis. The combination of long-term planning based on preliminary terminal resource demand and the automatic validation of terminal resources may give a berth planner additional tools for proactive planning of the operations of the container carrier terminal. Particularly, the planning can take maintenance of terminal resources such as quay cranes into account. As an example, it may be possible for the berth planner, due to the long planning horizon, to contact a container carrier e.g. two weeks in advance of its tentative arrival time and ask the container carrier to arrive at the container carrier terminal later than planned without this affecting the carriers departure time. This is possible since the allocation of terminal resources has been performed well in advance of the carrier's tentative arrival time, and since the berth planner may be assured that the preliminary terminal resource plan is an operational plan which may be relied upon. Further, since the preliminary terminal resource plan considers maintenance, the preliminary terminal resource plan is more reliable, than if maintenance was not considered, since maintenance may reduce risk of breakdown. Achieving a high utilization rate is generally advantageous in that the berthing times may be reduced for the container carriers. In practice this means that a container carrier may arrive later to and/or depart earlier from the container carrier terminal due to optimal deployment of resources. The more time a carrier has at its disposal to sail a route from one container carrier terminal to the next container carrier terminal the slower the carrier may sail across sea, and the less ship oil needs to be burned resulting in less emission of greenhouse gases and other pollutants, such as sulfur- and nitrogen containing gases.

The above-described method according to the present invention may further be advantageous in that changes to the terminal resource plan or terminal constraints made in a short-term time horizon, such as maintenance associated with breakdown, may be made with respect to the already established long-term preliminary terminal resource plan.

A further advantage of the above-described method according to the present invention may be that the long-term planning of resources, as described above, gives a berth planner a better indication of the utilization of terminal resources over a long time and this may enable the planner to schedule the maintenance, such as maintenance of quay cranes, well in advance and with respect to expected utilization of the terminal resources. This ensures that the maintenance may be scheduled for the most optimal point in time where the effect of the maintenance has the least influence of the operation of the container carrier terminal. Scheduling of maintenance, such as maintenance of a quay crane may be problematic if not done with respect to long-term resource allocation since otherwise the scheduled time of maintenance may fall at a critical time where there is a high demand on crane capacity and the crane may furthermore physically hinder movements of adjacent cranes thus rendering a significant quay length unusable for berthing of container carriers.

It should be noted that a container carrier entry relates to a container carrier and that such container carrier at the final execution of the entry is specified to be a specific carrier with known ID, e.g. a name and known properties, such as length. At the start of inputting the container carrier entry, the carrier may indeed be completely defined in a respective data record, but it may also be represented as a dummy carrier having certain properties, e.g. including intended number of containers to be offloaded, expected length etc. This could e.g. happen during a pro-forma planning one time a year. When the carrier is specifically identified the entry may be updated accordingly.

It should further be noted that the inputting, in said container carrier terminal system, typically via an input, of a plurality of container carrier entries may be performed on an entry-by-entry basis or as groups of entries. The container carrier system may of course, when initially activated, receive a complete set of entries at the given time, but from there the container carrier terminal system may typically be updated e.g. when new entries are input, when entries are to be modified or when terminal resources and the associated constraints are modified, intentionally or non-intentionally and when this change needs to be reflected in the container carrier terminal system.

It should also be noted that the step of automatically validating allocated terminal resources with respect to an individual and/or several container carrier entries may be invoked automatically upon occurrence of a relevant triggering event. Such a triggering event in the present context does also include a manual triggering of the automatic validation, e.g. via a user interface related to the terminal resource system. The triggering event may also relate to planning or scheduling maintenance in the container carrier terminal system. Thus, the validation may comprise validating whether the maintenance complies with a terminal resource plan.

It should moreover be noted that in some embodiments, the validating of whether allocated terminal resources of the container carrier entries comply with said preliminary terminal resource demand associated with said plurality of container carrier entries and said terminal constraints preferably include an automatic determination of whether the demand as expressed via the entry can be met in the sense the allocated terminal resources of the individual entry can in fact do the job and do it without conflicting with allocated terminal resources of other entries. Examples of which constraints to impose in such a validation is given below.

It should additionally be noted that the allocation and validation of the terminal resources may be advantageous as a technical means for optimizing and smoothing the use of resources during berthing even in spite of the fact that an optimized plan could potentially result in a plan which is more vulnerable to the real-world fact that more than 50% of container carriers are delayed when compared to the originally intended ETA. Taking maintenance into account may optimize usage of resources even further.

It should furthermore be noted that the term “preliminary” in relation to the preliminary terminal resource demand and in relation to the preliminary terminal resource plan may be associated with a first-time entry of a container carrier entry, i.e. a port call. The resulting terminal resource plan is preliminary as seen from the point of view of the new entry. As seen from the point of view of all other entries already included in the terminal resource plan, the preliminary terminal resource plan may simply be an updated terminal resource plan.

A preliminary terminal resource plan may be used as basis for actually operating the container carrier terminal. Alternatively, a preliminary terminal resource plan may thus be referred to as a preparatory terminal resource plan, a trial terminal resource plan, or simply a terminal resource plan. Similarly, a preliminary terminal resource demand may be referred to as a preparatory terminal resource demand, a trial terminal resource demand, or simply a terminal resource demand.

A basic point to make in the present context is that an entry at a very early stage, namely at the time of input into the container carrier terminal system, should be allocated terminal resources which in principle should be operable even if the time of execution, i.e. the time of the effective port call, is in the far future, e.g. weeks or months before execution.

It should also be noted that the invention may work with existing conventional long-term management systems as long as the preliminary resource demand is validated with respect to allocated resources.

Further, note that the invention is not restricted to a particular sequence of providing the maintenance as a constraint and allocating terminal resources. In some embodiments, maintenance is a constraint prior to the allocation. In some embodiments, maintenance is added as a constraint after the allocation. In some embodiments, maintenance is added at least partly simultaneously with allocating terminal resources.

In the present disclosure, a “container carrier” is understood as a ship, freighter, or vessel specially designed and equipped for carrying and transporting containerized cargo, e.g. shipping containers or intermodal containers, across water. A container carrier may therefore also be referred to as a container ship. In the context of the present invention, a “container carrier terminal” should be understood as an intermediate destination facility that enables shipping containers to switch methods of transport en route to their final destination. Shipping containers are transported on water by container carriers and shipped to a container carrier terminal for unloading before being transported further by land-based transportation such as by trains and trucks to their final destination. Likewise, the container carrier terminal may facilitate a switch from land-based transportation to container carrier in the transport of shipping containers. The container carrier terminal may comprise one or more quays for berthing of container carriers, one or more quay cranes for loading/unloading of shipping containers, one or more prime movers for transport of shipping containers within the container carrier terminal, a container yard for temporary storage of shipping containers.

In the present disclosure, a “container carrier terminal system” is understood as a computer-implemented system for managing terminal resources relating to berthing of container carriers at a container carrier terminal. By computer-implemented is understood that the container carrier entries and the model comprising terminal resources and terminal constraints are stored in digital form in the same or different locations and computer storage types, and that one or more processors are provided to carry out at least one or more steps of the method according to the present invention, such as the step of automatically validating terminal resources, including quay cranes, to the plurality of container carrier entries. In various embodiments, the container carrier terminal system further comprises a graphical user interface (GUI), hence also computer-implemented, i.e. providing a graphical view to a user by display means, and receiving input from the user by any ordinary or special computer input means. The graphical user interface of the container carrier terminal system may thus be regarded as an interface between the system and a user or operator of the system, e.g. a berth planner. The container carrier terminal system may be implemented and running on a single computer, or have different modules separated to different computers, e.g. one computer running an allocation engine/optimization engine, and another computer running the graphical user interface. The container carrier terminal system may be using distributed processing, for example cloud-based processing. The storage of data may be at separate data servers, e.g. cloud-based, or be local in connection with the processing computers. A graphical user interface may for example display representations of container carrier entries and/or terminal resources, such as representations of quay cranes and the quay. It may further display allocation of terminal resources (or their representations) to the container carrier entries. It may also display a representation of the maintenance, e.g. in association with a representation of a terminal resource associated with the maintenance.

The container carrier terminal system may be used, by e.g. container carrier terminal planner, as scheduling assistance tool for berthing of container carriers and operations relating to loading and/or unloading of shipping containers on/off container carriers. The container carrier terminal system may be distributed on one or more computer servers, and the container carrier terminal system may be a cloud-based system.

In the present disclosure, a “model” is understood as a computer-implemented representation of the container carrier terminal. The model may comprise various representations of container carrier terminal resources and container carrier terminal constraints, which in the below is referred to as terminal resources and terminal constraints respectively. By modeling the terminal resources and terminal constraints of the container carrier terminal it may be possible by use of the model to allocate terminal resources to container carriers before the container carriers arrive at the container carrier terminal.

In the present disclosure, “a terminal resource” is understood as a deployable asset, such as quay cranes, of the container carrier terminal which serves in the operation of the container carrier terminal, such as in loading/unloading of shipping containers to/from container carriers berthing at the container carrier terminal. The terminal resources may comprise:
Pilots—By a “pilot” is understood a person who maneuvers ships through dangerous or congested waters, such as harbors or river mouths. The pilot is a navigational expert possessing knowledge of the particular waterway such as its depth, currents, and hazards. The pilot may thus be experienced in maneuvering a container carrier through the waterways surrounding the container carrier terminal and safely berth the ship at a position along a quay of the container carrier terminal. The pilot may also be referred to as a maritime pilot, marine pilot, harbor pilot, port pilot or a ship pilot.
Tugboats—By a “tugboat” is understood any kind of vessel that maneuvers other vessels by pushing or pulling them either by direct contact or by means of a tow line. Tugboats typically move vessels, such as container carriers in or at a container carrier terminal, that are restricted in their ability to maneuver on their own.
Quay length—By a “quay length” is understood a length of section of a quay of a container carrier terminal or a length of an entire quay of a container carrier terminal. By a quay is understood a structure on the shore-side of a container carrier terminal where container carriers may dock/berth to load and unload shipping containers. A container carrier terminal may comprise one or more quays. A quay length may further be understood as a section of a quay, having a length, and which may be allocated to container carriers. As an example, a container carrier may have a length of 398 meters, and therefore at least a quay length, or quay section, of 398 meters must be allocated in order to berth the container carrier at the container carrier terminal. In practice a quay length of more than 398 meters may be allocated in order to make room for maneuvering of the container carrier during berthing at the terminal, and also an additional safety distance between container carriers may be required.
Bollards—By a “bollard” is understood any kind of structure capable of anchoring a container carrier at a quay. The bollards may be distributed along the quay and may also define specific berthing positions along the quay where container carriers may berth.
Quay cranes—By a “quay crane” is understood as a quayside (or dockside) crane for loading/unloading shipping containers to/from container carriers. The quay crane may therefore also be referred to as a ship-to-shore crane. The quay crane may be configured to move along rail tracks along a quay side of the container carrier terminal such that the quay crane may be positioned at necessary positions relative to the berthing container carrier for the loading/unloading of shipping containers. The quay crane may be operated by a dedicated gang of workers or alternatively be an automatically operated quay crane, e.g. an autonomous quay crane. The quay crane comprises a crane boom for reaching in over a berthing carrier to perform loading/unloading operations of shipping containers. The boom may be hinged to allow passage of large container carriers beneath or it may be fixed to reduce airspace being taken up. A quay crane may also be referred to as a ship-to-shore crane or a container-handling gentry crane.
Prime movers—By a “prime mover” is understood any kind of vehicle capable of transporting a shipping container from one place to another at the container carrier terminal. The prime mover may be a terminal truck. As an example, the prime mover may be a manually operated terminal truck or a fully autonomous terminal truck.
Straddle carrier—By a “straddle carrier” is understood a container-carrying vehicle that carries its load underneath by “straddling” it, rather than carrying it on top like a conventional truck. The straddle carrier is able to load and unload containers without the assistance of cranes or forklifts. As an example, the straddle carrier may be a manually operated or be fully autonomous.
Stacking crane—By a “stacking crane” is understood a gantry-like crane arranged to lift shipping containers and place/stack the containers at various positions and heights at the yard. The stacking crane may move around on the yard of the container carrier terminal by moving along rails.
Gangs—By a “gang” is understood a unit of workers which together as a team perform an operation relating to loading/unloading of shipping containers. The gang may be a dedicated quay crane gang specifically trained for operating a quay crane, e.g. a specific quay crane of a container carrier terminal. The gangs may work in shifts of e.g. 8 hours

In the present disclosure, a “terminal constraint” may be understood as an operational constraint of the container carrier terminal. The terminal constraint may thus comprise constraints relating to the deployment of terminal resources; however, the terminal constraints may also relate to physical constraints/restrictions of the container carrier terminal such as the physical layout of the container carrier terminal. The terminal constraints may comprise:
Quay depth—By “quay depth” is understood the distance between the water level at the quay and the seabed beneath. The quay depth may vary along the length of the quay.
Container carrier terminal entry restrictions—By a “container carrier terminal entry restriction” is understood physical limitations relating to the entry point(s) of the container terminal. As an example, a container carrier berthing at a container carrier terminal may have to sail along very specific sailing routes into the quay due to various hazards in the environment surrounding the terminal or due to depth restrictions. It may be for example that the entry route to the container carrier terminal from sea passes through one or more canals or other width restrictions imposed by the landscape or urban environment surrounding the container carrier terminal, and therefore the entry route may be congested due to the presence of other container carriers. Thus, the container carrier terminal entry restriction may be a time-varying restriction due to congestion of container carriers being dependent on time or even due to tides which over the course of a day may change the availability of the container carrier terminal.
Maintenance—various elements in container carrier terminals may regularly or abruptly require maintenance. Such various elements may for example be the terminal resources, for example quay cranes. In typical container terminals, maintenance cannot be avoided. Particularly for quay cranes, maintenance can render the utilization rate of the quay cranes inefficient. The quay crane is a vital asset to a container carrier terminal as it performs the key critical operations of the terminal, namely loading, unloading, and/or redistribution of shipping containers. As global container traffic steadily increases the workload of the quay cranes also increases, therefore high utilization rates of quay cranes may be desired. A high utilization rate of a quay cranes puts significant stresses on components of the quay cranes (motors, gears, structural components, etc.), and over time these components may degrade or in the worst case fail to such an extent that operations of the quay crane is no longer possible. Alternatively, a quay crane may have to be upgraded to meet new terminal resource demands imposed by ever increasing in size container carriers. As an example, the quay crane may need to be raised in height to accommodate larger ships, or the boom of the crane may need to be enlarged. In other words, a quay crane will need some kind of maintenance from time to time and such maintenance naturally imposes downtime of the quay crane. Downtime of the quay crane due to maintenance is thus a constraint which have to be complied with in the allocation of terminal resources. Even through quay crane maintenance pose a significant obstruction for efficiently operating a container carrier terminal, other maintenance may also be relevant for efficiency, such as quay maintenance, bollard maintenance, dredging maintenance, and cleaning maintenance.
Quay cranes may not cross each other along the quay. Typically, quay cranes are arranged to move on rail-like tracks along the quay, and such a track may service more than one quay crane. In such a situation it is clear that quay cranes cannot pass each other on the same set of tracks.
Quay cranes may only be allocated to container carriers if the reach of the quay crane is sufficient for the container operation required.
Gang availability—when operating a quay crane a gang is typically required.

The number of gangs available at any given time may be a bottleneck to the operations of the container carrier terminal. As an example, it may not be possible to allocate all quay cranes of a terminal if there is not enough available gangs. The gang availability may be reflected in gang schedules, such as schedules for dayshifts and nightshifts.

Note that terminal constraint may not necessarily fully restrict allocation of terminal resources. In some embodiments, the container carrier terminal system is capable of allowing allocation of terminal resources which do not comply with terminal constraints and resource demands, but via the validation, a user may be notified when an allocation of a resource plan does not comply with constraints and/or demands. Or a maintenance planning algorithm may aim to allocate resources to comply with constraints and/or demands, but if the algorithm cannot find solutions which fully comply, it may permit at least partial non-compliance. As a part of the iterative process of allocation, the maintenance planning algorithm may then regularly perform validation to establish whether (or to which degree) allocated terminal resources comply with the resource demand and terminal constraints.

In the present disclosure, a “container carrier entry” is understood as a data package representing a respective container carrier in the container carrier terminal system. The container carrier entry may be a port call. The container carrier entry comprises or links to data relevant to the berthing of the container carrier at the container carrier terminal. Such data may be found in container carrier data records. The data may comprise a tentative arrival time, a tentative departure time, a berthing position along a quay of the container carrier terminal, a cargo capacity to be unloaded from the container carrier at the container carrier terminal, a cargo capacity to be loaded onto the container carrier at the container carrier terminal, and a cargo capacity to be redistributed on the container carrier. A cargo capacity may refer to a number of shipping containers or a number of TEU's (twenty-foot equivalent unit). The data may further comprise details on the locations of the cargo capacity to be unloaded/redistributed and details on the locations where containers to be loaded are to be placed on the container carrier. The container carrier entry may further relate to specifics regarding the container carrier itself, such as the length, width, height and depth/draft of the container carrier. The container carrier entry may further comprise data indicative of previous port calls or future port calls of the container carrier with respect to the berthing of the container carrier at the container carrier terminal. By a port call is understood an intermediate stop at a terminal for a container carrier on its scheduled journey. In this regard, a container carrier entry may also be associated with a port call.

In the present disclosure, a “tentative arrival time” is understood as an arrival time of the container carrier in the container carrier terminal. The tentative arrival time may refer to the arrival time of the container carrier at its final berthing position along a quay of the container carrier terminal or it may refer to the arrival time of the container carrier at an entry to the container carrier terminal from which the container carrier may need to maneuver by its own power, or with the help from one or more tugboats, to its final berthing position. The tentative arrival time may also be referred to as an expected time of arrival (ETA) or a requested arrival time. As an example, a container on its way to the container carrier terminal may request a certain arrival time, which may be agreed to by a berth planner of the container carrier terminal, and this arrival time, which is agreed upon, may be an example of a tentative arrival time.

Similarly, the container carrier entry may comprise a tentative departure time. The tentative departure time is understood as a departure time of the container carrier from the container carrier terminal. The tentative arrival time may also be referred to as an expected time of departure (ETD) or a requested departure time. As an example, a container on its way to the container carrier terminal may request a certain departure time, which may be agreed to by a berth planner of the container carrier terminal, and this departure time, which is agreed upon, may be an example of the tentative departure time.

In the present disclosure, a “preliminary terminal resource demand” is understood as demands of the container carrier which the container carrier terminal must strive towards fulfilling through its allocation of terminal resources. The preliminary terminal resource demand may comprise a certain number of tugboats and/or pilots, the number of shipping containers to be loaded, the number of containers to be unloaded, and the number of containers to be redistributed once the container carrier is berthing at the container carrier terminal. Since, a tentative arrival time and departure time of the container carrier is already established prior to its arrival in the terminal, these container-related preliminary resource demands may also be translated into a number of container moves to be performed per unit of time. The preliminary terminal resource demand may also relate to the specifications of the container carrier, i.e. the length, width, height and depth of the container carrier, or a preferred side of berthing, i.e. port side or starboard. As an example, a container carrier having a depth under sea level, i.e. the distance from container carriers keel and the waterline of the container carrier also known as the draft of the container carrier, of 15 meters, the container carrier terminal must be able to provide a section of a quay having a depth surpassing this draft. As suggested by the name, the preliminary terminal resource demand represents a terminal resource demand that may be changed at a later stage. A shipping company operating a container carrier may have a contractual agreement with the container carrier terminal that a certain number of shipping containers are to be loaded/unloaded at the container carrier terminal every time the container carrier is berthing and this may be reflected in the preliminary terminal resource demand. Thus, well in advance of the container carrier berthing at the container carrier terminal there may be an agreement on how many containers to be moved, however, in practice, as the container carrier is on its way from a previous port call to the container carrier terminal for berthing the actual amount of containers to be moved may be known, and this may be a different number from the number in the contractual agreement. Changes between such a present terminal resource demand and a preliminary terminal resource demand may be reflected in an updated terminal resource demand. By an “updated terminal resource demand” is therefore understood the most up-to-date knowledge of the resource demands of a container carrier destined for berth at the container carrier terminal.

In the present disclosure, a “preliminary terminal resource plan” is understood as a plan of allocated terminal resources. The plan is preliminary in the sense that the plan is provided on the basis of a distribution of terminal resources complying with preliminary terminal resource demands. The preliminary terminal resource plan may be regarded as a schedule of the terminal resources. For example, the preliminary terminal resource plan may show what quay cranes have been allocated to what container carriers and for which time periods. Furthermore, the preliminary terminal resource plan may also comprise schedules of other terminal resources, such as which quay positions are allocated to which container carriers, i.e. where the container carriers are scheduled to berth at the quay, as well as schedules of gangs such as gangs working on dayshifts and/or nightshifts. As the name suggests, the preliminary terminal resource plan may be updated in the future when updated terminal resource demands are provided. However, note that embodiments of the invention are not restricted to updating the preliminary terminal resource plan. The preliminary terminal resource plan may for example be executed to operate the container carrier terminal and its terminal resources according to that plan.

In the present disclosure, “allocating” may be understood as the act of designating/appointing/assigning a terminal resource, within the model, to a container carrier entry relating to a container carrier expected to arrive in the container carrier terminal at some point in the future. As an example, a container carrier is expected to arrive at the container carrier terminal for berthing two weeks out in the future, thus a container carrier entry, representing that container carrier, comprising a tentative arrival time two weeks out in the future is present in the container carrier terminal system. The preliminary terminal resource demand associated with this container carrier entry may specify a specific number of shipping containers to be loaded, unloaded, and/or redistributed (i.e. moved from one position on the container carrier to another position on the container carrier), and in order to meet this demand in between the tentative arrival time and the tentative departure time, a certain number of quay cranes may be needed. Thus, well in advance of the tentative arrival time, e.g. two weeks prior, specific quay cranes of the container carrier terminal may be allocated, in the container carrier terminal system, to the container carrier entry in order to meet the terminal resource demand. Since the container carrier terminal typically handles/services more than one container carrier at any given point in time, this allocation of resources is performed with respect not only to the preliminary terminal resource demand of a single container carrier entry but also with respect to preliminary terminal resource demands of other container carriers, as well as with respect to terminal restrictions such as number of quay cranes available and possibly also quay crane gangs available for operation of quay cranes. Thus, in practice a subset of terminal resources is allocated to each container carrier entry, this subset may include some or all available terminal resources.

In the present disclosure, “automatically validating” is understood as a process being carried out in relation to the allocation of terminal resources, for example with each change or group of changes to the updated or preliminary terminal resource plan, or at occurrence of changes in the demands, constraints, or entries, at regular or irregular time intervals, etc. The validation being automatic means that it is computer-implemented and provides a result automatically. The triggering of the automatic validation may be automatic as part of the allocation, for example automatically carried out each time a change occurs, and/or be user-triggerable, e.g. upon a user requesting to validate the current terminal resource plan, or for example triggered by a user interacting with a user interface, e.g. using a user interface to modify demands, constraints, container carrier entries and/or terminal resources.

The automatic validation may for example include establishing whether the allocated resources match the demanded resources, e.g. with respect to a tentative arrival time or loading/unloading amount, for each container carrier entry. The automatic validation may for example, in addition or instead, include establishing whether the allocated resources match the terminal constraints, e.g. with respect to maintenance or crane availability. In case the validation shows mismatch of either demands or constraints with the allocated resources, it may not be possible for the terminal to provide the agreed or expected service to the container carrier, for example unloading an estimated number of containers within an estimated time frame because the allocated number of cranes cannot move that amount of containers in that time frame, or the allocated number of cranes do not exist or are not available on the quay in that time frame. In an embodiment of the invention a demand may be understood as a request implying requirement of a certain demand for a terminal capacity, e.g. in relation to container moves and berth location, and in this embodiment the validation is automatically performed in relation to the requested capacity and how the terminal resources can actually perform in relation to such requested capacity.

The automatic allocation and automatic validation may be carried out sequentially, for example performing a validation after the allocation, or performing a new allocation after a validation has indicated challenges with the current plan. The allocation and validation may also be carried out iteratively, in particular when major changes of demands or constraints have been entered and validation of the previous terminal resource plan therefor fails on several accounts. In an embodiment the validation is an integrated part of the allocation so each consideration in the allocation is validated before applied to the plan, or so that all possibilities are validated and the option with best validation result is applied to the plan. In an embodiment, the allocation and validation is carried out regularly to keep the preliminary terminal resource plan up to date. It may be advantageous to allow the allocation step to produce a preliminary terminal resource plan several weeks or months ahead on the basis of what current information and estimation is available, even if the plan will thereby most probably be incomplete and flawed, in order to at least have a direction and preliminary knowledge about future capacity of the terminal, and to have a starting point for fine tuning the plan as better information comes in. In such an embodiment it may further be advantageous to utilize the automatic validation step to determine the quality of the preliminary terminal resource plan in terms of for example feasibility or efficiency, and on the basis of the most current data (demands, constraints, entries) which may be different from the data that the allocation was carried out for.

In the present disclosure, an “updated terminal resource plan” is understood as a terminal resource plan reflecting allocations of terminal resources that are based on updated terminal resource demand, for example a changed tentative arrival time or container loading amount for a container carrier. The updated terminal resource plan may advantageously be provided for use in terminal systems and/or by terminal resources.

In embodiments of the invention, said maintenance is associated with a maintenance time period of said preliminary terminal resource plan.

A maintenance time period may have a maintenance start time and a maintenance end time, and thus implicitly also a maintenance duration. Such a maintenance time period of a constraint may permit an accurate and precise allocation of terminal resources.

In embodiments of the invention, said maintenance is related to maintenance of one or more of said terminal resources.

In embodiments of the invention, said method comprises a step of planning said maintenance.

By having an explicit step of planning the maintenance, it may for example be planned with respect to other constraints, container carrier entries, terminal resources, the preliminary terminal resource plan, or any combination thereof. It may further be based on input from various personnel of the container carrier terminal, such as gangs, operators, berth planners, engineers, or any combination thereof.

Explicitly palling the maintenance may thus ensure maintenance which comply with various demands, constraints, resources, and/or personnel of the container carrier terminal, which is advantageous.

In embodiments of the invention, said step of planning said maintenance comprises allocating said maintenance to said maintenance time period.

In embodiments of the invention, said step of planning said maintenance is performed at least partly simultaneously with said step of allocating a respective subset of said terminal resources.

By performing these two steps simultaneously, flexibility and efficiency of both the maintenance and the allocation is terminal resources may be permitted, which is advantageous.

In embodiments of the invention, said step of planning said maintenance is performed prior to said step of allocating a respective subset of said terminal resources.

Accordingly, the subset of terminal resources may be allocated with respect to the maintenance, which is advantageous.

In embodiments of the invention, said step of planning said maintenance is performed after said step of allocating a respective subset of said terminal resources.

Accordingly, the maintenance may be planned with respect to the preliminary terminal resource plan, which is advantageous.

In embodiments of the invention, said step of planning said maintenance is based on maintenance planning constraints.

In embodiments of the invention, said maintenance planning constraints relate to timing constraints.

In embodiments of the invention, said timing constraints are at least partly determined by said allocated terminal resources.

In embodiments of the invention, said maintenance planning constraints are at least partly user-definable.

Maintenance planning constraints may at least partly constraint the maintenance and/or planning of the maintenance. Maintenance planning constraints may for example be defined by terminal resources, optionally through a resource plan of the terminal resources. Such a plan may define when and where resources are allocated, and hence constraint when a particular resource is idle for undergoing maintenance.

A user, such as a berth planner, may also manually add maintenance constraints into the container carrier terminal system, which can then be used for automatic, semiautomatic, or manual planning of maintenance. By providing such control to a berth planner, that berth planner can personally assess relevant factors. For example, if a particular terminal resource requires maintenance (e.g. crane or quay), the maintenance may be planned based on when this resource is not allocated for usage. Or if a maintenance team is only available within certain time durations.

In embodiments of the invention, said step of planning said maintenance is performed automatically.

It may for example be performed by the container carrier terminal system, e.g. as part of or independently from an optimization routine. Such automatic planning may be based on maintenance planning constraints.

Typically, maintenance may be planned by a berth planner through a graphical user interface. For example, both maintenance and allocation of terminal resources may be visualized, such that they can be compared and adjusted relative to each other. Such a user interface may further explicitly or implicitly display maintenance planning constraints. An implicit display may for example be through displaying relevant terminal resources such as allocation of quay cranes.

In embodiments of the invention, said method comprises a step of receiving a maintenance request, wherein said step of planning said maintenance is based on said maintenance request.

A maintenance request may be provided by personnel, such as an engineering team, of the container carrier terminal. Such personnel may identify a potential problem with a terminal resource, which will require maintenance. Or perhaps preventive maintenance or inspection maintenance is required. In either case, a maintenance request may be sent to the container carrier terminal system, which a berth planner can then address.

A maintenance request may for example pinpoint a terminal resource which requires maintenance, and, optionally, provide one or more suggested times spans in which the maintenance can be performed.

Such a request may then be accepted, rejected, or answered with an alternative maintenance suggestion. Such an action may either be performed by a berth planner operating the container carrier terminal system, or optionally by the container carrier terminal system itself. The acceptance of a request may typically be associated with planning the maintenance in the container carrier terminal system. For example, upon acceptance, the maintenance is automatically planned, or upon receiving the request, the berth planner may manually plan the maintenance in the container carrier terminal system in relation to accepting the request. An alternative maintenance may for example at least include an alternative proposal to an originally requested time period.

In embodiments of the invention, said maintenance request is associated with a requested time period, wherein said maintenance time period is based on said requested time period.

In embodiments of the invention, said maintenance request is related to one or more of said terminal resources.

In embodiments of the invention, said maintenance request is submitted digitally by a terminal operator of said container carrier terminal.

A terminal operator is typically a different person than a berth planner managing a container carrier terminal system. E.g., the operator may in practice operate terminal resources such as quay cranes (e.g. a crane operator). A terminal operator may also be an engineer, such as a maintenance engineer, and/or a part of a terminal engineering team.

In embodiments of the invention, said maintenance request further comprises a repetition request.

In embodiments of the invention, said step of planning said maintenance comprises regularly repeating said maintenance in said preliminary terminal resource plan.

In embodiments of the invention, said step of planning said maintenance comprises regularly repeating said maintenance in said preliminary terminal resource plan based on said repetition request.

In some circumstances, planning regular maintenance may be advantageous, for example planning inspection maintenance of a particular quay crane every three months. Optionally, a maintenance request may request such regular maintenance.

Planning regular maintenance may permit an even more efficient utilization of container terminal resources.

In embodiments of the invention, said maintenance is acute breakdown maintenance.

In some situations, a terminal resource such as a quay crane may suddenly break down, for example such that it cannot be operated further. In such an acute breakdown case, invoking maintenance as a terminal constraint in a container carrier terminal system may permit a rapid validation or reallocation or resources according to such a newly introduced terminal constraint. For example, upon a quay crane breakdown, the remaining quay cranes can be redistributed among container carrier entries to inherit the crane operations of the broken quay crane while minimizing or even avoiding delays of container carriers.

In some embodiments, the container carrier terminal system may automatically provide suggestions of alternative resource allocations which can aid to comply with a resource demand as well as the maintenance. Or alternatively, a container carrier terminal system may simply automatically establish an optimized resource plan based on the maintenance.

In some exemplary situations, a breakdown may occur, in which maintenance is not immediately planned and/or executed. In such a situation, the terminal resource which undergoes the breakdown may be inoperable. In some embodiments, such a resource is inoperable in the container carrier terminal system, e.g. until maintenance has been completed. Thus, at least in some embodiments, a constraint in the form of maintenance may constraint allocation of terminal resources outside the time period in which the maintenance takes place.

In embodiments of the invention, said maintenance is preventive maintenance.

Preventive maintenance may for example be used for addressing matters which do not necessarily prevent operation, but which nevertheless may require attention. A quay crane may be unusually noisy during operation, which may indicate that a complication may arise at a later stage if preventive maintenance is not performed. Or a certain part of a quay crane is about to or has exceeded its expected lifetime, upon which replacing this part may be useful for avoiding acute breakdown. Or a part of a quay may have become minorly damaged to a degree where it can still be used, but where it may become further damaged if not maintained.

In embodiments of the invention, said maintenance is inspection maintenance.

Inspection maintenance may for example relate to inspection of a terminal resource. Inspection maintenance may for example involve functional checks and/or service. Thus, inspection maintenance may lead to further maintenance, in case repair or replacement is found necessary. Such further maintenance may be performed successively to the inspection maintenance or planned to be performed at a later time, e.g. via the container carrier terminal system.

Inspection maintenance may optionally be allocated regularly in a preliminary terminal resource plan.

Typically, maintenance may alternatively relate to elements which themselves do not directly affect operations of a container carrier terminal, such as HVAC (e.g. air conditioning) for quay crane operation personnel. Breakdown of such elements may not hinder utilization of terminal resources, but maintenance of such elements may nevertheless temporarily hinder usage of e.g. the quay crane, and is thus relevant for complying with a resource demand.

In embodiments of the invention, said maintenance is corrective maintenance.

Corrective maintenance may for example be performed to identify, isolate, and/or rectify a fault of a terminal resource so that this resource can be restored to an operational condition within the tolerances or limits established for terminal operations.

In embodiments of the invention, said maintenance relates to maintenance of at least some of said terminal resources.

In embodiments of the invention, said maintenance is associated with an inoperative subset of said terminal resources which is inoperative in said container carrier terminal.

In embodiments of the invention, said inoperative subset is associated with an inoperative duration of time.

A subset of terminal resources which require maintenance may be inoperative, for example until maintenance has been performed. The period in which the subset is inoperative may be understood as an inoperative duration of time.

The inoperative duration of time may thus, at least partly, correspond to the maintenance time period. It may also be longer than the maintenance time period.

In embodiments of the invention, a representation of said inoperative subset are at least partly constrained in said container carrier terminal system based on said maintenance.

In embodiments of the invention, a representation of said inoperative subset have more constraints in said model than a representation of an operative subset of said terminal resources.

In embodiments of the invention, a representation of said inoperative subset is non-allocatable in said container carrier terminal system.

Typically, the representation of the inoperative subset is constrained or non-allocatable within the inoperative duration of time.

By having a representation of the inoperative subset being constrained in the container carrier terminal system, e.g. being non-allocatable, it is possible to allocate terminal resources without relying on the inoperative subset, e.g. an inoperative crane, which is advantageous.

In an alternative embodiment, the inoperative subset can be allocated, but the container carrier terminal system provide a notification, such as a warning, in case the inoperative subset has been allocated within the inoperative duration of time.

In embodiments of the invention, said maintenance relates to a first type of said terminal resources, wherein said terminal constraints based on said maintenance apply to a second type of terminal resources in said container carrier terminal system.

If a crane requires maintenance, it may for example constraint whether a container carrier can berth at a particular part of the quay. For example, if a quay crane is immovable, it may restrict mobility of other quay cranes, which in turn may affect where a container carrier should berth for optimal operation. Additionally, a quay crane which is unable to lift its boom, may restrict certain container carriers from berthing at the quay crane, particularly in case of a small quay crane and a large container carrier.

In embodiments of the invention, said maintenance comprises quay crane maintenance.

For example, said maintenance is quay crane maintenance.

In embodiments of the invention, a quay crane representation of said representations of said plurality of quay cranes is associated with said quay crane maintenance.

By having a crane representation in the container carrier terminal system being associated with the quay crane maintenance, it is possible for a berth planner to use this representation for planning maintenance, allocating terminal resources, validating, or any combination thereof.

In embodiments of the invention, said quay crane representation is associated with an indication of operational status.

An indication of operational status may typically indicate whether the given terminal resource can be allocated or not. Further, it may indicate an expected time span in which the resource is inoperable.

An indication of operational status may for example be a user-configurable widget such as a checkbox in a graphical user interface. The checkbox may for example be graphically associated with the quay crane representation.

Having an indication of operational status permits a berth planner or the container carrier terminal system to use the operational status when planning/allocating.

The indication may for example be automatically included when allocating and validating resources.

An indication may thus grant a high degree of control to the berth planner when establishing a resource plan which need to take maintenance into account.

In embodiments of the invention, said quay crane representation is a part of said inoperative subset.

In embodiments of the invention, said quay crane representation is associated with an indication of mobility.

Depending on maintenance and/or breakdown, a quay crane may not be able to move during maintenance or until maintenance has been completed. For example, if rollers, or and engine for rolling has been damaged.

In such a case an indication of mobility may be useful for indicating whether the quay crane in question is able to move or not, and optionally, an expected time span in which it is not able to move.

An indication of mobility may for example be a user-configurable widget such as a checkbox in a graphical user interface. The checkbox may for example be graphically associated with the quay crane representation.

Having an indication of mobility permits a berth planner or the container carrier terminal system to use this information when planning/allocating. Particularly, an immovable quay crane may restrict movability of other quay cranes as these cannot typically cross each other.

The indication of mobility may for example be automatically included when allocating and validating resources.

An indication of mobility may thus grant a high degree of control to the berth planner when establishing a resource plan which need to take maintenance into account.

In embodiments of the invention, said quay crane representation is associated with an indication of boom status.

A boom status may indicate whether the boom of the quay crane is stuck in a lowered or raised position. Typically, the boom of a quay crane (which lift containers to and form the carrier) can be lowered or raised depending on operation. If the boom system breaks, the boom may become stuck in a lowered position, in which case it may potentially block large container carriers from berthing at the position of this quay crane.

Thus, an indication of boom status may be useful for indicating whether the boom of the quay crane in question is able to move away from a lowered position or not, and optionally, an expected time span in which it is not able to move.

An indication of boom status may for example be a user-configurable widget such as a checkbox in a graphical user interface. The checkbox may for example be graphically associated with the quay crane representation.

Having an indication of boom status permits a berth planner or the container carrier terminal system to use this information when planning/allocating.

The indication of boom status may for example be automatically included when allocating and validating resources.

An indication of boom status may thus grant a high degree of control to the berth planner when establishing a resource plan which need to take maintenance into account.

In embodiments of the invention, said quay crane maintenance involves any of wire rope maintenance, boom system maintenance, spreader maintenance, hoist motor maintenance, load cell maintenance, break maintenance, festoon maintenance, roller maintenance, or any combination thereof.

A representation of maintenance (or the quay crane to undergo maintenance) in a graphical user interface may further indicate the type of maintenance and/or the component to receive maintenance, e.g. chosen from the listed options above. Additionally, or alternatively, a terminal resource may also have a representation of breakdown/inoperability, or an indication of breakdown, in a graphical user interface. Such a breakdown representation may at least partly overlap in time with a maintenance representation.

In embodiments of the invention, said maintenance comprises quay maintenance.

In embodiments of the invention, a quay representation of said representations of said terminal resources is associated with said quay maintenance.

By having a quay representation in the container carrier terminal system being associated with the quay maintenance, it is possible for a berth planner to use this representation for planning maintenance, allocating terminal resources, validating, or any combination thereof.

The quay representation may relate to a part of the quay, as typically, only a part of a quay undergoes maintenance.

Optionally, the quay representation may be associated with an indication of operational status.

An indication of operational status may typically indicate whether the given terminal resource can be allocated or not. Further, it may indicate an expected time span in which the resource is inoperable. In case of a quay, a container carrier may not be able to berth at a part of a quay which undergoes maintenance. Or alternatively/additionally, it may indicate whether a quay crane is able to move across this part of the quay, since some maintenance may block such movement.

An indication of operational status may for example be a user-configurable widget such as a checkbox in a graphical user interface. The checkbox may for example be graphically associated with the quay representation.

Having an indication of operational status permits a berth planner or the container carrier terminal system to use the operational status when planning/allocating. The indication may for example be automatically included when allocating and validating resources. An indication may thus grant a high degree of control to the berth planner when establishing a resource plan which need to take maintenance into account.

In embodiments of the invention, said maintenance comprises bollard maintenance.

In embodiments of the invention, a bollard representation of said representations of said terminal resources is associated with said bollard maintenance.

In embodiments of the invention, said bollard representation is associated with an indication of operational status.

In case of a damaged bollard or a bollard undergoing maintenance, a container carrier cannot necessarily be secured at this bollard. Hence, including a bollard representation and an indication of operations status of the associated bollard is useful since it may enable a berth planner to use this representation for planning maintenance, allocating terminal resources, validating, or any combination thereof.

An indication of operational status of a bollard and its representation may typically indicate whether the given terminal resource can be allocated or not. Further, it may indicate an expected time span in which the resource is inoperable.

An indication of operational status may for example be a user-configurable widget such as a checkbox in a graphical user interface. The checkbox may for example be graphically associated with the bollard representation.

Having an indication of operational status permits a berth planner or the container carrier terminal system to use the operational status when planning/allocating. The indication may for example be automatically included when allocating and validating resources. An indication may thus grant a high degree of control to the berth planner when establishing a resource plan which need to take maintenance into account.

In embodiments of the invention, said maintenance comprises dredging maintenance.

In embodiments of the invention, a quay representation of said representations of said terminal resources is associated with said dredging maintenance.

Tides, construction, and general terminal activity may affect the water depth at the quay to a degree where it may hinder larger container carriers from berthing. Thus, dredging maintenance may sometimes be necessary to remove material from the side of the quay to increase water depth sufficiently.

Such maintenance may block berthing for a part of the quay. Accordingly, including a quay representation associated with dredging maintenance and optionally an indication of operations status of the part of the quay is useful since it may enable a berth planner to use this representation for planning maintenance, allocating terminal resources, validating, or any combination thereof. Further, this quay representation may be associated with an indication of operational status.

In embodiments of the invention, said maintenance comprises cleaning maintenance.

In embodiments of the invention, a quay representation of said representations of said terminal resources is associated with said cleaning maintenance.

Cleaning maintenance may for example relate cleaning up after an accident, e.g. oil spillage, an accidental container drop, or a vehicle accident (e.g. a prime mover accident).

Such maintenance may block berthing for a part of the quay. Accordingly, including a quay representation associated with cleaning maintenance and optionally an indication of operations status of the part of the quay is useful since it may enable a berth planner to use this representation for planning maintenance, allocating terminal resources, validating, or any combination thereof. Further, this quay representation may be associated with an indication of operational status.

In embodiments of the invention, said quay representation is associated with an indication of operational status.

In embodiments of the invention, said quay representation is a part of said inoperative subset.

In embodiments of the invention, said maintenance is a first maintenance occurrence, wherein said terminal constraints further comprises a second maintenance occurrence.

In embodiments of the invention, each of said first maintenance occurrence and said second maintenance occurrence relate to separate maintenance of separate resources of said terminal resources.

The container carrier terminal system may optionally be able to handle multiple independent instances of maintenance. This may for example be maintenance of a first quay crane and maintenance of a second quay crane, in two separate time spans. Or it may be maintenance of a quay crane and maintenance of a part of the quay.

Alternatively, the maintenance may further of a third maintenance occurrence. It may even have a fourth and optionally even a fifth maintenance occurrence. Such maintenance occurrences may for example relate to different quay cranes of the plurality of quay cranes.

Having such multiple occurrences of maintenance permits rapid planning and execution of many different maintenance operations, which may sometimes be required in large container carrier terminals. It further allows an enhanced flexibility of resource allocation. For example, if few carriers are scheduled to berth, more maintenance may be planned. Or different maintenance occurrences distributed across several days or even several weeks may be planned simultaneously, thus ensuring necessary maintenance while reducing risk of breakdown and utilization of gaps in the resource plan to implement maintenance.

In embodiments of the invention, said method comprises a step of recording maintenance data based on said maintenance.

Maintenance data may for example be recorded and stored in a historic maintenance database. E.g. automatically through said container carrier terminal system, by berth planner, by gangs or other operational personnel. E.g. through a handheld device such as a smartphone.

Maintenance data may indicate a resource which undergoes maintenance (e.g. a particular quay crane). It may further indicate timing, and type of maintenance.

Recording such data is useful for analysis of maintenance of terminal resources, such as analysis of quay crane maintenance.

In embodiments of the invention, said method comprises a step of establishing a historic maintenance database.

In embodiments of the invention, said maintenance data is added to said historic maintenance database.

In embodiments of the invention, said historic maintenance database is based on previously recorded maintenance data.

In embodiments of the invention, said historic maintenance database indicates occurrence of maintenance of said terminal resources.

A historic maintenance database (e.g. implemented on a digital storage) may grant an overview of maintenance in one or more container carrier terminals. It may permit identification of historic trends or be used for input of future planning. Such a historic maintenance database may optionally be provided to a user such as the berth planner or other personnel of the terminal as a visualization or alternatively as raw data. The visualization may indicate the timespans in which a terminal resource such as a quay crane is inoperable due to breakdown or maintenance. In an exemplary embodiment, a visualization displays all quay cranes of a terminal, and the time spans in which each of the quay cranes are inoperable due to breakdown or maintenance. It further display timespans of operation and timespans of idling of the cranes.

In embodiments of the invention, said method comprises a step of identifying an unhealthy quay crane of said terminal resources.

In embodiments of the invention, said step of identifying an unhealthy quay crane is based on said historic maintenance database.

A historic database may permit identification of cranes which particularly often undergo maintenance. Such identification may be based on simple analysis such as a comparison with and average maintenance degree, or comparison with a certain time-based and/or maintenance frequency-based threshold. Alternatively, more advances computer algorithms may be used for identification, such as machine learning.

A crane which undergoes maintenance particularly often may then be identified and labelled as an unhealthy crane. It may be identified automatically or by berth planner, or by other operational personnel. Upon identification, the crane may be labelled, e.g. via a digital widget in a user interface.

Identifying and labelling an unhealthy crane may permit a berth planner and/or the container carrier terminal system to incorporate an increased risk of maintenance when planning berth. For example, this crane may be allocated less, or to less critical operations.

Alternatively, a berth planner may manually categorize a quay crane as an unhealthy quay crane, for example based on a partial breakdown of that crane.

In embodiments of the invention, said container terminal system generates a user notification when said unhealthy quay crane is allocated.

A notification provides a possibility for a berth planner to find alternative solutions.

In embodiments of the invention, said step of allocating a respective subset of said terminal resources is performed based on deprioritizing said unhealthy quay crane.

For example, when resources are automatically allocated via the container carrier terminal system, an unhealthy quay crane is deprioritized. For example, if two different quay cranes are available for allocation of which one of the cranes are unhealthy, the other crane is allocated in a longer time span to ensure efficient operations.

In embodiments of the invention, said step of planning said maintenance is based on said historic maintenance database.

A historic maintenance database may enable identifying a time slot which has a high probability of being well suited for the maintenance.

In embodiments of the invention, said step of planning said maintenance is based on said unhealthy quay crane.

By identifying an unhealthy quay crane, it is possible to plan maintenance for this quay crane to advantageously improve its health.

In embodiments of the invention, said method comprises a step of recategorizing said unhealthy quay crane.

In embodiments of the invention, said step of recategorizing said unhealthy quay crane is based on said step of planning said maintenance.

Be performing certain maintenance operations, a crane may be recategorized, particularly if the maintenance is expected to ensure more stable operations. Such recategorization may result in removal of the “unhealthy” label. A quay crane which is not unhealthy (or not labelled as unhealthy) may also be referred to as a healthy quay crane.

Recategorization can be scheduled to be synchronized in time with planned maintenance, such that after execution of the maintenance, the quay crane is recategorized such that it not unhealthy anymore.

May be performed manually by a berth planner, e.g. via the container carrier terminal system. Or it may be performed automatically by the container carrier terminal system upon planning and/or executing the maintenance.

In embodiments of the invention, said step of identifying an unhealthy quay crane is based on respective health scores of quay cranes of said plurality of quay cranes.

Each crane (or optionally just some of the cranes) may be linked to a health score, which indicate their health. For example, a health score may go from 0 to 100, where 0 indicates low health (e.g. high likelihood of failure) and 100 indicates high health (e.g. low likelihood of failure). Based on operations of the cranes, the health scores of the different quay cranes may be regularly updated e.g. via the historic maintenance database or other data records. Based on the health score, an unhealthy crane can then be identified (e.g. low score), upon which this crane may be deprioritized or maintenance of this crane can be planned.

Having a health score thus permits gradually adjusting expectations of each crane, which may provide a more accurate representation of actual expected operations of the cranes.

In embodiments of the invention, said step of planning said maintenance is at least partially performed using a maintenance planning algorithm.

A maintenance planning algorithm is advantageous since it may enable planning maintenance in a complex, and sometimes hectic, container carrier terminal, in which maintenance can otherwise be difficult to fit in between constant operations of container carriers.

A maintenance algorithm may suggest maintenance and perhaps a maintenance time period autonomously, or alternatively, it may provide a suggested time period based on a maintenance request from operational personnel or a berth planner. If the algorithm suggests maintenance autonomously, it may further generate a notification request which can be accepted, e.g. by the berth planner.

In embodiments of the invention, said maintenance planning algorithm suggests maintenance based on said preliminary terminal resource plan.

In embodiments of the invention, said maintenance planning algorithm suggests scheduling of said maintenance time period based on said preliminary terminal resource plan.

In embodiments of the invention, said maintenance planning algorithm suggests maintenance based on vacancies of said terminal resources in said preliminary terminal resource plan.

By supplying a resource plan (preliminary or updated) to the maintenance planning algorithm, the algorithm can identify suitable vacancies for maintenance, which is advantageous. Optionally, a maintenance planning algorithm may be combined with an optimization routine, e.g. to allocate terminal resources in combination with planning maintenance.

In embodiments of the invention, said maintenance planning algorithm suggests maintenance based on said historic maintenance database by identifying at least one quay crane of said terminal resources which is represented in said historic maintenance database more often than other quay cranes of said terminal resources.

In this context, “more often” may for example be a larger number of times or longer accumulated durations. A criterion for identification may for example be they a quay crane undergoes maintenance more than average, more than a threshold (relative or absolute), appearance of a certain type of maintenance a certain number of times etc.

In embodiments of the invention, said maintenance planning algorithm suggests scheduling of said maintenance time period within a preferred time span.

The preferred time span may for example be inputted by the berth planer or be predefined in the container carrier terminal system. It may be a particular time span, e.g. between 08:00 and 16:00 and/or between Monday and Friday. Thus, maintenance planning can be adjusted to constraints such as availability of maintenance teams.

In embodiments of the invention, said maintenance planning algorithm selects a quay crane of said plurality of quay cranes for said maintenance.

In embodiments of the invention, said maintenance planning algorithm selects a quay crane of said plurality of quay cranes for said maintenance based on maintenance type.

Maintenance types may for example be corrective maintenance, preventive maintenance, inspection maintenance, breakdown maintenance, and corrective maintenance.

In embodiments of the invention, said maintenance planning algorithm selects a quay crane of said plurality of quay cranes for said maintenance based on a component to receive maintenance.

Various components which may receive maintenances (at least one quay cranes) are wire rope, boom system, spreader, hoist motor, load cell, break, festoon, and roller.

In embodiments of the invention, said maintenance planning algorithm selects a said unhealthy quay crane for said maintenance.

Having a maintenance planning algorithm selecting a quay crane for maintenance may advantageously permit selection of the quay crane which is most suitable for receiving a particular type of maintenance, or which requires replacement/maintenance of a particular component.

In embodiments of the invention, said maintenance planning algorithm is based on machine learning trained using said historic maintenance database.

Such a machine learning algorithm may be trained on historic maintenance data from other quay cranes, even other quay cranes of other container carrier terminals. It may for example be trained to predict maintenance/breakdown patterns, and thus be able to identify which quay cranes which are at risk of breakdown.

In embodiments of the invention, said method further comprises a step of providing an updated terminal resource demand relating to at least one of said plurality of container carrier entries; and

In embodiments of the invention, said method further comprises a step of processing an updated terminal resource plan on the basis of said updated terminal resource demand by means of said computer implemented container carrier terminal system.

The processing may for example lead to an establishment of an updated terminal resource plan. Thus, the step of processing an updated terminal resource plan may comprise providing the updated terminal resource plan.

In embodiments of the invention, the step of processing an updated terminal resource plan on the basis of said updated terminal resource demand by means of said computer implemented container carrier terminal system is performed in compliance with updated demands and terminal resources.

In embodiments of the invention, the step of providing an updated terminal resource demand relates to said plurality of container carrier entries.

In embodiments of the invention, said step of allocating terminal resources comprises automatic distribution of terminal resources to at least a subset of said container carrier entries.

In embodiments of the invention, said step of providing an updated terminal resource demand relating to said plurality of container carrier entries is initiated automatically in response to modification of one or more container carrier entries of said plurality of container carrier entries.

By implementing the method such that the terminal resource demand is automatically updated when a container carrier entry is modified, an advantageous method may be achieved as it thereby facilitates up-to-date demands and constraints for the next processing of an updated terminal resource plan.

In embodiments of the invention, said step of processing an updated terminal resource plan relating to said plurality of container carrier entries is initiated automatically in response to modification of available terminal resources.

The availability of terminal resources may change over time. As an example, schedules of available gangs, such as quay crane gangs, may change over time due to e.g. organizational changes to the container carrier terminal. Thus, an automatic processing of an updated terminal resource plan based on the modified availability of terminal resources is advantageous. An automatic processing of an updated terminal resource plan upon an updated terminal resource demand is likewise advantageous.

In embodiments of the invention, said updated terminal resource demand is provided based on output from one or more container carriers.

In embodiments of the invention, said updated terminal resource demand is provided based on output from a control center associated with at least one of said one or more container carriers.

A container carrier may contact the container carrier terminal and, such as by phone to an operator of the container carrier system, or directly with the container carrier system through a communication channel, such as a wireless cellular connection. Through such a contact, the container carrier may alert the container carrier terminal about an arrival time later than the tentative arrival time which the container terminal system has previously used in the allocation of terminal resources. The newly updated tentative arrival time as provided by the container carrier may require that a new allocation of terminal resources are needed not only for the container carrier but also other container carriers which are scheduled for berthing at or around the time of the newly updated tentative arrival time of the container carrier. The output may refer to communication in any form, e.g. digital through any electronic communication form, audible through for example telephone, written through for example telefax or email, etc.

Alternatively, the updated terminal resource demand may be communicated via a control center related to a container carrier. Often control centers control and coordinate routings of container carriers, and may thus coordinate adjustments to schedules of container carriers from a carrier point-of-view. A control center may also be referred to as a coordination center.

In embodiments of the invention, said updated terminal resource demand comprises an updated tentative arrival time.

In embodiments of the invention, said updated terminal resource demand comprises an updated tentative departure time.

In embodiments of the invention, said updated terminal resource demand comprises an updated cargo capacity to be loaded, unloaded, and/or redistributed at said container carrier terminal.

In embodiments of the invention, the step of processing an updated terminal plan comprises:
applying in said container carrier terminal system at least one new container carrier entry or modifying an existing container carrier entry of the container carrier terminal system, each container carrier entry relating to a container carrier and associated with respective terminal resource demand including a tentative arrival time, wherein said tentative arrival time is indicative of arrival of said container carrier to said container carrier terminal;
allocating a respective subset of said terminal resources to each container carrier entry of said plurality of container carrier entries to obtain an updated resource plan of allocated terminal resources, wherein said step of allocating terminal resources comprises automatically validating allocated terminal resources of the container carrier entries
the allocated terminal resources including said plurality of quay cranes, the validating including automatically establishing whether the allocated terminal resources of the container carrier entries comply with said terminal resource demand associated with said plurality of container carrier entries and said terminal constraints, said terminal resource demand including said tentative arrival time.

An updated terminal resource plan may not simply involve a single update of a preliminary terminal resource plan motivated by a provided updated terminal resource demand of a single container carrier entry of the many container carrier entries. As time progresses, more container carriers may report disruptions in their itinerary and/or their terminal resource demand, thus more and more changes to the container carrier entries may be provided in the container carrier system within a given time frame, such as within a resource allocation time window, and since allocation of terminal resources among a plurality of container carrier entries is a highly mutually influential process, i.e. a change in the allocation of terminal resources for a first container carrier entry may impose changes to a second container carrier entry in order to comply with terminal constraints, and vice versa, a fundamental change in the terminal resource plan may be required. Furthermore, available terminal resources may change over time, or the terminal constraints relating to the terminal resources may change over time necessitating an updating of the preliminary terminal resource plan for the plan to be rendered operational. Updating of terminal resource plans may also be a simple matter of a desire to fit in further entries or modify the configuration of the available terminal resources.

In embodiments of the invention, said step of processing an updated terminal resource plan comprises allocating a respective subset of said terminal resources, including said plurality of quay cranes, to each container carrier entry of said plurality of container carrier entries, wherein said step comprises automatically distributing terminal resources, including said plurality of quay cranes, to said plurality of container carrier entries to comply with said updated terminal resource demand and said terminal constraints.

The updated terminal resource plan may be processed in a similar way as the preliminary terminal resource plan is obtained, however taking into account updated terminal resource demand relating to said plurality of container carrier entries. The updated terminal resource demand may relate to a single container carrier entry or it may relate to a plurality of container carrier entries.

In embodiments of the invention, said step of processing an updated terminal resource plan comprises allocating terminal resources within a resource allocation time window.

Generally and advantageously, the processing of an updated terminal resource plan relates to allocation of terminal resources within the same time window as the preliminary terminal resource plan or previous updated terminal resource plan relating to the same container carrier entries. In other words, the allocation of terminal resources can also be considered a re-allocation regarding the same container carrier entries. When referring to a same time window or said resource allocation time window, this may encompass that sometimes an updated container carrier entry involves a shift in tentative arrival time or tentative departure time, thereby requiring an extension of the resource allocation time window and/or processing the container carrier entry in a different resource allocation time window.

In embodiments of the invention, said method comprises a step of providing further updated terminal resource demand and processing a further updated terminal resource plan on the basis of said updated terminal resource demand by means of said computer implemented container carrier terminal system.

The further updated terminal resource demand and further updated terminal resource plan may also be referred to as re-updated terminal resource demand and re-updated terminal resource plan, respectively. The steps of providing an updated terminal resource demand relating to said plurality of container carrier entries and processing an updated terminal resource plan on the basis of the updated terminal resource demand may be performed any number of times, even within the same resource allocation time window. In other words, for a given set of container carrier entries in the container carrier terminal system, a subset of terminal resources allocated for any of the container carrier entries may change through updates. As an example, a quay crane may be allocated to a first container carrier entry according to a preliminary terminal resource plan or updated terminal resource plan and in a subsequent updated terminal resource plan the same quay crane may instead be allocated to a second container carrier entry which is overlapping in time with the first container carrier entry.

Having the ability to perform multiple updates of a terminal resource plan, and even within the same resource allocation time window, is advantageous in that it may be ensured that there is always an operationally functioning plan of allocated resources available in the container carrier terminal system, and this plan is always up to date with the most recent changes to the terminal resource demand relating to the plurality of container carrier entries.

In embodiments of the invention, said updated terminal resource plan is a previously updated terminal resource plan and said updated terminal resource demand is a previously updated terminal resource demand and wherein an updated terminal resource plan is processed on the basis of said previously updated terminal resource demand.

In embodiments of the invention, said updated terminal resource plan is processed on the basis of said preliminary terminal resource plan.

Providing an updated terminal resource plan on the basis of a preliminary terminal resource plan may comprise basing the updated plan on a part of the preliminary plan. As an example, a part of the preliminary terminal plan may be set in stone for the future operations of the container carrier terminal and the remaining part of the preliminary terminal resource plan may, subject to an updated terminal resource demand, have to be updated/modified in the process of processing an updated terminal resource plan. As an example, container carrier entries relating to containers that are currently being serviced e.g. one or more quay cranes, and which therefore have already had terminal resources allocated in relation with the obtainment of the preliminary terminal resource plan may be considered set in stone, i.e. not changed or modified, when an updated terminal resource plan is processed.

In embodiments of the invention, said method comprises a step of updating said maintenance.

For example, a maintenance team of engineers may be unavailable, or a terminal resource which are scheduled to undergo maintenance may be required for allocation instead.

In embodiments of the invention, said method comprises a step of rescheduling said maintenance based on said preliminary terminal resource plan.

A rescheduling of maintenance may for example be necessary when a terminal resource has been allocated within a maintenance time period.

In embodiments of the invention, said updated terminal resource plan is based on said maintenance.

For example, if maintenance of a terminal resource has been scheduled simultaneously with allocation of that terminal resource in a resource plan.

In embodiments of the invention, said updated terminal resource plan is based on said maintenance time period.

For example, the updated terminal resource plan may involve allocation of a terminal resource which is scheduled to undergo maintenance, wherein that terminal resource is than only allocated outside the maintenance time period.

In embodiments of the invention, said updated terminal resource plan is based on said inoperative subset.

For example, the updated terminal resource plan may involve allocation of an inoperative subset only outside time periods where it is not expected to be inoperable.

In some embodiment, an inoperative subset is inoperative outside a maintenance time period. It may for example be inoperative from a point of breakdown until maintenance has been completed.

In embodiments of the invention, said step of planning said maintenance is performed prior to said step of processing said updated terminal resource plan.

In embodiments of the invention, said step of planning said maintenance is performed at least partly simultaneously with said step of processing said updated terminal resource plan.

In embodiments of the invention, said step of planning said maintenance is performed after said step of processing said updated terminal resource plan.

The planning maintenance may potentially affect the processing of the updated terminal resource plan and vice versa. Hence, a particular execution of these steps may simplify the method, which is advantageous.

In embodiments of the invention, said step of processing said updated terminal resource plan comprises adjusting said maintenance time period.

As a part of processing the updated terminal resource plan, the maintenance time period may be adjusted. For example, as a part of an optimization. This may ensure improved efficiency of terminal operation.

In embodiments of the invention, said container carrier terminal system is associated with a database comprising a plurality of container carrier data records, wherein each of said plurality of container carrier data records comprises data associated with a respective container carrier of said plurality of container carriers.

The container carrier system may be associated with a database stored on a single computer server or distributed on a plurality of computer servers. The database may comprise a plurality of container carrier data records, i.e. data records corresponding to respective container carriers. A container carrier data record may comprise general information/data about the container carrier such as the type of the container carrier, size of the container carrier and a schedule of the container carrier sailing routes. Any contractual agreements between the container carrier and the container carrier terminal may also be reflected in the container carrier data records. Such contractual agreements may comprise an agreed amount of shipping containers to be loaded, unloaded, and/or redistributed at the container carrier terminal, and may further comprise times where the container carrier is initially scheduled for arriving and berthing at the container carrier terminal.

Having a database of container carrier data records associated with the container carrier terminal system is advantageous in that data associated with the container carriers that are berthing at the container carrier terminal (including container carriers that have berthed in the past and container carriers berthing in the future) need only be managed by a single database which may be referenced or linked to when e.g. inputting container carrier entries in the container carrier terminal system. By linking to the relevant data or importing the data from the container carrier data records when inputting container carrier entries in the container carrier terminal system is achieved that the risk of wrongly inputting data concerning a container carrier is minimized, as long as the data is correctly input in the container carrier data records in the first place. A further advantage of such container carrier data records is that future container carrier entries may automatically be generated and inputted into the container carrier terminal system.

In embodiments of the invention, said container carrier terminal system is associated with a database comprising a plurality of quay crane data records, wherein each of said plurality of quay crane data records comprises data associated with a respective quay crane of said plurality of quay cranes.

The container carrier system may be associated with a database stored on a single computer server or distributed on a plurality of computer servers. The database may comprise a plurality of quay crane data records, i.e. data records corresponding to respective quay cranes of the container carrier terminal. A quay crane data record may comprise information/data about the quay crane such as the reach of the quay crane, i.e. how far out from the quay the crane is able to handle shipping containers, the working range of the crane, i.e. the quay length along the quay over which the quay crane is able to move (not withstanding that other quay cranes may be positioned in the way of the quay crane), as well as a maximum productivity (gross moves per hour) of the quay crane.

In embodiments of the invention, said container carrier terminal system is associated with a database comprising at least one resource maintenance data record, wherein each of said at least one resource maintenance data record data associated with said maintenance.

A resource maintenance data record may for example comprise information relating to previous, ongoing, or future maintenance of a terminal resource. For example scheduled maintenance time period, quay length, bollard number, previous maintenance of that resource etc.

In embodiments of the invention, said container carrier terminal system is associated with a database comprising at least one of maintenance data record, wherein each of said at least one maintenance data record data associated with maintenance of a respective quay crane of said plurality of quay cranes.

In embodiments of the invention, said quay crane data records comprises information about maintenance of respective quay cranes.

A quay crane data record may comprise information on maintenance of a quay crane, such as time and date of a previous maintenance and time and date of a future scheduled maintenance. The records may further comprise a tracking of the use of the quay crane such that maintenance of the quay crane may automatically be suggested by the system when for example the total number of gross moves by the crane reaches a predetermined number since last maintenance of the crane or when the total operation time of the crane reaches a predetermined operation time since last maintenance of the crane. Storing information about maintenance, for example maintenance of quay cranes in quay crane data records, is advantageous in that the container carrier terminal system may be able to account for future expected maintenance of, e.g., a quay crane, when allocating terminal resources to container carrier entries in the future. If for example, it is determined that a quay crane has 500 hours of operation left, i.e. 500 hours to lift and move shipping containers before a maintenance is required, then due to the capability of the container carrier terminal system in allocating the quay crane to container carrier entries representative of container carriers arriving for berthing in the container carrier terminal way out in the future, the container carrier terminal system is able to proactively deal with a future maintenance since the system may be able to predict when in the future the remaining 500 hours of operation will lapse. Thus, the container carrier terminal system may be able to already take into account that at some point in the future a terminal resource may not be an available terminal resource for allocation to container carrier entries and thus the preliminary terminal resource demand of the container carrier entries, at that point in time in the future, may have to be complied with by fewer resources (e.g. fewer quay cranes).

Knowing such information in good time puts an operator of the container carrier terminal system in an advantageous position, since a consequence of such a disruption to the terminal operations may be that one or more container carriers may have to arrive later at the container carrier terminal in order for operations to run smoothly. The operator may thus contact a container carrier, e.g. a captain on the carrier, and ask for the carrier to arrive later at the terminal. The earlier a container carrier knows of such changes the better, since the ship may sail a greater distance at a reduced speed contrary to sailing at a higher speed for the most of the trip and then abruptly reducing the speed as it gets close to the terminal. The fuel consumption of a container carrier is greatly dependent on the speed of the container carrier and it has been found that for speeds above 14 knots the fuel consumption of a container grows exponentially with the speed of the container carrier. Thus, by reducing its speed, even slightly, in good time before arrival at the container carrier terminal later, the container carrier may reduce emissions of greenhouse gases significantly.

In embodiments of the invention, said container carrier terminal system is associated with a database comprising a plurality of gang data records, wherein each of said plurality of gang data records comprises data associated with a gang of said container carrier terminal.

A gang data record may comprise data relating to planned working shifts of gangs, such as quay crane gangs. Knowing information about planned working shifts for gangs is highly advantageous for the allocation of resources, since the number of available gangs at any point in time may represent a bottleneck for the operations of the container carrier terminal. As an example, the number of available quay crane gangs may dictate how many quay cranes may be allocated at any given time. Therefore, information about what gangs are available at any given time in the future may further improve the terminal resource plans generated/processed by the container carrier terminal system.

According to an embodiment of the invention, the container carrier terminal system is associated with a database, wherein the database may comprise any of a container carrier data records, quay crane data records, and gang data records.

In embodiments of the invention, said container carrier entries are inputted in a resource allocation environment of said container carrier terminal system.

By a “resource allocation environment” is understood a computer-implemented working environment in which the terminal resources of the model may be allocated to the container carrier entries. The resource allocation environment may advantageously facilitate automatic distribution/allocation of terminal resources to container carrier entries. A resource allocation environment is advantageous in that it facilitates a common place for handling of container carrier entries and allocation of terminal resources to these.

In embodiments of the invention, said resource allocation environment is represented by a graphical user interface of said container carrier terminal system.

Thereby an advantageous embodiment is provided, as the container carrier terminal system provides a highly user friendly and intuitive procedure for allocating terminal resources to container carrier entries, thereby forming preliminary-, intermediate-, and/or updated terminal resource plans.

The graphical user interface is configured to allow the user/operator of the container carrier terminal system to access and/or modify a plan of allocated terminal resources in the resource allocation environment, by presenting graphical elements, i.e. graphical representations of container carrier entries, allocated resources, and/or conflicts of a resource allocation plan on a screen, and facilitating interaction with the graphical elements, by input from the user/operator e.g. by computer mouse, keyboard, touch gestures, etc.

In embodiments of the invention, said step of inputting a plurality of container carrier entries comprises automatically inputting one or more of said plurality of container carrier entries in said container carrier terminal system.

The container carrier entries may be automatically inputted/imported in the container carrier terminal system using data from external data sources, such as data managed on servers by shipping companies, data managed on servers managed by other container carrier terminals, or other from other data servers relating to the container carrier terminal. In an alternative embodiment of the invention, at least a subset of said plurality of container carrier entries are inputted manually into said resource allocation environment, e.g. by input through a graphical user interface. As an example, the container carrier terminal system may automatically retrieve data from a shipping company indicative of a future berth at the container carrier terminal. This data may specify that a number of containers are expected to be loaded/unloaded/redistributed at the container carrier terminal in the future, and in some cases the data may even indicate, by reference to a vessel name, a specific container carrier such as “Emma Mærsk”. Automatically inputting container carrier entries in the container carrier terminal system, e.g. in a resource allocation environment, is advantageous in that the container carrier terminal system may frequently be updated about future berths at the container carrier terminal and the system may gain access to the newest available information about future berths, since the data sources relied upon in the automatically inputting of container carrier entries may be the earliest indicators of future berths at the container carrier terminal.

In another embodiment of the invention, each of said plurality of container carrier entries is inputted automatically in the container carrier terminal system.

In embodiments of the invention, said automatically inputting one or more of said plurality of container carrier entries comprises inputting data from said plurality of container carrier data records.

In embodiments of the invention, said automatically inputting one or more of said plurality of container carrier entries comprises referencing data from said plurality of container carrier data records.

When inputting container carrier entries in the container carrier terminal system, a reference, e.g. by link, association, pointer, copying, etc, may be made to data relating to a specifics about a container carrier, e.g. type of carrier, size of carrier, etc. Such data may be present in a container carrier data record, and may be either pointed to by a pointer in the container carrier entry or hard copied into the container carrier entry.

In embodiments of the invention, said container carrier terminal system is associated with a database comprising a plurality of container carrier entry data records, wherein each of said container carrier entry data records comprises data associated with a respective container carrier entry of said plurality of container carrier entries.

In embodiments of the invention, said representations of terminal resources of said model are representations of terminal resources which are physically present at said container carrier terminal, such as physical quay cranes.

The terminal resources of the model are understood as representations of resources physically present at the container carrier terminal. As an example, the model may comprise 5 quay cranes, and this should be understood in such a way that the model comprises computer representations of 5 quay cranes which are actually physically present at the container carrier terminal which is represented by the model. In this regard, the terminal resources of the model are not capable of performing, by themselves, actions relating to operations of a physically present container carrier terminal, these actions are performed by physically present resources, e.g. quay cranes actually present at a container carrier terminal, but these resources may nonetheless be represented by the model and allocated to container carrier entries.

In embodiments of the invention, said representations of terminal resources comprises representations of one or more physical quay lengths.

In embodiments of the invention, said representations of terminal resources comprises representations of one or more physical bollards.

In embodiments of the invention, said representations of terminal resources comprises representations of one or more physical gangs.

In embodiments of the invention, said preliminary terminal resource demand comprises a container carrier length.

In embodiments of the invention, said preliminary terminal resource demand includes a tentative departure time.

A container carrier on its way to the container carrier terminal may request a certain departure time, which may be agreed to by a berth planner of the container carrier terminal, and this departure time, which is agreed upon, may be an example of the tentative departure time. Having a tentative departure time as part of the preliminary resource demand is advantageous for the execution of the method, and in particular for the allocation of terminal resources. By having access to a tentative departure time, the allocation of terminal resources may be better allocated/distributed to the plurality of container carrier entries.

In embodiments of the invention, said tentative arrival time and/or tentative departure time is automatically retrieved and inputted in said container carrier entry.

In embodiments of the invention, said tentative arrival time and/or tentative departure time is automatically predicted.

The container carrier terminal system may be arranged to automatically retrieve the tentative arrival/departure time from external sources, such as from data sources managed by the operator of the container carrier, e.g. a shipping company. In an alternative embodiment of the invention, the tentative arrival time is automatically predicted based on e.g. AIS-data (Automatic Identification System data). Automatically retrieving and inputting the tentative arrival time and/or tentative departure time is advantageous in that container carrier entries may thereby easier be automatically inputted in the container carrier terminal system.

In embodiments of the invention, said preliminary terminal resource demand is based on an estimated terminal resource demand.

In embodiments of the invention, said estimated terminal resource demand comprises a preliminary quay crane demand.

An estimated terminal resource demand may for example be indicative of a number of containers to be moved, a number of TEU units to be moved, or a number of quay crane workhours required to service a container carrier at the container carrier terminal.

An estimated terminal resource demand may alternatively be referred to as an estimated resource demand.

Introducing an estimated terminal resource demand is advantageous, since it allows an approximate allocation of terminal resources, which in turn may ensure proper delivery of goods and reduced emission of greenhouse gases.

In embodiments of the invention, said estimated terminal resource demand is based on a contractual terminal resource demand.

A contractual terminal resource demand may for example be based on a long-standing contractual agreement, e.g. a so-called pro-forma plan. Here, a contractual number of containers to be transferred by a certain container carrier in a certain container carrier terminal may for example be stated. However, such contractual numbers are often imprecise and/or inaccurate.

Basing an estimated terminal resource demand on a contractual terminal resource demand is advantageous, since the contractual terminal resource demand may to some degree be indicative of an updated terminal resource demand or an actual terminal resource demand.

In embodiments of the invention, said preliminary terminal resource demand comprises a container-related berth workload.

A container-related berth workload may for example relate to a cargo capacity to be loaded, unloaded, and/or redistributed by the quay cranes of the terminal in relation to a container carrier entry. Alternatively, a container related berth workload for example relate to a number of quay crane workhours. The container-related berth workload may be a single number representing the total amount of work, e.g. by a number of container moves or crane hours, or it may be a multi-dimensional parameter that provides individual numbers for loading, unloading and redistribution, respectively, to allow for more accurate allocation depending on the types of tasks. Regardless of the way of quantifying the workload, one or more cranes may be allocated to match the container-related berth workload. A balance exists between the number of cranes allocated and the time required to carry out the container moves, as generally the more cranes allocated for the workload, the faster the work can be done.

In embodiments of the invention, said preliminary terminal resource demand comprises cargo capacity to be loaded, unloaded, and/or redistributed at said container carrier terminal.

Cargo capacity may be understood as a measure of the amount of containerized cargo. For example, a number of containers or a number of units of TEU, where TEU is twenty-foot equivalent units, which is a unit of cargo capacity often used to describe the capacity of container carriers and container terminals. Sometimes a container carrier gets completely unloaded and/or loaded during a single berth, and thereby the required workload roughly corresponds to the cargo capacity of the container carrier. However, more typically the container carriers unload and load only partially in each terminal they visit and the required workload is thereby not the total cargo capacity of the vessel.

In embodiments of the invention, said method further comprises a step of updating said tentative arrival time based on said maintenance.

In embodiments of the invention, said method further comprises a step of updating said tentative departure time based on said maintenance.

For example, if maintenance can only be properly scheduled in the container carrier terminal system by changing tentative arrival or departure time, e.g. to increase the time in which a terminal resource is not allocated, thus permitting maintenance of this resource. Or, for example, if maintenance can be planned or executed more efficiently than initially expected, it may permit a container carrier to arrive earlier, thus permitting more faster delivery of containers.

Arrival and departure times may be changed to reduce or increase berth time. A reduction of berth time may reduce emission of greenhouse gases since it enables the container carrier to travel slower. An increase in berth time may ensure that all necessary container moves are completed.

In embodiments of the invention, said step of planning said maintenance is based on availability of maintenance resources.

The planning may for example be based on when certain maintenance resources are available.

In embodiments of the invention, said maintenance resources comprises maintenance equipment.

In embodiments of the invention, said maintenance resources comprises maintenance gangs.

A maintenance gang may for example be understood as a physical maintenance gang of one or more persons. Such a maintenance gang may be associated with the container carrier terminal, or it may be an external gang which is hired in for the maintenance. A maintenance gang may for example be a crane maintenance gang, or a quay maintenance gang.

In embodiments of the invention, said terminal resources comprises said maintenance resources.

In embodiments of the invention, said representations of terminal resources comprises representations of said maintenance resources.

Thus, maintenance resources may be included in the model of the container carrier terminal system and be managed via allocation and validation, which is advantageous.

In embodiments of the invention, said preliminary terminal resource demand comprises a maintenance resource demand, wherein said step of planning said maintenance is based on said maintenance resource demand.

In embodiments of the invention, said maintenance resource demand is associated with said maintenance resources.

By establishing a maintenance resource demand, a clear maintenance-related objective can be defined. And based on this, maintenance can be planned, e.g. via allocation of maintenance resources.

In embodiments of the invention, said terminal constraints comprises quay depth.

A quay has a certain depth along the length of the quay and this may impose limitations to what container carriers may berth at specific positions along the quay.

In embodiments of the invention, said terminal constraints comprises quay crane move restrictions.

By quay crane move restrictions is understood restrictions to the movement of one or more quay cranes of the container carrier terminal. For example, two quay cranes may not move into one another and pass each other. Furthermore, a quay crane which is under maintenance may not move along the quay and it may block the available working space for other quay cranes at the same quay.

In embodiments of the invention, said terminal constraints comprises quay crane maintenance.

In embodiments of the invention, said terminal constraints comprises weather restrictions.

The quay depth may depend on tides, and furthermore operations of the container carrier terminal may be hampered by bad weather. As an example, the productivity of a quay crane may be affected by visibility.

In embodiments of the invention, said weather restrictions are based on weather forecasts or historic weather data.

In embodiments of the invention, said step of allocating a respective subset of said terminal resources to each container carrier entry of said plurality of container carrier entries comprises allocating a respective quay position to each container carrier entry of said plurality of container carrier entries.

By including allocation of quay positions when allocating terminal resources to the container carrier entries may be achieved significant advantages. By doing so, the allocation/designation of quay positions may be performed with respect to other available terminal resources.

In embodiments of the invention, said step of allocating a respective subset of said terminal resources to each container carrier entry of said plurality of container carrier entries is performed for a resource allocation time window.

In the present disclosure, a “resource allocation time window” is understood as a time interval in which terminal resources may be allocated to container carrier entries. For example, the resource allocation time window spans a time interval from present time and long into the future, such as to allocate resources to container carrier entries associated with container carriers which have not even set off from a preceding port call.

In embodiments of the invention, said step of planning said maintenance is performed within said resource allocation time window.

In embodiments of the invention, said allocating said at least one quay crane is performed from 2 days to 90 days prior to said container carrier berth, such as from 3 days to 60 days, for example from 4 days to 20 days, for example 7 days or 14 days, such as at least 1 week, 2 weeks, 3 weeks, 1 month or 2 months prior to said container carrier berth.

The time interval of the resource time window may alternatively be defined by the above exemplified time intervals.

In embodiments of the invention, said automatically validating and/or at least partly distributing terminal resources is carried out with respect to one or more allocation targets.

In embodiments of the invention, said one or more allocation targets comprise an allocation target from the list of earlier time of departure ETD, later arrival ETA, reduced between-tasks crane movement, reduced number of resource allocation peaks, reduced magnitude of resource allocation peaks, performing said step of planning said maintenance.

Performing the allocation of resources according to an allocation target is advantageous as it enables achieving technical advantages that would otherwise not be possible with a less aimed approach. For example allocation targets relating to allowing container carriers to arrive later or depart earlier, and making this allocation in good time, i.e. several days or weeks before the berth is scheduled to take place, among other advantages makes it possible for the container carriers to slow down and thereby reduce the emission of greenhouse gasses. For example, an allocation target of minimizing the movement or relocation of cranes between task may among other advantages reduce the wear on the cranes. For example reducing amount or level of resource allocation peaks, i.e. times where the terminal is too busy with risks of accidents, additional wear, errors, insufficient flexibility to handle unforeseen events, or too idle causing inefficiency and wasted resources.

A possible allocation target is performing said step of planning said maintenance. For example, crane resources may be allocated and/or redistributed to permit maintenance to be scheduled as well. For example, crane resources may be allocated to ensure that a terminal resource is available for at least said maintenance time period.

In embodiments of the invention, said step of automatically validating and/or distributing terminal resources, including said plurality of quay cranes, to said plurality of container carrier entries to comply with said preliminary terminal resource demand, involves calculating a theoretical required number of cranes NCt by a formula corresponding to:

NCt=WLe/(Tb*Pc)

wherein WLe is an estimated container-related workload of said preliminary terminal resource demand, Tb is a duration of said container carrier entry, and Pc is a measure of average crane productivity.

From an estimated container-related workload WLe to be handled at a terminal with an average crane productivity Pc during a port call with an expected duration Tb, one of the possible solutions may be calculated by first calculating the theoretically required number of cranes NCt. From this number, several solutions of feasible allocations of cranes may be derived.

An estimated container-related workload may also be referred to as an estimated container-related berth workload.

In embodiments of the invention, said step of automatically validating and/or distributing terminal resources, including said plurality of quay cranes, to said plurality of container carrier entries to comply with said preliminary terminal resource demand, involves calculating a theoretical required number of cranes NCt, and rounding said theoretical required number of cranes NCt up to an integer number of cranes NC.

The calculated theoretical number of cranes NCt may be a non-integer. One possible solution for the allocation is then to round NCt up to the nearest higher integer to get an integer number of cranes NC to allocate.

In embodiments of the invention, said step of automatically validating and/or distributing terminal resources, including said plurality of quay cranes, to said plurality of container carrier entries to comply with said preliminary terminal resource demand, involves calculating a required average length of crane time windows Tc from a number of cranes NC by the formula:

Tc=WLe/(NC*Pc)

wherein WLe is an estimated container-related workload of said preliminary resource demand, NC is said number of cranes, preferably derived from a theoretically required number of cranes NCt, and Pc is a measure of average crane productivity.

Solutions for the allocation can be found by calculating different crane time window lengths if more than one crane is allocated, or reduce the common crane time window for all the allocated cranes. For example, starting from an actual number of cranes NC achieved by rounding a theoretical number NCt up, the required average length of the crane time windows Tc, which will be shorter than the berth duration Tb, may be found.

Other possible allocation solutions involve allocating even more cranes and reduce the lengths of the crane time windows commonly or individually. The formula above can also be used to find the resulting average crane time windows required when increasing the number of cranes NC.

In more advanced embodiments non-productive time such as idle time, crane preparing time, buffer time, inspection time, etc., may be taken into account to result in the number of cranes multiplied by the length of their respective crane time windows and their respective productivity exceeding the estimated workload by an amount corresponding to the various added non-productive time.

In embodiments of the invention, said preliminary resource demand is indicative of a cargo capacity to be unloaded, loaded and/or redistributed from said container carrier to said container carrier terminal during said container carrier entry.

A cargo capacity may for example be understood as a number of containers or be parameterized by a unit of cargo capacity such as TEU.

Two typical tasks of a quay crane in relation to a container carrier berth is to unload containers from the container carrier to the container carrier terminal, and load containers from the container carrier terminal to the container carrier. Additionally, a quay crane may also redistribute containers on the container carrier, since otherwise some containers may be inaccessible or a weight distribution on the container carrier may be imbalanced. Unloading and loading may typically be performed from/to a quay and/or yard of the container carrier terminal.

From an estimated cargo capacity to be handled at the terminal during a container carrier entry, the allocation step involves determining a suitable combination of number of cranes and length of crane time window which allows for handling the estimated cargo capacity preferably within the expected duration of the scheduled berth. By specification of the general formula above, the estimated cargo capacity WLcc to be handled divided by the expected duration Tb of the container carrier entry and further divided by the average productivity in cargo capacity per crane Pc, cc gives the theoretically required number of cranes NCt:

NCt=WLcc/(Tb*Pc,cc)

For example with cargo capacity of 600 TEU, berth duration of 4 hours and average productivity of 40 TEU/h per crane:

NCt=600/(4*40)=3.75 cranes.

This number could either be rounded up to an allocation of 4 cranes which also provides some buffer time for unforeseen or non-productive events, or be fine-tuned by allocating different crane time windows for each crane, e.g. only allocating 3 hours for one of the cranes, and 4 hours for the other three cranes.

Having the estimated container-related berth workload being indicative of the cargo capacity to be unloaded, loaded, and/or redistributed is advantageous, since these tasks are typical tasks of quay cranes, and estimating these numbers thus allows optimum scheduling of quay cranes, which in turn may reduce delivery time of goods and emission of greenhouse gases.

In embodiments of the invention, said estimated container-related berth workload is indicative of a number of containers to be moved in relation to said container carrier berth.

A number of containers to be moved, also referred to as container moves or simply moves, may for example be understood as the sum of the number of containers to be unloaded, the number of containers to be loaded, and the number of containers to be redistributed. The parameter may also be given as a separate number for each type of move, i.e. load, unload and redistribution.

From an estimated number of containers to be moved at the terminal during a container carrier entry, the allocation step involves determining a suitable combination of number of cranes and length of crane time window which allows for handling the estimated container moves preferably within the expected duration of the container carrier entry. For example, the estimated container moves WLm to be handled divided by the expected duration Tb of the container carrier entry and further divided by the average productivity given in moves per crane Pc,m, such as the common measure Gross Moves Per Hour, GMPH, gives the theoretically required number of cranes NCt:

NCt=WLm/(Tb*Pc,m)

For example, with estimated workload of 500 container moves, berth duration of 6 hours and average productivity GMPH of 30 moves/h per crane:

NCt=500/(6*30)=2.78 cranes.

This could either be rounded up to an allocation of 3 cranes which also provides some buffer time for unforeseen or non-productive events, or be fine-tuned by allocating different crane time windows for each crane.

For example, by applying the formula Tc=WLe/(NC*Pc) discussed above, the required average crane time window Tc if allocating 4 cranes instead of 3 to the scheduled berth can be calculated:

Tc=500/(4*30)=4.17 hours=4 hours and 10 minutes, i.e. a considerably shorter time than the scheduled berth duration Tb of 6 hours.

Having the estimated resource demand being indicative of the number of containers to be moved is advantageous, since estimating this number allows optimal scheduling of quay cranes, which in turn may reduce delivery time of goods and emission of greenhouse gases.

In embodiments of the invention, said estimated resource demand is indicative of a number of crane moves to be performed in relation to said container carrier berth.

Some quay cranes are able to pick up and move more than one container at a time. A quay crane may for example move two containers at a time, or four containers at a time. The number of crane moves may thus be lower than the number of containers to be moved, since one crane move may move more than one container.

Having the estimated resource demand being indicative of the number of crane moves to be performed is advantageous, since estimating this number allows better scheduling of quay cranes, which in turn may reduce delivery time of goods and emission of greenhouse gases.

Note that during a container carrier entry, a quay crane may alternate between loading and unloading containers to maximize utilization of the crane moves. In some embodiments of the invention, such optimized crane moves may be taken into account in the estimated container-related berth workload, whereas in other embodiments it may not.

In embodiments of the invention, said estimated resource demand is indicative of a number of quay crane workhours required during said container carrier entry.

A number of quay crane workhours is not restricted to natural numbers of mathematics but may be any type of number, e.g. a number including decimals and/or a fraction. Some examples of quay crane workhours are 2.5 hours, 3 hours and 43 minutes, and 7/3 hours. From a number of estimated required quay crane workhours, the allocation step may involve determining a suitable combination of number of cranes and length of crane time window which provides for the estimated quay crane workhours. For example, the estimated crane workhours WLwh required divided by the expected duration Tb of the container carrier entry gives the theoretically required number of cranes NCt:

NCt=WLwh/Tb

This value can be rounded up to an integer to arrive at a possible allocation solution, and other solutions be calculated by adjusting the crane time windows for individual cranes, or use a higher number of cranes.

Having the estimated resource demand being indicative of a number of crane workhours is advantageous, since estimating a number of workhours allows improved scheduling of quay cranes, which in turn may reduce delivery time of goods and emission of greenhouse gases.

In embodiments of the invention, said estimated resource demand is indicative of a container location distribution onboard said container carrier.

The container location distribution onboard a container carrier may in some cases be important for quay crane operations during a container carrier entry. It may for example determine whether it is necessary to move containers to access containers to be unloaded, whether multiple containers can be picked up at a time be a quay crane, and/or how many quay cranes can access containers to be unloaded at a time.

Having the estimated resource demand being indicative of a container location distribution is advantageous, since estimating container location distribution allows enhanced scheduling of quay cranes, which in turn may reduce delivery time of goods and emission of greenhouse gases.

In embodiments of the invention, said estimated resource demand is indicative of a container weight and/or a number of empty containers.

Empty containers and heavy containers may typically require to be handled differently than regular containers during container carrier entry. They may for example require to be moved or stored differently.

As such, estimating information relating to container weight and number of empty containers is advantageous, since it enables a more detailed quay crane allocation.

In embodiments of the invention, said automatically validating and/or distributing terminal resources is performed on the basis of an optimization routine.

The optimization routine may be used in any of the steps of obtaining a preliminary resource allocation plan, processing an updated resource allocation plan, and processing one or more intermediate resource allocation plans.

In embodiments of the invention, said optimization routine is arranged to distribute terminal resources to comply with said terminal constraints and said preliminary terminal resource demand and to optimize distribution of terminal resources with respect to one or more optimization targets.

In embodiments of the invention, said optimization routine is arranged to distribute terminal resources to comply with said terminal constraints and said updated terminal resource demand and to optimize distribution of terminal resources with respect to one or more optimization targets.

In embodiments of the invention, said optimization targets are said allocation targets.

Allocation target may advantageously be represented by the model(s) of the container carrier terminal system.

In some alternative embodiment, an optimization target and/or an allocation target may be related minimizing maintenance hours, and/or maintenance costs. Some other embodiments do not include such targets. Costs can refer to either economical costs, or allocation costs, e.g. an mathematical cost function which improves efficiency of terminal operations by implementing a higher cost for inefficient maintenance planning and/or operations. The cost may be based on maintenance duration, maintenance timing, relative scheduling of several maintenances, or any combination thereof.

In embodiments of the invention, said step of allocating said respective subset of said terminal resources is restricted to a subset of said plurality of container carrier entries.

In embodiments of the invention, said optimization routine is restricted to a subset of said plurality of container carrier entries when performing optimization.

In embodiments of the invention, said step of processing an updated terminal resource plan is restricted to a subset of said plurality of container carrier entries when performing optimization.

In berth planning, allocation of terminal resources may only be relevant for a subset of a plurality of container carrier entries. Other container carrier entries may for example be less relevant since the associated container carriers are scheduled to arrive relatively too far into the future. Or perhaps a berth planner has already made decided resource allocations for some container carrier entries, and does not want to alter this particular allocation.

In such cases, it is useful to only address a subset of the plurality of container carrier entries when allocating, optimizing, and/or processing. Thus, allocation or reallocation or resources can be avoided for entries for which such actions are not desired.

The subset of container carrier entries may for example be selected by a berth planner through a graphical user interface, e.g. by manually picking out entries on the user interface for which allocation, optimization, and/or processing are to be performed, or, alternatively, by picking out entries for which such actions should be not be performed.

In embodiments of the invention, said method comprises a step of operating said container carrier terminal by operating said terminal resources on the basis of said updated terminal resource plan.

In embodiments of the invention, said method comprises a step of operating said container carrier terminal by operating said terminal resources on the basis of said preliminary terminal resource plan.

In embodiments of the invention, said step of operating said container carrier terminal comprises operating one or more of said plurality of quay cranes on the basis of said updated terminal resource plan.

In embodiments of the invention, said step of operating said container carrier terminal comprises moving one or more of said plurality of quay cranes from a respective first quay crane position to a respective second quay crane position on the basis of said updated terminal resource plan.

The container carrier terminal may be operated based on, for example, the preliminary terminal resource plan, or the updated terminal resource plan.

By a first and second quay crane position is understood positions of a quay crane along a quay of the container carrier terminal. The first quay crane position may be a position along the quay where the quay crane has loaded/unloaded shipping containers from a first container carrier and the second quay crane position may be another position of the quay crane along the same quay where another container carrier is present and where loading/unloading of shipping containers is required. The first and second quay crane positions may also refer to positions of the crane adjacent to the same container carrier. For example, when a container carrier is berthing a redistribution of shipping containers may be needed, i.e. the quay crane may have to move a shipping container from one position to another position along the length of the container carrier.

In embodiments of the invention, said method comprises a step of performing said maintenance.

The maintenance may for example be performed by operational personnel of the container carrier terminal, such as maintenance engineers.

In embodiments of the invention, said step of allocating a respective subset of said terminal resources comprises identifying whether said allocated terminal resources comply with said preliminary terminal resource demand associated with said plurality of container carrier entries and providing at least one notice of violation when said allocated terminal resources does not comply with said preliminary terminal resource demand.

In some situations, it may not be possible to allocate terminal resources to a plurality of container carrier entries to comply with the preliminary terminal resource demand. Or the allocation results in a resource plan which does not comply with the terminal resource demand. The magnitude of the preliminary terminal resource demand may be greater than the terminal resources. E.g. the combined length of container carriers scheduled to lay along the quay be greater than the total length of the quay, or there may not be enough available quay cranes to fully load and unload all container carriers within their respective arrival and departure times.

Providing a notice of violations is advantageous, since it alerts a manager of a container carrier terminal that some type of adjustments may be necessary. Particularly, since embodiments of the invention are arranged to obtain a terminal resource plan far in advance of operation, providing a notice of violation allows adjustments of the container carrier terminal or of arrival and departure time, with minimal delays to delivery of containers to consumers and production facilities.

A notice of violation may for example be a message on a computer and may for example be provided to a user of the container carrier terminal system, e.g. a berth planner or manager of the container carrier terminal.

In embodiments of the invention, a notice of violation of said at least one notice of violation identify that said inoperative subset is allocated to a container carrier entry within said inoperative duration of time.

For example, a quay which is inoperative is allocated to a container carrier entry within a period in which it is inoperative. Or a quay crane which is inoperative is allocated to a container carrier entry within a period in which it is inoperative.

In embodiments of the invention, a notice of violation of said at least one notice of violation identify that a quay crane of said plurality of quay cranes is allocated to traverse said inoperative subset within said inoperative duration of time.

E.g., a crane has been scheduled to traverse another crane which is scheduled to undergo maintenance in which it is immovable.

In embodiments of the invention, said at least one notice of violation is a plurality of notices of violations, wherein each notice of violation of said plurality of notices of violations is provided for a respective subset of said preliminary terminal resource demand which does not comply with said allocated terminal resources.

In some situations, there may be multiple subsets of the preliminary terminal resource demand which cannot be met by the available terminal resources. For example, a lack of available quay cranes result in a temporary terminal resource plan in which multiple container carriers are not loaded and unloaded accordingly. A notice of violation may then be provided for each subset of the preliminary terminal resource demand, do not have allocated terminal resources.

Providing a dedicated notice of violation for each problem in a terminal resource plan is advantageous, since it alerts a manager of the container carrier terminal of each single problem.

In embodiments of the invention, each notice of violation of said at least one notice of violation is provided together with one or more violation solution suggestions, wherein implementation of a violation solution suggestion of said one or more violation solution suggestions in said preliminary terminal resource plan result in said allocated terminal resources complying with said subset of said preliminary terminal resource demand.

In embodiments of the invention, a violation solution suggestion of said one or more violation solution suggestions comprises changing any of said tentative arrival time, said tentative departure time, said terminal constraints, said preliminary terminal resource demand, and a quay crane efficiency.

A notice of violation may be provided together with violation solution suggestions. For example, if allocation of terminal resources cannot be performed such that a container is unloaded and/or loaded as required, a berth planner of the container carrier terminal system may receive a number of violation solution suggestions. For example, a tentative arrival time of the container carrier/container carrier entry may be changed to allow sufficient quay crane operations. Or similarly, the tentative departure time may be changed. Other violations solution suggestions may for example be to suggestion loading and/or unloading fewer shipping containers, change a (scheduled) quay crane efficiency, call in additional gangs of workers, add overtime for a gang of workers etc.

A quay crane efficiency may for example be crane GMPH which is crane gross-moves per hour, which is indicative of how many shipping containers or units of TEU a quay crane can transfer per unit of time.

In embodiments of the invention, said container carrier terminal system comprises at least one resource scenario, wherein each resource scenario of said at least one resource scenario is a graphical representation of at least one resource plan of any of said preliminary terminal resource plan and said updated terminal resource plan.

In embodiments of the invention, said at least one resource scenario is a plurality of resource scenarios comprising a master resource scenario and at least one auxiliary resource scenario, wherein said step of allocating a respective subset of said terminal resources is performed in one of said at least one auxiliary resource scenario, and wherein said master resource scenario is arranged to be updated on the basis of one of said at least one auxiliary resource scenarios.

In embodiments of the invention, said step of operating said container carrier terminal is based on said master resource scenario comprising said updated terminal resource plan.

In embodiments of the invention, each of said at least one auxiliary resource scenario is arranged to be edited by a user.

In embodiments of the invention, each resource scenario of said at least one resource scenario is associated with one or more scenario efficiency parameters, wherein said one or more scenario efficiency parameters are automatically calculated and indicative of an estimated efficiency of an associated resource scenario.

A resource scenario may comprise a preliminary terminal resource plan, an updated terminal resource plan, or both.

A resource scenario may be understood as a potential terminal resource plan.

A container carrier terminal system may for example comprise multiple resource scenarios, wherein the container carrier terminal is operated according to a master resource scenario of the resource scenarios. Alternative terminal resource plans may then be established as auxiliary resource scenarios and evaluated by a user. Upon generation of a preferable and/or more efficient terminal resource plan in an auxiliary resource scenario, the master resource scenario/master database may be updated by importing elements from that auxiliary resource scenario.

Having a resource allocation environment with multiple resource scenarios is advantageous, since it allows a user to test a multitude of various terminal resource planning strategies while maintaining a master resource scenario which the container carrier terminal is operated upon. As such, a better updated terminal resource plan can be established, with minimized risk of upsetting it.

Within an auxiliary resource scenario, a berth planner may input ghost entries of container carrier entries, which are current already in scheduled to berth via the master resource scenario. The berth planner may then freely adjust these ghost entries in one or more auxiliary resource scenarios without affecting the master resource scenario upon which the container carrier terminal is operated. If potentially the berth planner arrives at a better solution within an auxiliary resource scenario by adjusting ghost entries and resource allocations to these ghost entries, then parts of or an entire auxiliary resource scenario may be implemented in the master resource scenario.

Resource scenarios may for example be implemented in data processing equipment. They may for example have a graphical representation on a computer display. The different resource scenarios may for example be available in different tabs of a graphical user interface, which allows the user to quickly browse the various resource scenarios for comparison and optimization.

Scenario efficiency parameters may for example be indicative of crane allocation, gang allocation, idle time, etc.

In embodiments of the invention, said step of performing said maintenance is based on said master resource scenario.

In embodiments of the invention, said step of planning said maintenance is performed in one of said at least one auxiliary resource scenarios.

The different resource scenarios may thus have different constraints, e.g. different maintenance. Maintenance may thus for example be implemented or updated in a master resource scenario based on maintenance in an auxiliary resource scenario.

In an auxiliary resource scenario, various maintenance solutions and schedules can then be tested without affecting the master resource scenario, and if a the berth planner arrives at a suitable implementation of maintenance in an auxiliary scenario, this can be implemented in the master resource scenario.

The flexibility offered by having multiple resource scenarios is advantageous for planning maintenance, since such maintenance can be difficult to plan without readjusting allocation of terminal resources. However, readjustment of terminal resources may be undesirable if a somewhat functioning resource has already been established. An auxiliary resource scenario thus permits testing reallocation of terminal resources and adjustment of terminal constraints (such as maintenance) while maintaining a functioning master scenario, while potentially permitting an improved solution to be found via the auxiliary resource scenario.

In embodiments of the invention, said step of allocating a respective subset of said terminal resources is performed with respect to a long-term time window.

In embodiments of the invention, said providing an updated terminal resource demand is performed with respect to said long-term time window.

In embodiments of the invention, said processing an updated terminal resource plan is performed with respect to said long-term time window.

In embodiments of the invention, said long-term time window comprises at least one tentative arrival time of said plurality of container carrier entries.

In embodiments of the invention, said step of planning maintenance is performed within said long-term time window.

In embodiments of the invention, said long-term time window is from 2 days to 90 days, for example from 3 days to 60 days, such as from 5 days to 30 days, such as from 7 days to 14 days.

A step of the method of the invention performed with respect to a long-term time window may be understood as performing the step taking into account elements of the container carrier terminal and/or container carrier entries. For example, a respective subset of terminal resources is allocated to a terminal resource demand of a container carrier entry which has a tentative arrival time which is 14 days into the future.

Thus, the long-term time window lies relative of performing a relevant step of the method. E.g. in an embodiment of the invention, a long-term time window is from 7 to 14 days, and the step of processing an updated terminal resource plan is performed with a container carrier entry which has a tentative arrival time which lies 12 days after processing the updated terminal resource plan.

Performing steps of the method is not restricted to container carrier entries with tentative arrival times which lie within the long-term time window. In an embodiment of the invention, providing an updated terminal resource demand is performed with respect to container carrier entries which have tentative arrival times before, during, and after the long-term time window.

In an embodiment of the invention, said step of allocating is at least partly based on said tentative arrival times of said preliminary terminal resource demands.

It may be advantageous to take the tentative arrival times into consideration when allocating subsets of terminal resources to the container carrier entries. Thereby it may be determined which container carrier entries demand resources at the same time, neighboring times or are not related in time. The consideration of tentative arrival time may preferably be enhanced by also taking into account the expected duration and/or a tentative departure time. In preferred embodiments, the allocation is further based on other preliminary terminal resource demands and/or terminal constraints.

In an embodiment of the invention, said step of validating comprises establishing whether said allocated terminal resources comply with said tentative arrival times of said preliminary terminal resource demands.

In order to evaluate whether the established preliminary terminal resource plan may be problematic with respect to compliance between resources, demands and constraints, it may be advantageous to take into consideration the tentative arrival times comprises by the demands of container carrier entries, thereby making it possible to consider potential problems with the allocation for a specific point in time. For example, it may be possible when taking into account the tentative arrival time, which may be derived from other time values such as tentative departure time, estimated time of arrival, etc., to sum up how many cranes have been allocated for a specific date and time and compare with the total amount of cranes in the terminal.

An aspect of the invention relates to container carrier terminal system comprising data processing equipment configured to execute a model of a container carrier terminal, said model comprising representations of terminal resources and terminal constraints relating to said terminal resources; said terminal resources comprising a plurality of quay cranes and said representations of terminal resources including representations of said plurality of quay cranes;
the container carrier terminal system comprising an input configured to receive a plurality of container carrier entries, each container carrier entry relating to a container carrier and associated with a preliminary resource demand including a tentative arrival time, wherein said tentative arrival time is indicative of arrival of said container carrier to said container carrier terminal;
the container carrier terminal system being configured to allocate a respective subset of said terminal resources to each container carrier entry of said plurality of container carrier entries to obtain a preliminary terminal resource plan of allocated terminal resources, wherein said allocation comprises automatically validating and/or distributing terminal resources, including said plurality of quay cranes, to said plurality of container carrier entries to comply with said terminal constraints and said preliminary terminal resource demand associated with said plurality of container carrier entries, wherein said terminal constraints comprises maintenance.

In embodiments of the invention, said container carrier terminal system is configured to carry out the method of any of embodiment of the invention.

An aspect of the invention relates to a container carrier terminal comprising a plurality of quay cranes and the container carrier terminal system of any embodiment of the invention.

In embodiments of the invention, said container carrier terminal is configured to operate said plurality of quay cranes on the basis of said updated terminal resource plan.

An aspect of the invention relates to computer program comprising instructions which, when the program is executed by a computer, cause the computer to carry out the following steps:
execute a model of a container carrier terminal, said model comprising representations of terminal resources and terminal constraints relating to said terminal resources; said terminal resources comprising a plurality of quay cranes and said representations of terminal resources including representations of said plurality of quay cranes;
receive via an input plurality of container carrier entries, each container carrier entry relating to a container carrier and associated with a preliminary resource demand including a tentative arrival time, wherein said tentative arrival time is indicative of arrival of said container carrier to said container carrier terminal;
allocate a respective subset of said terminal resources to each container carrier entry of said plurality of container carrier entries to obtain a preliminary terminal resource plan of allocated terminal resources, wherein said allocation comprises automatically validating and/or distributing terminal resources, including said plurality of quay cranes, to said plurality of container carrier entries to comply with said terminal constraints and said preliminary terminal resource demand associated with said plurality of container carrier entries, wherein said terminal constraints comprises maintenance.

In embodiments of the invention, said computer program further comprises instructions to cause the computer to carry out the following step: operating said plurality of quay cranes on the basis of said updated terminal resource plan.

In embodiments of the invention, said computer program further comprises instructions to cause the computer to carry out the method of any of embodiment of the invention.

### THE DRAWINGS

Various embodiments of the invention will in the following be described with reference to the drawings where

FIG. 1 illustrates a container carrier to be operated according to embodiments of the invention,

FIG. 2 illustrates the relationship between a container carrier and a so-called container carrier entry,

FIG. 3 illustrates exemplary hardware properties related to a container carrier terminal system according to embodiments of the invention,

FIG. 4 discloses and explains ways of organizing data records in embodiments a container carrier terminal system within the scope of the invention,

FIG. 5a-5c illustrate an exemplary graphical user interface which may be applied in a container carrier terminal system within the scope of the invention,

FIG. 6 illustrates some basic principles of a container carrier entry,

FIG. 7 illustrate how container carrier entries may very over time,

FIG. 8 illustrates how container carrier entries may very over time relative to the time at the final execution,

FIG. 9 illustrates a progressive update of terminal resource plans within the scope of the invention,

FIG. 10 illustrates how terminal resources may be affected during operation of a terminal,

FIG. 11 illustrates the use of ghost entry/entries within the scope of the invention,

FIG. 12 illustrates the use of multiple scenarios when modifying specified entries for fitting into terminal resource plan,

FIG. 13a-c illustrate examples of implementation of maintenance according to the invention,

FIG. 14 illustrates deprioritizing of an unhealthy crane according to the invention,

FIG. 15a-b illustrate another example of implementation of maintenance according to the invention,

FIG. 16 illustrates a maintenance request and resulting planning of maintenance according to the invention,

FIG. 17a-c illustrates solution to breakdown maintenance according to the invention,

FIG. 18 illustrates an exemplary graphical user interface according to an embodiment of the invention, and

FIG. 19 illustrate a way of processing a validation of a scenario in an embodiment of the invention.

### DETAILED DESCRIPTION

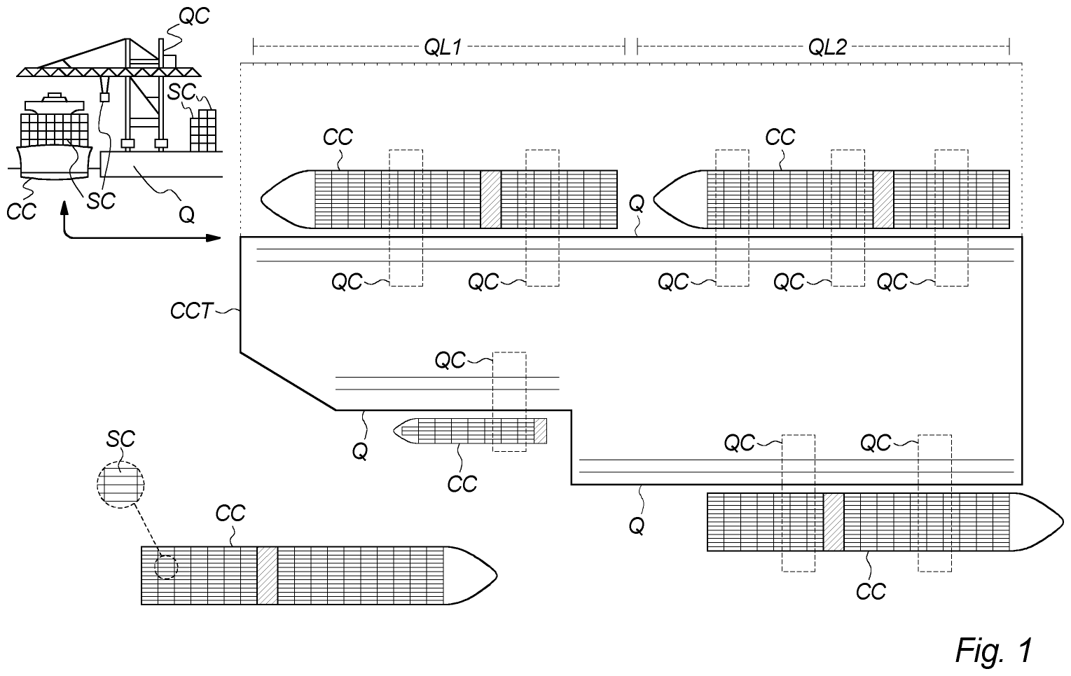

FIG. 1 illustrates a container carrier terminal CCT for handling container carriers CC of different sizes according to embodiments of the invention. The container carrier terminal CCT comprises three quays Q at which container carriers Q may berth, as well as a plurality of quay cranes QC disposed at the quays Q. As shown in FIG. 1, four container carriers CC are currently berthing at the container carrier terminal CCT at the quays Q of the container carrier terminal CCT and being serviced by the quay cranes QC.

The figure additionally illustrates a side view of one of the container carriers CC and one of the quay cranes QC.

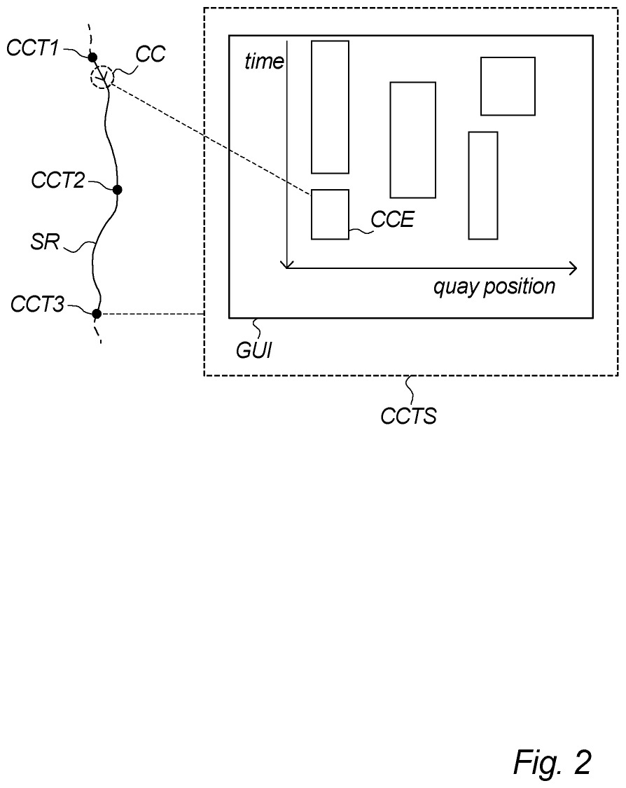

FIG. 2 illustrates a relationship between a container carrier CC and a container carrier entry CCE according to embodiments of the invention. As shown in the figure, a container carrier CC is sailing along a sailing route SR which includes stops, or port calls, at three container carrier terminals CCT1-CCT3. At each container carrier terminal, shipping containers are loaded, unloaded, and/or redistributed on the container carrier CC. As shown, the third container carrier terminal CCT3 is associated with a container carrier terminal system CCTS that is used for scheduling the logistics of the operations of the third container carrier terminal CCT3, including allocation of terminal resources to container carriers destined for arrival and berthing at the third container carrier terminal CCT3. The terminal resources include cranes and berth maintenance (not shown). As the container carrier CC is destined for arrival and berthing at the third container carrier terminal CCT3, a digital representation of the container carrier CC is present in the container carrier terminal system CCTS in the form of a container carrier entry CCE. As shown, the container carrier terminal system CCTS comprises a graphical user interface GUI which shows a graphical representation of the container carrier entry CCE.

The container carrier entry CCE comprises a tentative arrival time and a tentative departure time which is depicted in the graphical user interface GUI.

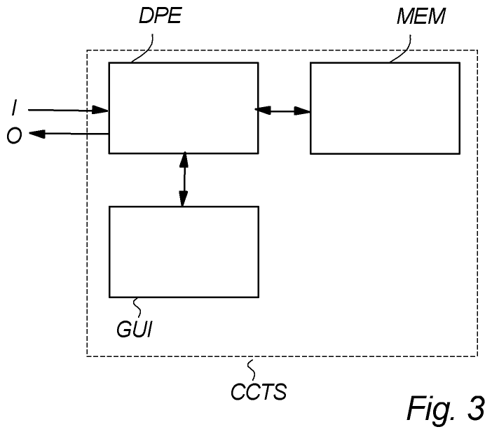

FIG. 3 illustrates a hardware setup of a container carrier terminal system CCTS within the scope of the invention. The container carrier terminal system CCTS comprises data processing equipment DPE. The data processing equipment here communicates with associated hardware memory MEM. The memory may be part of a device, apparatus or structure including the data processing equipment is located or it may be cloud based. The data processing equipment DPE is communicating with the outside world via an input I and a user interface GUI. It should be noted that the physical implementation of either input (I) or output (O) may vary depending on whether inputs are merely channelled to the data processing equipment DPE e.g. via dedicated communication link as shown here, or it may be communicated to and from the outside world via a user interface including a graphical user interface GUI as shown here.

The graphical user interface GUI be an output device which display information in a pictorial form, such as a computer monitor. It can for example receive its output from the data processing equipment via digital communication, and thus provide relevant information and facilitate interactions between the processing equipment DPE and the berth planner.

Other ways of structuring the physical data processing may be applied within the scope of the invention as long as the inventive provisions are applied and executed by means of the physical system.

It should also be noted that data bases may be applied for containing and processing both a preliminary and an updated terminal resource plan or plans.

The data processing equipment may comprise program logic configured to perform logic operations, so as to facilitate algorithms, calculations, optimizations, validations, and other computer-related operations in relation to records representing demands, e.g. container carrier entries, and records representing terminal resources, such as cranes.

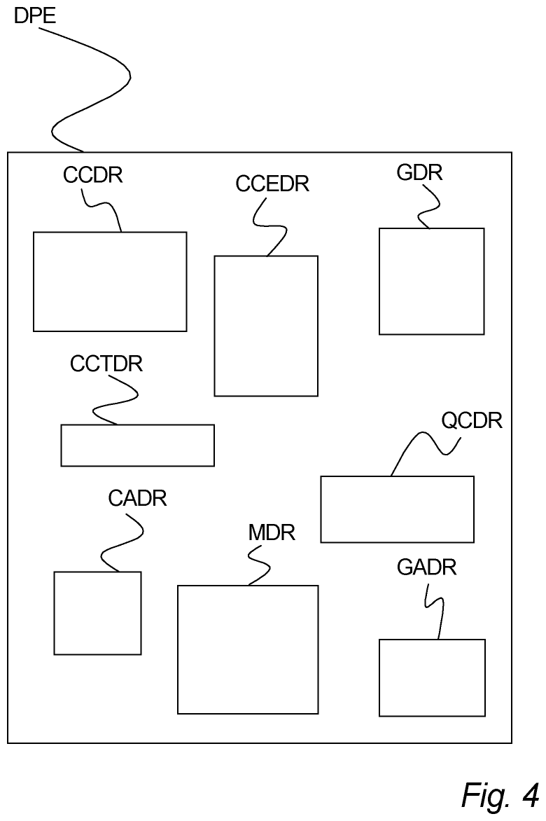

FIG. 4 illustrates data processing equipment DPE comprising different records of relevance to embodiments of the invention. Data processing equipment DPE may for example be one or more computers/servers, for example based on cloud storage.

The data processing equipment DPE comprises at least one or more crane allocation data records CADR, one or more container carrier entry data records CCEDR, one or more container carrier data records CCDR, one or more gang data records GDR, one or more maintenance data records MDR, one or more container carrier terminal data records CCTDR, one or more gang allocation data records GADR, and one or more quay crane data records QCDR.

A quay crane data record QCDR may be understood as a digital record of a quay crane. In this exemplary embodiment, this record comprises the information shown here:

| Field | Value | |
|---|---|---|
| ID | 1 | |
| Name | QC01 | |
| Height | 53 | meters |
| Outreach | 70 | meters |
| Range from | 100 | meters |
| Range to | 800 | meters |

A container carrier data record CCDR may be understood as a digital record of a container carrier. In this exemplary embodiment, this record comprises the information shown here:

| Field | Value | |
|---|---|---|
| ID | 123 | |
| IMO | 9778791 | |
| Name | Madrid Maersk | |
| Length | 399 | meters |
| Beam | 58.6 | meters |
| Total cargo capacity | 20,568 | TEU |

A container carrier entry data record CCEDR may be understood as a digital record of a container carrier entry. In this exemplary embodiment, this record comprises the information shown here:

| Field | Value |
|---|---|
| ID | 123 |
| Vessel_ID | 123 |
| Service | Asia Europe (AE10) |
| Moves Load | 200 |
| Moves reload | 400 |
| Moves redistribute | 50 |
| GMPH | 30 |
| Target vessel rate | 80 |
| Pilot station arrival | Feb. 4, 2020 11:00 |
| Berth arrival | Feb. 4, 2020 12:00 |
| Cargo start | Feb. 4, 2020 12:00 |
| Cargo end | Feb. 4, 2020 18:00 |
| Berth departure | Feb. 4, 2020 18:10 |
| Maximum cranes | 6 |
| Quay start | 400 |
| Quay end | 799 |

Here, the berth arrival or the cargo start may for example be the tentative arrival time, and the berth departure or the cargo end may be the tentative departure time.

A crane allocation data record CADR may be understood as a digital record of a crane allocation/quay crane allocation. In this exemplary embodiment, this record comprises the information shown here:

| Field | Value |
|---|---|
| Crane_ID | 1 |
| Port call: | 123 |
| Start | Feb. 4, 2020 12:00 |
| End | Feb. 4, 2020 18:00 |

Here, the port call may be understood as the container carrier entry.

A maintenance data record MDR may be understood as a digital record of a maintenance, e.g. a maintenance of a quay crane or a part of a quay. In this exemplary embodiment, this record comprises the information shown here:

| Field | Value |
|---|---|
| Crane_ID | 1 |
| Maintenance type | Corrective maintenance |
| Start | Jan. 2, 2020 11:00 |
| End | Jan. 2, 2020 23:00 |

A gang data record GDR may be understood as a digital record of a gang of workers. In this exemplary embodiment, this record comprises the information shown here:

| Field | Value |
|---|---|
| Gang_ID | 2 |
| Number of workers | 10 |
| Regular shift start | 8:00 |
| Regular shift end | 16:00 |

A gang allocation data record GADR may be understood as a digital record of an allocation of a gang, e.g. to a quay crane. In this exemplary embodiment, this record comprises the information shown here:

| Field | Value |
|---|---|
| Gang_ID | 2 |
| Crane_ID | 1 |
| Port call | 123 |
| Allocation start | Feb. 4, 2020 12:00 |
| Allocation end | Feb. 4, 2020 16:00 |

A container carrier terminal data record CCTDR may be understood as a digital record of a container carrier terminal. In this exemplary embodiment, this record comprises the information shown here:

| Field | Value |
|---|---|
| terminal_ID | 321 |
| Number of gangs 8:00-16:00 | 10 |
| Number of gangs 16:00-24:00 | 8 |
| Number of gangs 00:00-08:00 | 6 |
| Number of cranes | 8 |
| Quay length | 1000 meters |
| Allocation end | Feb. 4, 2020 16:00 |

The above examples of records should be seen as exemplary. Any records according to embodiments of the invention may comprise any information and be linked in any manner within the scope of the invention as defined by the claims.

In another exemplary embodiment, a maintenance data record may for example comprise the following information:

| Field | Value |
|---|---|
| Quay part | 200-400 meters |
| Maintenance type | Preventive maintenance |
| Start | Jan. 2, 2020 8:00 |
| End | Jan. 2, 2020 16:00 |

This information may for example relate to quay maintenance. The quay part thus refers to a part of the quay. The quay may for example be 1000 meters long, and the preventive maintenance relate to the part which extend from a point at 200 meters to a point at 400 meters, measured form one end of the 1000 meter quay.

Maintenance data records may alternatively relate to bollard maintenance, and thus indicate a bollard number and/or position (along with maintenance type, start and end). Or a maintenance data record may relate to dredging maintenance, or cleanup maintenance, which similarly to quay maintenance may relate to a part of a quay.

In particular, it should be mentioned that quay crane records and/or their associated maintenance within the scope of the present invention may be represented in numerous different ways as long as the allocation of a terminal resource in the form of a quay crane may be allocated in the system for use in connection with container carriers and their respective associated container carrier entries. It should also be noted that the maintenance and preferably also restrictions/constraints resulting from a planned maintenance related to e.g. cranes and/or berth should be contained and be processable to a degree that makes it possible to automatically calculate/validate whether the a planned maintenance of one terminal resource affect the functioning/applicability of further non-maintained resources.

Such constrictions may be applied or contained in separate records but they may e.g. also be contained in relevant resource records. An example of such may be a crane record including e.g. location at where the crane is or is to be maintained and also an information of whether the crane can be moved. This has the effect that a crane which is down for breakdown maintenance may be identified as non-movable and therefore blocking for movement of neighboring cranes and therefore making these neighboring cranes non-usable or restricted during maintenance. Other such “cross” terminal resource constraints may be applied or included for automatic calculation/validation of applicability of terminal resources, i.e. whether these are available or to what degree they are available.

An exemplary model which may be applied in a container carrier terminal system within the scope of the invention is disclosed and explained below. Other types of models and optimizations of such may be applied widely within the scope of the invention.

The model described below may also be referred to as a berth optimization model, as the model facilitates optimization of the operation of a terminal operating according to the progressing updated terminal resource plan in compliance and by means of the overall combined model. Here and elsewhere it should be noted that a port call corresponds to a container carrier entry according to the provisions of the invention and that the below referred set of all port calls P may refer to the elsewhere referred plurality of container carrier entries CCE. In the same way, arrival time may refer to what is elsewhere in the application mentioned as tentative arrival time. Please also note that time slots in the below model/models refers to units of time slots of one hour rather referring to a complete time window. A time window may thus be defined by one or a plurality of time slots.

First sets and parameters are outlined:

Sets and Parameters
P Set of all port call
B Set of all berth positions. A berth position is defined by a quay location, an arrival time, and a departure time
B^{p}⊂B Set of all feasible berth positions for port call p∈P. To determine this set, we consider characteristics such as how many and what kind of cranes can reach this position
p^{b}⊂P Set of all port calls that can be assigned to berth position b∈B
[symbol] penalty associated with allocating port call p∈P to berth position b∈B^{p}
[symbol] arrival time of berth position b∈B
I Set of pairwise incompatible berth positions. If (b¹, b²)∈I, with b₁,b₂∈B, then any feasible solution cannot contain port calls in both b₁ and b₂
O Pairwise precedence set, defining the order in which port calls should berth. If a pair of port calls (p₁,p₂)∈O, this means that the berth position selected Or port call p₁ should have art earlier arrival time than the berth position selected for port call p₂

We consider several different aspects to calculate [symbol] :
difference between the position of b and the desired position of port call p
difference between the arrival time of b and the desired arrival time of port call p
number of cranes that can reach position b
characteristics of the cranes that can reach position b, in terms of productivity, range, and outreach
yard driving distances to pick up containers to be loaded on the port call

All these items have different weights in their contribution to

[symbol]

Variables
x_{pb}∈[0,1] Binary variables, equal to 1 if and only if port call p∈P is assigned to berth position b∈B^{p}

Objective Function and Constraints

The exemplary mathematical model for Berth Optimization is presented below:

$$\begin{matrix}min & {\sum }_{p ∈ P} {\sum }_{b ∈ {B}^{p}} {w}_{pb} \cdot {x}_{pb}\end{matrix} \qquad ( 1 )$$

$$\begin{matrix}s . t . {\sum }_{b ∈ {B}^{p}} {x}_{pb} = 1 & ∀ p ∈ P\end{matrix} \qquad ( 2 )$$

$$\begin{matrix}{\sum }_{p ∈ {P}^{{b}_{1}}} {x}_{{pb}_{1}} + {\sum }_{p ∈ {P}^{{b}_{2}}} {x}_{{pb}_{2}} \leq 1 & ∀ ( {b}_{1} , {b}_{2} ) ∈ I\end{matrix} \qquad ( 3 )$$

$$\begin{matrix}{\sum }_{b ∈ {B}^{{p}_{1}}} {x}_{{p}_{1} b} \cdot {b}_{a} < {\sum }_{b ∈ {B}^{{p}_{2}}} {x}_{{p}_{2} b} \cdot {b}_{a} & ∀ ( {p}_{1} , {p}_{2} ) ∈ O\end{matrix} \qquad ( 4 )$$

$$\begin{matrix}{x}_{pb} ∈ \{ 0 , 1 \} & ∀ p\end{matrix} ∈ P , b ∈ {B}^{p} \qquad ( 5 )$$

The objective function (1) minimizes the penalties associated with the berth positions chosen for each port call. Constraints (2) ensure that we select exactly one berth position for each port call. Constraints (3) ensure that incompatible berth positions are not selected simultaneously, ensuring conflict free solutions. Constraints (4) ensure that the priorities between port calls are respected. Finally, constraints (5) define the domain of the decision variables.

Furthermore, the exemplary overall model may include a crane optimization model:

Sets and Parameters
P Set of all port calls
pₕ Minimum number of crane hours to be assigned to port call p∈P, determined based in the number of moves to be performed
[symbol] Maximum number of cranes that can be assigned to port call p∈P in the same time slot, determined by vessel characteristics
C Set of all cranes
C^{p}⊂C Set of all cranes that can be assigned to port call p∈P. This takes into account crane characteristics such as range, productivity, or crane height, and port call characteristics such as vessel length, vessel beam, and position of the port call
T Set of all time slots in the planning horizon, being a time slot equal to 1 hour
T^{p}⊂T Set of all time slots overlapping the port stay of port call p∈P
[symbol] P Set of all port calls that contain time slot [symbol] T in their port stay
S Set of all shifts in the planning horizon
[symbol] T Set of all time slots of shift [symbol] S
[symbol] Cost of using a gang in shift [symbol] S

Variables
[symbol] {0,1} Binary variables, equal to 1 it and only if crane c∈C^{p} is assigned to port call p∈P in time slot t∈T^{p}
[symbol] Positive integer variables, representing the number of gangs used in shift [symbol] S

The exemplary mathematical model for Crane Optimization is presented below:

Objective Function and Constraints

$$\begin{matrix}min & {\sum }_{s ∈ S} {w}_{s} \cdot {y}_{s}\end{matrix} \qquad ( 6 )$$

$$\begin{matrix}s . t . {\sum }_{c ∈ {C}^{p}} {\sum }_{t ∈ {T}^{p}} {x}_{cp}^{t} \geq {p}_{h} & ∀ p ∈ P\end{matrix} \qquad ( 7 )$$

$$\begin{matrix}{\sum }_{c ∈ {C}^{p}} {x}_{cp}^{t} \leq {p}_{max C} & ∀ p ∈ P , t ∈ {T}^{p}\end{matrix} \qquad ( 8 )$$

$$\begin{matrix}{\sum }_{p ∈ {P}^{t}} {\sum }_{c ∈ {C}^{p}} {x}_{cp}^{t} \leq {y}_{s} & ∀ s ∈ S , t ∈ {T}^{s}\end{matrix} \qquad ( 9 )$$

$$\begin{matrix}{x}_{cp}^{t} ∈ \{ 0 , 1 \} & ∀ p ∈ P , c ∈ {C}^{p} , t ∈ {T}^{p}\end{matrix} \qquad ( 10 )$$

$$\begin{matrix}{y}_{s} ∈ {ℤ}_{0}^{†} & ∀ s ∈ S\end{matrix} \qquad ( 11 )$$

The objective function (6) minimizes the costs associated with the gangs used in all shifts in the planning horizon. Constraints (7) ensure that we have enough crane hours assigned to each port call. Constraints (8) ensure that at each time slot, the maximum number of cranes for each port call is respected. Constraints (9) determine the number of gangs used in each shift. Finally, constraints (10) and (11) define the domain of the decision variables.

Furthermore, the exemplary overall model may include a maintenance optimization model:

Sets and Parameters
P Set of all port calls
[symbol] Minimum number of crane hours to be assigned to port call p∈P, determined based in the number of moves to be performed
[symbol] Maximum number of cranes that can be assigned to port call p∈P in the same time slot, determined by vessel characteristics
C Set of all cranes
[symbol] C Set of all cranes that can be assigned to port call p∈P. This takes into account crane characteristics such as range, productivity, or crane height, and port call characteristics such as vessel length, vessel beam, and position of the port call
T Set of all time slots in the planning horizon, being a time slot equal to 1 hour
T^{p}∈T Set of all time slots overlapping the port stay of port call p∈P
Pⁱ⊂P Set of all port calls that contain time slot i∈T in their port stay
S Set of all shifts in the planning horizon
[symbol] T Set of all time slots of shift [symbol] S
[symbol] Cost of using a gang in shift [symbol] S
M Set of all crane maintenance activities to be performed in the planning horizon
M^{N}⊂M Set of all non-movable crane maintenance activities to be performed in the planning horizon
M^{M}⊂M Set of all movable crane maintenance activities to be performed in the planning horizon
cₘ Crane c∈C associated with crane maintenance m∈M
dₘ Required duration of crane maintenance m∈M in number of time slots
pₘ Position of crane maintenance m∈M^{N}
rₘⁱ Cost of performing maintenance m∈M at time t∈T
[symbol] binary indicator matrix that takes the value of 1 if crane [symbol] C cannot be used on port call p∈P when crane cₘ is assigned to non movable crane maintenance m∈M^{N}.

Variables
x_{cp}ⁱ∈{0,1} Binary variables, equal to 1 if and only if crane c∈C^{p} is assigned to port call p∈P in time slot [symbol] T
uₐ∈ [symbol] Positive integer variables, representing the number of gangs used in shift [symbol] S
zₘ^{t}∈{0,1} Binary variables, equal to 1 if and only if crane maintenance m∈M starts in time slot t∈T
θ [symbol] [0,1} Binary variables, equal to 1 if and only if crane c∈C is under maintenance in time slot t∈T

The mathematical model for Maintenance Optimization is presented below:

$$\begin{matrix}min & {\sum }_{s ∈ S} {w}_{s} \cdot {y}_{s} + {\sum }_{m ∈ M} {\sum }_{t ∈ T} {r}_{m}^{t} \cdot {z}_{m}^{t}\end{matrix} \qquad ( 12 )$$

$$\begin{matrix}s . t . {\sum }_{c ∈ {C}^{p}} {\sum }_{t ∈ {T}^{p}} {x}_{cp}^{t} \geq {p}_{h} & ∀ p ∈ P\end{matrix} \qquad ( 13 )$$

$$\begin{matrix}{\sum }_{c ∈ {C}^{p}} {x}_{cp}^{t} \leq {p}_{max C} & ∀ p ∈ P , t ∈ {T}^{p}\end{matrix} \qquad ( 14 )$$

$$\begin{matrix}{\sum }_{p ∈ {P}^{t}} {\sum }_{c ∈ {C}^{p}} {x}_{cp}^{t} \leq {y}_{s} & ∀ s ∈ S , t ∈ {T}^{s}\end{matrix} \qquad ( 15 )$$

$$\begin{matrix}{\sum }_{t ∈ T} {z}_{m}^{t} = 1 & ∀ m ∈ M\end{matrix} \qquad ( 16 )$$

$$\begin{matrix}{z}_{m}^{{t}_{1}} \leq {θ}_{{c}_{m}}^{{t}_{2}} & ∀ m ∈ M , {t}_{1} ∈ T , {t}_{2} ∈\end{matrix} \{ {t}_{1} , {t}_{1} + 1 , … , {t}_{1} + {d}_{m} - 1 \} \qquad ( 17 )$$

$$\begin{matrix}{θ}_{c}^{t} \leq 1 - {x}_{cp}^{t} & ∀ c ∈ C ,\end{matrix} t ∈ T , p ∈ P \qquad ( 18 )$$

$$\begin{matrix}{θ}_{{c}_{m}}^{t} + {u}_{{c}_{1} , {c}_{m} , p} \leq 2 - {x}_{{c}_{2} , p}^{t} & ∀ m ∈ {M}^{N} , {c}_{m} ∈ C , {c}_{1} ∈ C , t ∈ T , p ∈ P\end{matrix} \qquad ( 19 )$$

$$\begin{matrix}{x}_{cp}^{t} ∈ \{ 0 , 1 \} & ∀ p ∈ P ,\end{matrix} c ∈ {C}^{p} , t ∈ {T}^{p} \qquad ( 20 )$$

$$\begin{matrix}{y}_{s} ∈ {ℤ}_{0}^{†} & ∀ s ∈ S\end{matrix} \qquad ( 21 )$$

$$\begin{matrix}{z}_{m}^{t} ∈ \{ 0 , 1 \} & ∀ m ∈ M ,\end{matrix} t ∈ T \qquad ( 22 )$$

$$\begin{matrix}{θ}_{c}^{t} ∈ \{ 0 , 1 \} & ∀ c ∈ C ,\end{matrix} t ∈ T \qquad ( 23 )$$

The objective function (12) minimizes the costs associated with the gangs used in all shifts in the planning horizon and the cost of performing the maintenance at the chosen time. Constraints (13) ensure that we have enough crane hours assigned to each port call. Constraints (14) ensure that at each time slot, the maximum number of cranes for each port call is respected. Constraints (15) determine the number of gangs used in each shift.

Constraints (16) ensure that all crane maintenance activities are performed within the planning horizon. Constraints (17) are linking constraints between the z and θ variables, setting the values for the latter depending on the starting time selected for each maintenance activity. Constraints (18) ensure that cranes under maintenance are not assigned to port calls in the time slots where maintenance occurs. Constraints (19) ensure that cranes are not assigned to port calls they cannot reach due to non-movable crane maintenance activities. This is modelled using the binary indicator matrix u, which prevents cranes from crossing other cranes under non-movable maintenance. Given that the crane under non-movable crane maintenance is in a fixed position, the model can determine if two cranes are crossing if the one with the lower sequence is allocated at a higher position i.e. the following condition is true crane1.sequence<crane2.sequence and crane1.position>crane2.position. The sequence is the order of the cranes on the rails. The positions are given by the position of the maintenance and the position of the port call we want to assign the crane to.

Finally, constraints (20)-(23) define the domain of the decision variables.

The three above models may be applied in combination according to the provisions of the invention for automatically validating of container carrier entries and associated allocated terminal resources. Optimization may thus be applied for both berth positions and crane allocations. Further models may be included e.g. to describe and optimize with respect to internal terminal logistics, container distribution at the terminal etc.

The models may also be applied for optimization by validation of manual input of alternative configurations of one or groups of containers carrier entries. In a particular advantageous embodiment of the invention, the models or variations thereof may be applied for automatically suggesting modifications of particular entries and also for suggesting modifications of container carrier entries affected by a first modification of an entry leading to conflict with the particular entries.

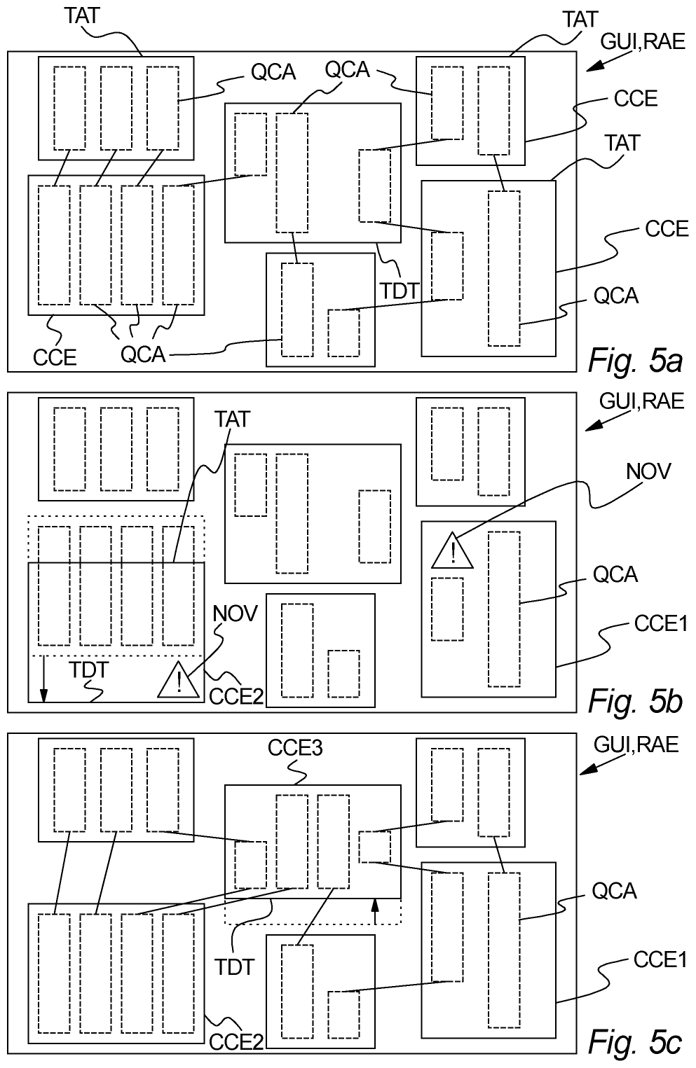

FIG. 5a-5c illustrate allocation of terminal resources, providing an updated terminal resource demand, and processing an updated terminal resource plan, e.g. reallocation of terminal resources. Each of the subfigures, 5a, 5b, and 5c is a graphical user interface GUI showing a representation of a resource allocation environment RAE. The vertical direction in each of the subfigures indicate time, and the horizontal direction indicate position along the quay of the container carrier terminal.

The graphical user interface GUI showing the resource allocation environment RAE is part of a container carrier terminal system and allows a user to allocate and monitor container carrier entries and quay crane allocation QCA with respect to these container carrier entries CCE. In the graphical user interface, the location and extend of a container carrier entry in the horizontal direction indicate an allocated quay location and quay length of the container carrier entry and its associated container carrier. The location and extend of a container carrier entry CCE along the vertical direction indicate the tentative arrival time TAT and tentative departure time TDT. In this embodiment, the shown plan is executed from top to bottom, i.e. the arrow of time and the time axis points downwards.

In FIG. 5a, a plurality of container carrier entries CCE are shown in in the graphical user interface GUI. A total of seven cranes have been allocated to these container carrier entries according to an embodiment of the invention. That is, the quay cranes have been automatically allocated to the container carrier entries to comply with their preliminary terminal resource demand and their tentative arrival and departure time. In the graphical user interface GUI, each quay crane allocation QCA is indicated by a rectangle located in relation to a container carrier entry CCE. Allocation of a single quay crane to several quay crane allocations QCA is indicated by lines extending between these quay crane allocations QCA.

The various quay crane allocations QCA of an individual container carrier entry CCE does not necessarily have the same extend. The summarized extend of the quay crane allocations QCA of a given container carrier entry ensure that the terminal resource demand of the container carrier entry is met. For example, a container carrier which is expected to have relatively many shipping containers loaded and/or unloaded has a larger summarized extend of quay crane allocations QCA than a container carrier which is expected to have relatively fewer shipping containers loaded and/or unloaded. Note that the maximum number of quay cranes associated with a container carrier/container carrier entry is not necessarily allocated to a container carrier entry. For example, a container carrier may be arranged to have four quay cranes to simultaneously perform transfer of containers, but only three are allocated.

In this embodiment, the allocation is performed based on crane allocation constraints. For example, quay cranes are not allocated such that they are required to cross each other along the quay during operation. Further, each quay crane is not allocated to more than one crane time window at a time. Additionally, the allocation has been performed with respect to a built-in movement time of cranes between different positions along the quay. However, note that embodiments of the invention are not restricted to particular crane allocation constraints.

In some embodiments, the allocation is performed at least partially manually. In some embodiments, the allocation is performed automatically. The allocation may further be based on an optimization, for example an optimization to maximize the potential reduction of greenhouse gases by minimizing the potential expected durations 13 of the container carrier entries 6.

The shown allocation of quay cranes to container carrier entries CCE is an example of a preliminary terminal resource plan. It may for example have been established several weeks prior to the tentative arrival time of any of the entries shown in the graphical user interface.

In FIG. 5b, a later version of the terminal resource plan as shown in FIG. 5a is shown. In FIG. 5b, the container carrier terminal system has received an updated terminal resource demand. A container carrier associated with a first container carrier entry CC1 have informed that more shipping containers requires to be unloaded than previously expected. Consequently, the current quay crane allocation is insufficient. In such cases, the container carrier terminal system is arranged to provide a notice of violation NOV, which is shown in the graphical user interface GUI and which is linked to the container carrier entry CCE1. The user may digitally interact with this notice of violation to receive information about the violation and to receive violation solution suggestions. The displaying of notice of violation NOV may advantageously be based on the automatically performed validation of entry/entries as described further in detail elsewhere in the present application.

Additionally, another container carrier associated with a second container carrier entry have informed that the container carrier is delayed and will arrive later than previously expected. In the graphical user interface, the container carrier entry CCE2 have been shifted downwards corresponding to the delay, such that the tentative arrival time TAT and the tentative departure time are both later. Consequently, the quay crane allocations QCA do no longer lie properly within the container carrier entry. Since the parts of the quay crane allocations QCA which lie within the container carrier entry CCE2 are insufficient to perform the expected loading and unloading of containers, a notice of violation NOV is provided and shown in the graphical user interface GUI and linked to the container carrier entry CCE2.

Upon receiving the updated tentative arrival time and terminal resource demand, the preliminary terminal resource plan of allocated terminal resource does no longer comply with the terminal resource demand. Accordingly, the plan can be updated to establish an updated terminal resource plan.

In FIG. 5c, terminal resources have been redistributed. The principles of this new allocation of quay cranes is substantially similar to the principles used for the quay crane allocation illustrated in FIG. 5a, but the updated container carrier entries and updated terminal resource demands have been used. For example, the quay cranes have been allocated using similar constraints.

The new quay crane allocations QCA shown in FIG. 5c have ensured that the allocated terminal resource, including the quay cranes, comply with the updated terminal resource demand. Further, the delay of the container carrier associated with a container carrier entry CCE2 have enables quay crane allocation to be redistributed in a manner which allow a third container carrier associated with a third container carrier entry CCE3 to be unloaded and loaded more quickly, such that its tentative departure time lies earlier. This ensures that this container carrier may reduce its cruising speed towards the next container carrier terminal to reduce emission of greenhouse gases.

As such, the processing of an updated terminal resource plan on the basis of an updated terminal resource demand be means of the computer implemented container carrier terminal system have ensured that cargo, which could otherwise be greatly delayed, may be properly loaded and unload in the container carrier system, while simultaneously reducing emission of greenhouse gases.

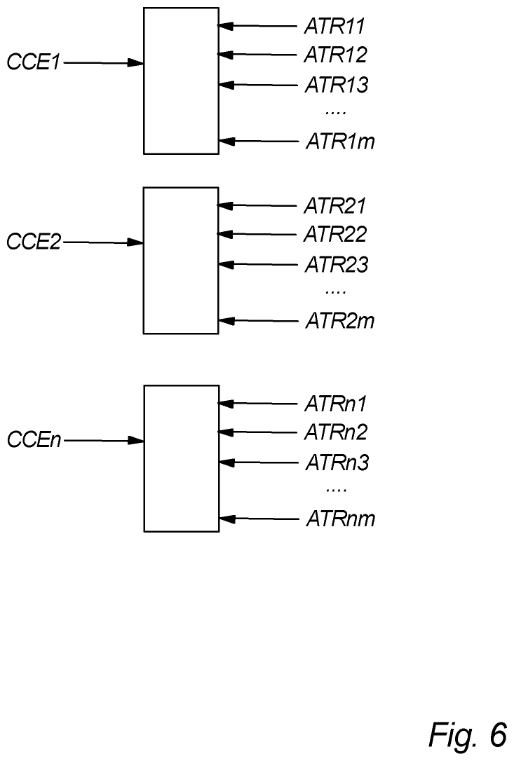

FIG. 6 illustrates some principles relating to the understanding of a representation of terminal resources and how these are allocated to container carrier entries.

The figure shows how a number of container carrier entries CCE1, CCE2, CCEn are each associated with corresponding representations of terminal resources.

Thus, a first container carrier entry CCE1, e.g. a specific carrier or a carrier having specified properties, is allocated corresponding terminal resources here described by representations of terminal resources ATR11, ATR12, ATR13 . . . ATR1m.

A second container carrier entry CCE2, also a specific carrier or a carrier having specified properties, is allocated corresponding terminal resources here described by representations of terminal resources ATR21, ATR22, ATR23 . . . ATR2m, etc.

All resources are associated with respective specified time slots and a subset of terminal resources are allocated for the purpose of fulfilling the requirement of a demand related to the respective entries.

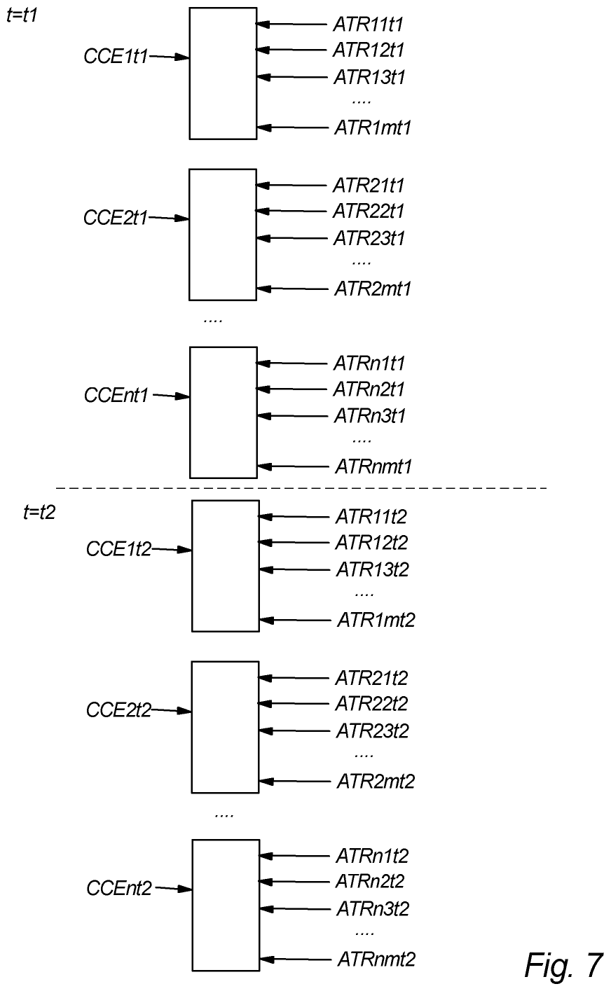

FIG. 7 illustrates some principles relating to the understanding of a representation of terminal resources and how these are allocated to container carrier entries over time.

The figure shows how a number of container carrier entries CCE1t1, CCE2t1, CCEnt1 each are associated with corresponding representations of terminal resources at a given time t1.

Thus, a first container carrier entry CCE1t1, e.g. a specific carrier or a carrier having specified properties, is allocated corresponding terminal resources here described by representations of terminal resources ATR11t1, ATR12t1, ATR13t1 . . . ATR1mt1 at the time t1.

A second container carrier entry CCE2t1, also a specific carrier or a carrier having specified properties, is allocated corresponding terminal resources here described by representations of terminal resources ATR21t1, ATR22t1, ATR23t1 . . . ATR2mt1 at the same time t1.

All resources are associated with respective specified time slots and a subset of terminal resources are allocated for the purpose of fulfilling the requirement of a demand related to the respective entries at the given time t1. It should be noted that that allocated resources may include time slots, including at least specification of absolute time so that conflict may be avoided between allocated resources. It should also be noted that the time slots are future to the time t1 in the present context. In other words, the allocated terminal resources are here specified and stored as they are determined to be in the future at the “present” time t1.

At the time t2 updated carrier entries container CCE1t2, CCE2t2, CCEnt2 are input related to future demands. It should be noted that the applied carriers entries as they are defined at time t2, may or may not differ from the earlier entries at time t1 and the same applies to the allocated resources ATR21t2, ATR22t2, ATR23t2 . . . ATR2mt2. It should however be noted that just one change in either, a modified entry or a modification in the description or constraints related to available terminal resources preferably should invoke an updating of the updated terminal resource demand relating to the entries unless special circumstances are defined as a room for accepting e.g. latency with respect to updating of the terminal resource plan. Other triggers for updating allocated resource may e.g. be invoked by a user of the system activating an automated optimization procedure, if such procedure is facilitated by the system.

At the time t2 updated carrier entries container CCE1t2, CCE2t2, CCEnt2 are input related to future demands. It should be noted that the applied carriers entries as they are defined at time t2, may or may not differ from the earlier entries at time t1 and the same applies to the allocated resources ATR21t2, ATR22t2, ATR23t2 . . . ATR2mt2. It should however be noted that just one change in either, a modified entry or a modification in the description or constraints related to available terminal resources preferably should invoke an updating of the updated terminal resource demand relating to the entries unless special circumstances are defined as a room for accepting e.g. latency with respect to updating of the terminal resource plan. Other triggers for updating allocated resource may e.g. be invoked by a user of the system activating an automated optimization procedure, if such procedure is facilitated by the system

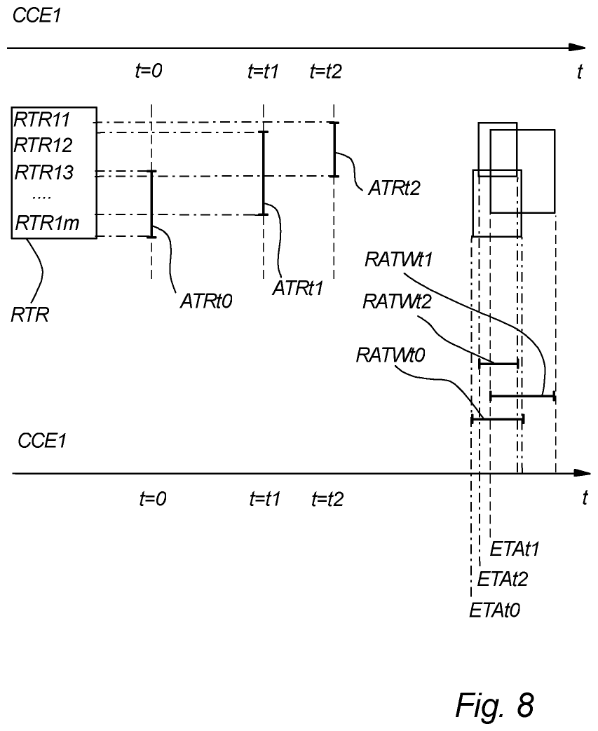

FIG. 8 illustrates a further important feature related an advantageous embodiment of the invention.

A container carrier entry, e.g. the container carrier entry CCE1 referred to in the previous figures, at over time input for processing with reference to the model M or for a modification of an existing model M. The model M and the entry CCE1 is related to a specified terminal.

Representations of available terminal resources RTR are included in the model by respective constraint and optionally relevant mutual constraints. In other words, representations of terminal resources RTR11 . . . RTR1m are a data description of the relevant resources which may be applied for the purpose of executing a container carrier entry. A container carrier entry may in the public space be referred to as a port call.

In essence, the container carrier entry includes at least an associated tentative time of arrival and information regarding a carrier to which the entry is related and also an indication about how many containers the entry relates to for delivery and/or pickup. The tentative time of arrival may to a certain degree be understood conventionally as an estimated time of arrival ETA, but it should be noted that the tentative time of arrival when applied in the context of the invention is intended to cover a continuously modified time, as the inventive technology is in particular aimed and advantageous for the purpose of optimizing and adapting terminal resource plans by moving the tentative arrival time back and forth in time. The same applied to the tentative departure time, which in particular is subject to modification by means of the provisions of the inventive system.

It should be noted that such an entry may be organized and processed in many ways within the scope of the invention. Data may be gathered in records carrying the complete information or preferably be arranged and programmed with pointers to other records.

The container carrier entry CCE1 is input at a time, here illustrated as a time t1. The container carrier entry CCE1 results in a corresponding allocation of a subset of terminal resources. In the present context, terminal resources will from a data perspective be understood as data representations of such resources. Terminal resources may e.g. include quay locations, bollards associated therewith, gangs, etc. Description of such resources and their relevance have been described above.

When allocating resources to the specified container carrier entry CCE1 on the basis of a request, the request will typically include a tentative arrival time. In the present context this tentative arrival time will be regarded as a starting point of when resources of the terminal must be allocated, all calculated at the time t0. Please note that resources may typically be associated with the entry within a resource allocation time window which is starting from the tentative arrival time. It should however be noted that the resource allocation window in principle may include a timing starting from prior the tentative arrival time depending on whether the tentative arrival time is understood as tentative time of berth or whether this time is understood as time of arrival to the terminal sphere. This may be relevant if a terminal includes e.g. a pilot as included in the resource control, as the pilot resource must be allocated a time slot prior to a time slot starting strictly with the time or berthing.

In the present context and for simplification of the present explanation of the concept, the tentative arrival time is simply regarded as an expected time of berthing ETAt0 at the time t0. Time t0 may in this connection be understood as the time at which the initial entry is included in the model M. Typically such initial entry is input weeks or months before the tentative arrival time.

Thus, at time t0, a combination of allocated terminal resources ATRt0 configured from the total set of available terminal resources RTR are included in a preliminary terminal resource plan PTRP. The allocated terminal resources ATRt0 are each associated with time slots within a respective resource allocation time window RATWt0 and the resources are automatically validated by the container carrier terminal system to ensure and provide the tentative arrival time and preferably also a respective tentative departure time related to the entry CCE1.

At time t1, the terminal resource plan is updated into an updated terminal resource plan UTRP. This may be either a result of changes related to terminal resources available for the executing of the respective entry CCE1 in the future, as a result of changes related to the entry CCE1 itself, as a result of changes in other entries already contained or dealt with by the model or it may be inclusion of a new entry related in the model, i.e. as a result of a new port call in the resource plan related to the specified terminal. The update may also be triggered according to time, e.g. at predetermined time intervals, at scheduled update times, coinciding with scheduled low activity times, etc.

The updated resource plan is now, at time t1, including an updated container carrier entry CCE1, where a respective resource allocation time window RATWt1 is including another combinations and ways of using available terminal resources RTR11.TRT1m, e.g. new time slots for specified cranes, other gangs related to the allocated cranes, etc. This updated entry CCE1 is now set to start at a modified future tentative arrival time ETAt1. The illustrates tentative arrival time has in the present illustration been moved further into the future as a result of the automatically validated allocated terminal resources ATRt1.

At time t2, the terminal resource plan is updated again and this has the result that the updated carrier entry CCE1 is to be tentatively operated in a new allocation time window RATWt2.

This updated entry CCE1 is now set to start at a modified future tentative arrival time ETAt2. The illustrated tentative arrival time has been moved back in time as a result of the automatically validated and allocated resources ATRt2. It should be noted that the illustrated entry illustrates a time flow where the entry I automatically validated as from t=t0 and that valid resources have been allocated to the entry. It is however within the scope of the invention either to allow entries into the container carrier terminal system without validation in the sense that terminal resources are not checked for compliance with both existing entries and the new entry. It is however in an embodiment of the invention preferred that the automatic validation from the very time of the inputting of the entry shows whether an entry is associated with violations related to the model forming basis of the system. Such violations may then be dealt with later. In other words, the automatic validation of an entry may include both a positive determination and/or a negative determination of whether it is possible to allocate terminal resources without conflicting with other entries requiring resources already allocated to such entries. Such positive determination may be flagged actively via the user interface, preferably visually. It is however strongly preferred that such negative determination is flagged as soon as possible via the user interface making it clear to the operator that the respective entry at the time being is effectively not operable by the terminal.

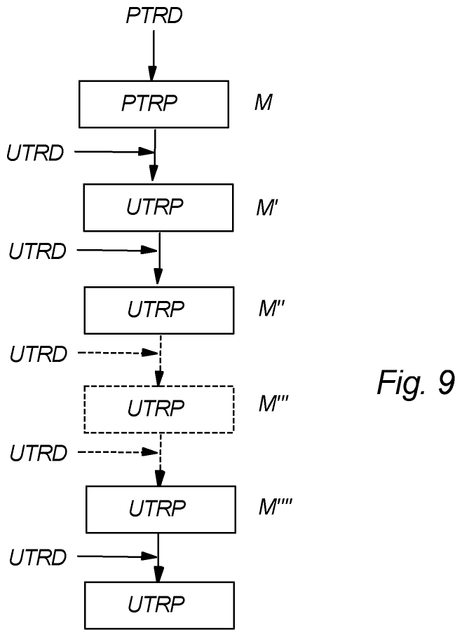

FIG. 9 illustrates how a preliminary terminal resource demand PTRD associated to container carrier entries are resulting in a preliminary terminal resource plan PTRP. It should be noted that the understanding of a preliminary terminal resource plan, e.g. associated with a so-called container carrier entry/port call is that the first established terminal resource plan with respect to this particular container carrier entry is regarded as a preliminary terminal resource plan with respect to this particular new entry, even in spite of the fact that several other entries are already contained and processed in the container carrier terminal system and that the preliminary terminal resource plan to them merely is understood as an updated terminal resource plan UTRP.

This is e.g. the case when an updated terminal resource demand UTRD is happening as illustrated in the flow chart. This updated demand may e.g. be resulting from the inputting of a new entry/request for a new entry, but the specifically illustrated updated terminal resource demand is intended to show that changes in the specific container carrier entry over time. Such change may e.g. relate to information about the associated carrier, a modified tentative arrival time, a modified tentative departure time, a modified number of containers to be delivered, etc.

The updating will continue, typically a very large number of times. The updating may e.g. be performed 1 time per hour or much more often depending of the activity of the specific terminal and also depending on how often entries are modified. Each time the result is a new updated terminal resource plan.

If the illustrated flow chart represents the “travel” of a specific container carrier entry, the last updated terminal resource plan will be the resource plan according to which the specific entry is handled. Please again note that multiple container carrier entries are also processed and contained at the same time in the updated terminal resource plan as the other container carrier entries “travels” through the model.

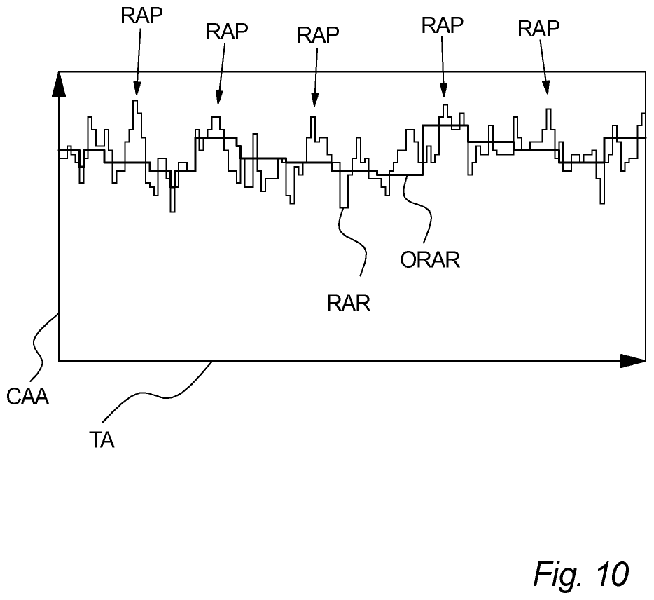

FIG. 10 illustrates a comparison of resource allocation representations. The panel of the figure has a horizontal time axis TA which represents time, where the full extend of the axis corresponds to a week. The panel further has a vertical crane allocation axis CAA which represents a number of allocated cranes.

A resource allocation representation RAR shows the number of allocated cranes in a container carrier terminal which do not operate according to a method of the invention. The shown curve resource allocation representation RAR is based on an exemplary resource allocation of a real container carrier terminal. The curve features many protrusions; it regularly has minima and maxima throughout the extent of the time axis. In other words, the resource allocation representation has a relatively large standard deviation with respect to its average. This represents that the number of allocated cranes throughout the week is relatively irregular. Particularly, several periods of resource allocation peaks RAP are present, in which a large number of cranes are allocated.

The occurrence of resource allocation peaks RAP may be considered a problem of container carrier terminal operations. In such periods, goods are more likely to be delayed, since resources, such as quay cranes, may be lacking. Particularly, a terminal resource demand may exceed the available terminal resources. A constantly changing number of allocated quay cranes may further lead to an increased wear of the quay cranes.

As such, resource allocation peaks RAP are highly undesirable within the field of container carrier terminal operation.

The figure further illustrates another resource allocation representation ORAR—an optimized resource allocation representation. This resource allocation has been achieved using an embodiment of the invention. The embodiment is based on a partial automatic allocation of terminal resources performed using a machine learning-based algorithm configured for reducing resource allocation peaks.

In comparison with the un-optimized resource allocation representation RAR, the optimized resource allocation representation ORAR features no prominent resource allocation peaks RAP.

Note that the areas the curves RAR,ORAR, i.e. the definite integrals of the two curves RAR,ORAR extending the entire duration of the time axis TA, are approximately the same. In the two resource allocation representations RAR,ORAR, the total number of allocated quay crane hours are thus similar, but due to the complexity of resource allocation in container terminals, it is extremely difficult to avoid resource allocation peaks within the prior art.

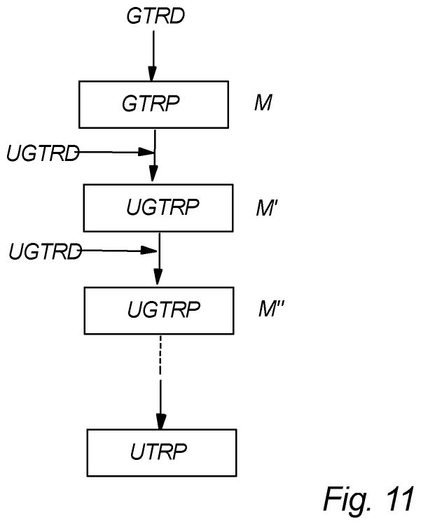

FIG. 11 illustrates a further advantageous feature of embodiments of the invention.

The container carrier terminal system CCTS is in this embodiment configured to handle simultaneous ghost entries GE of one or more container carrier entries CCE already contained and validated in the current active terminal resource plan. The ghost entry may also be understood as an entry which does not presently exist in the terminal resource plan. The first type of ghost entry may be applied and utilized for an intended modification of an existing entry without compromising the database containing entries of the current active terminal resource plan. The current terminal resource plan may also be understood as relying and operating on a master database. The latter type of ghost entry may simply be a way of checking an entry with respect to validity prior to inputting into the master database. The present embodiment may in particular also be relevant when matching a demand to terminal resources and in particular when such resources need to be maintained and when such maintenance must be reflected in an updated terminal resource plan.

Initially a copy of the at any time current terminal resource plan is made from the master database and the copy is here referred to as a ghost terminal resource plan GTRP. The resource plan may from here be modified within affecting the master database. The ghost terminal resource plan includes ghost information about presently contained container carrier entries and presently respective allocated terminal resources. A modification, either made by means of an automatic optimization routine or manually by a user e.g. by inserting the ghost entry via a suitable user interface may then be applied to the ghost terminal resource plan as an update ghost terminal resource demand and a new updated ghost terminal resource plan is generated. This may happen a number of times, each time assisted by an automated validation of the modified entry/the modified entries and of course an automated validation of other entries of the ghost database affected or potentially affected by the modified ghost entry. When finally a ghost entry has been modified satisfying the needs of the user and complying with the complete updated ghost terminal resource plan of ghost entries and associated constraints of allocated resources, the ghost entries may be transferred to the existing master database and thereby resulting in an updated terminal resource plan. A supplemental validation of the entry or entries may be appropriate in the master plan, the now updated terminal resource plan, if there in the meantime has been made changes in other entries, demands or resources in the master data base.

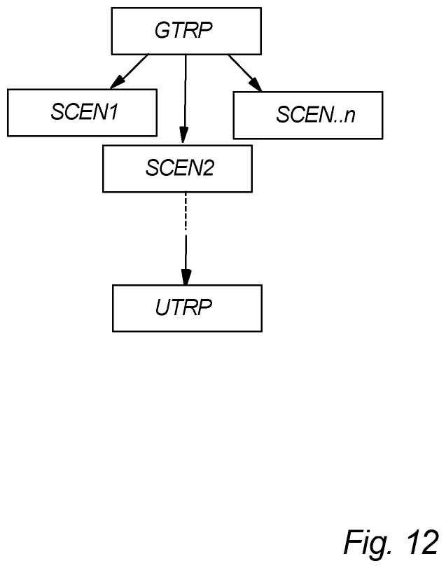

FIG. 12 illustrates a further advantageous technical feature of the invention, namely the features related to the application of multiple scenarios.

In a ghost database derived from the master database, the principle explained above, a user may modify selected entries, here ghost entries. These entries may e.g. be modified in order to fit other entries into an already updated and current terminal resource plan.

The system thus provides for the application of different scenarios, here SCEN1, SCEN2 and SCENn. In these different scenarios a user of the system may check different ways of modifying one or more container carrier entries in order to optimize or fit them into the plan. This task may sometimes be a difficult on, and the application of different scenarios makes it possible for a user to check different ways of modifying entries without compromising the master data base.

One, two or more (here n) scenarios may be tested, and when a useful configuration of allocated terminal resources has been found in combination with modified container carrier entries, these entries may be transferred into the master database and an updated terminal resource plan UTRP has been created.

It should be noted that the multiple scenario design within the scope of the invention is in particular useful as the system is designed for automatic validation of the entries affected of each scenario. A user may thus be able to intuitively check different ways of configuring the entries, typically related to a need of a modifying an entry with respect to e.g. a tentative time of arrival, number of containers to be dealt with, etc.

The present embodiment may in particular also be relevant when matching a demand to terminal resources and in particular when such resources need to be maintained and when such maintenance must be reflected in an updated terminal resource plan and where multiple alternative scenarios are used in order to find the right one.

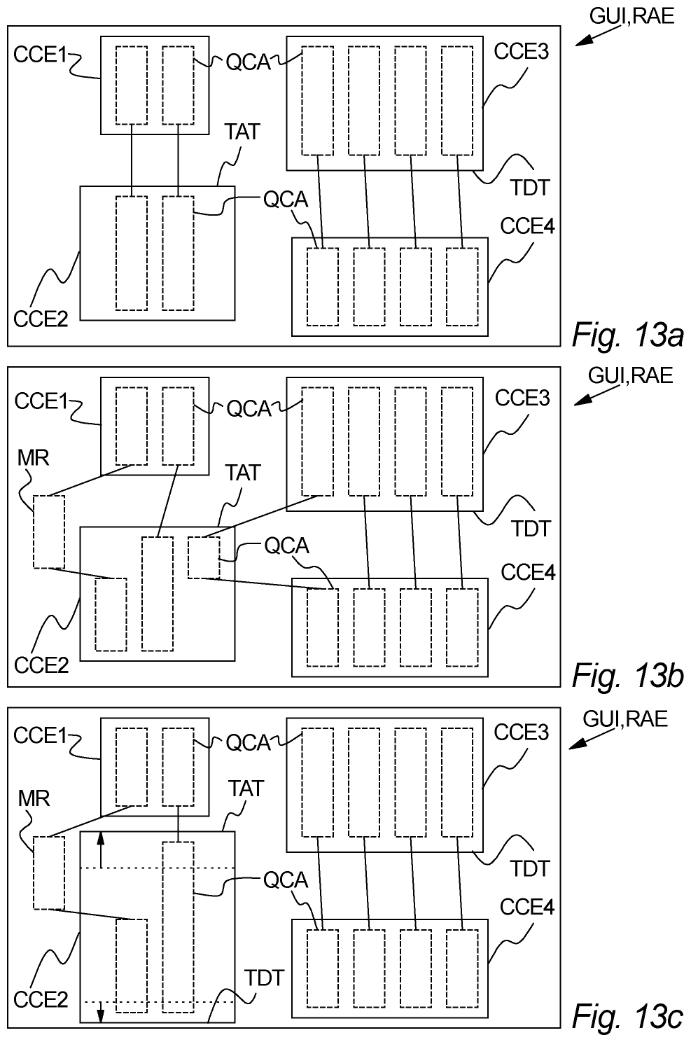

FIG. 13a-c illustrate examples of implementation of maintenance according to the invention.

As in FIG. 5a-c, each of the subfigures 13a, 13b, and 13c is a graphical user interface GUI showing a representation of a resource allocation environment RAE. The vertical direction in each of the subfigures indicate time, and the horizontal direction indicate position along the quay of the container carrier terminal. And again, this is part of a container carrier terminal system, thus allowing a user to manage quay crane allocations QCA with respect to container carrier entries CCE. Furthermore, in this embodiment, the container carrier terminal system is configured to facilitate maintenance according to the invention.

In FIG. 13a, a plurality of container carrier entries CCE are shown in in the graphical user interface GUI. A total of six cranes have been allocated to four container carrier entries CCE, and allocation of a quay crane to several quay crane allocations QCA is indicated by lines extending between these quay crane allocations QCA.

At a point during operation, it becomes apparent that one of the quay cranes require maintenance. The quay crane requiring maintenance is associated with the left-most quay crane allocations QCA. The subfigures 13b and 13c show two possible solutions to this issue which may be facilitated by embodiments of the invention.

In FIG. 13b, a maintenance representation MR has been implemented in the container carrier terminal system, which works as a constraint for the corresponding quay crane. Note that for the duration of the maintenance (indicated by the height of the maintenance representation MR), the corresponding quay crane does not have a quay crane allocation QCA. In other words, quay crane maintenance functions as a constraint in the container carrier terminal system. This type of maintenance, which was previously not planned, may also be considered as updated terminal constraints.

As a response to the maintenance, the quay cranes have been reallocated, which is also apparent by comparison with FIG. 13a. The allocation has been performed automatically along with validation by an optimization routine. The quay crane which undergoes maintenance is not only allocated for a part of the berth time of the relevant container carrier entry CCE2. In order to avoid delays of this container carrier (container carrier entry CCE2), which could otherwise have been delayed due to the maintenance, an additional quay crane has been allocated to the container carrier entry CCE2. This quay crane has been allocated without affecting operations related to the other container carrier entries CCE3, CCE4. Thus, the invention has permitted implementation of maintenance and allocation of quay cranes as a response to (updated) terminal constraint, without introducing any delays to container carriers.

In some situations, it may not be possible to react to maintenance without affecting arrival and/or departure times of container carriers. This is the situation illustrated in FIG. 13c. As in 13b, a quay crane is unavailable due to maintenance. However, in the particular situation of FIG. 13c, other quay cranes cannot be reallocated to the relevant container carrier entry CCE2. Nevertheless, reallocation is performed automatically along with validation by an optimization routine. As a part of this process, the tentative arrival time and the tentative departure time of the relevant container carrier entry CCE2 is changes to ensure that the required number of containers moves can be performed during berth. The changed arrival and departure times are indicated by arrows and are also visible by comparison with FIG. 13a. To ensure these new arrival and departure times are acceptable, a berth planner has contacted a captain of the relevant container carrier. Thus, the invention has permitted implementation of maintenance and allocation of quay cranes as a response to (updated) terminal constraint.

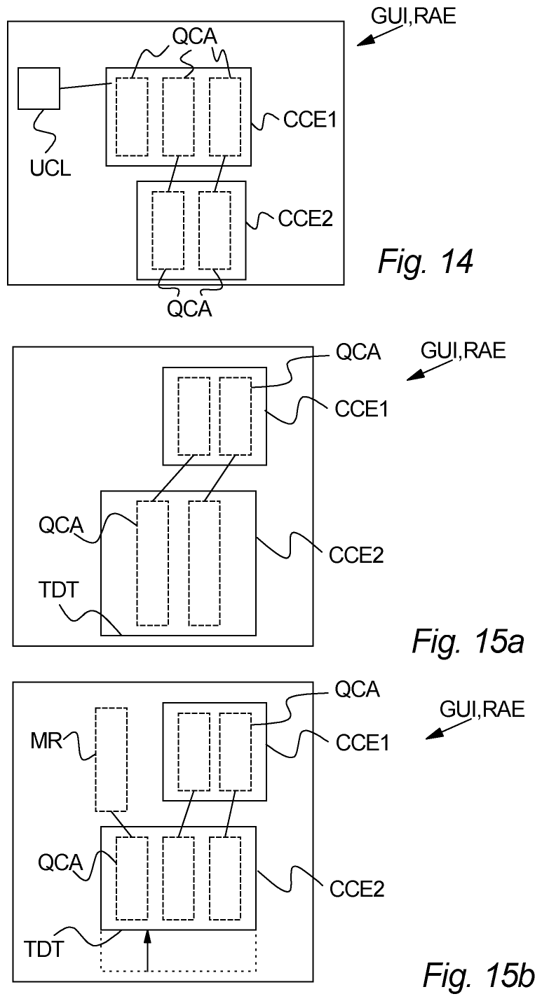

FIG. 14 illustrates deprioritizing of an unhealthy crane according to the invention.

As in FIGS. 5a-c and 13a-c, the figure shows a graphical user interface GUI showing a representation of a resource allocation environment RAE as a part of a container carrier terminal system.

In this embodiment, three quay cranes are available for allocation. All three quay cranes have been allocated to a first container carrier entry CCE1. However, the following container carrier entry CCE2 is associated with a container carrier which can only accommodate two quay cranes, and thus only two quay crane allocations QCA, at a time.

One of the three quay cranes is labelled with an unhealthy quay crane label UCL. It has received this label due to a history of breakdowns, which have been recorded in a database. Upon recognizing that this particular quay crane has significantly more breakdowns than the other quay cranes, it has been associated with the unhealthy quay crane label UCL.

As a consequence, when terminal resources are allocated via the container carrier terminal system, the unhealthy quay crane is deprioritized. This is clearly showing in the figure, where the two quay cranes which are not unhealthy have been allocated to the second container carrier entry CCE2. This minimizes risk of breakdown during berth of the container carrier associated with this container carrier entry CCE2.

FIG. 15a-b illustrate another example of implementation of maintenance according to the invention.

As in FIGS. 5a-c and 13a-c, each subfigure 15a and 15b shows a graphical user interface GUI showing a representation of a resource allocation environment RAE as a part of a container carrier terminal system.

FIG. 15a illustrates a preliminary terminal resource plan, where two quay cranes have been allocated to two container carrier entries CCE1 and CCE2. A third quay crane is also present at the container carrier terminal of the container carrier terminal system. However, this quay crane is currently inoperable, and is thus not allocated in the container carrier terminal system.

Due to available maintenance resource, maintenance is planned of the inoperable quay crane, as indicated by the maintenance representation MR shown in FIG. 15b. A scheduled maintenance of the quay crane permits the scheduling allocation of that quay crane after expected completion of the maintenance. As a result, three quay crane allocations QCA can be allocated to the latest container carrier entry CCE2. Consequently, the tentative departure time associated with the container carrier of that container carrier entry CCE2 can be moved, which is advantageous.

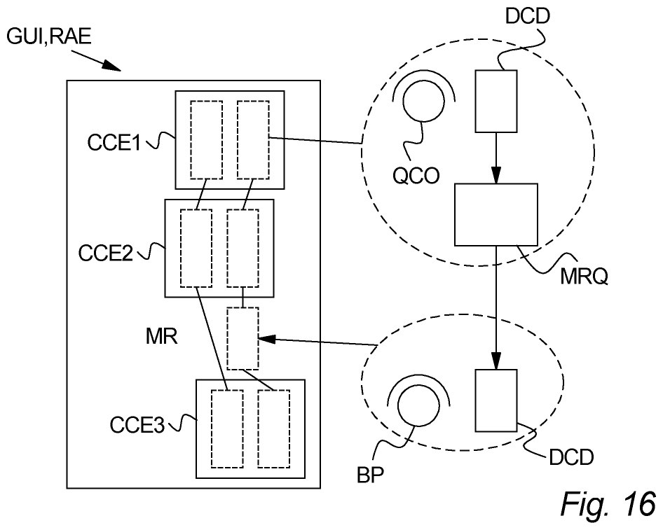

FIG. 16 illustrates a maintenance request and resulting planning of maintenance according to the invention.

The left part of the figure shows a graphical user interface GUI showing a representation of a resource allocation environment RAE as a part of a container carrier terminal system, as in FIGS. 5a-c and 13a-c.

Here two quay cranes have been allocated to three container carrier entries CCE1, CCE2, CCE3. During operation of the container carrier entry CCE1, a quay crane operator QCO of one of the quay cranes recognize that the quay crane does not operate fully as intended, without the quay crane being inoperable as such. For example, the quay crane is more noisy than usual, which the operator QCO knows is a sign of wear, which might lead to breakdown if maintenance is not performed soon.

To address this issue, the quay crane operator provides a maintenance request MRQ via a digital communication device to a berth planner BP, which receives the request via his own digital communication device. Such digital communication devices may be linked up to the container carrier terminal system, or may function independently of the terminal system.

Based on the received request, the berth planner BP now knows that it as necessary to plan maintenance of the relevant quay crane soon. The berth planner BP use the container carrier terminal system to plan maintenance of the relevant quay crane, and with aid of the terminal system, an idle duration of time suitable for the maintenance is identified. Thus, maintenance is planned without affecting operations.

The maintenance request may optionally comprise description of the problem, requested time, terminal resource to be maintained, etc. The maintenance request may for example also relate to quay maintenance.

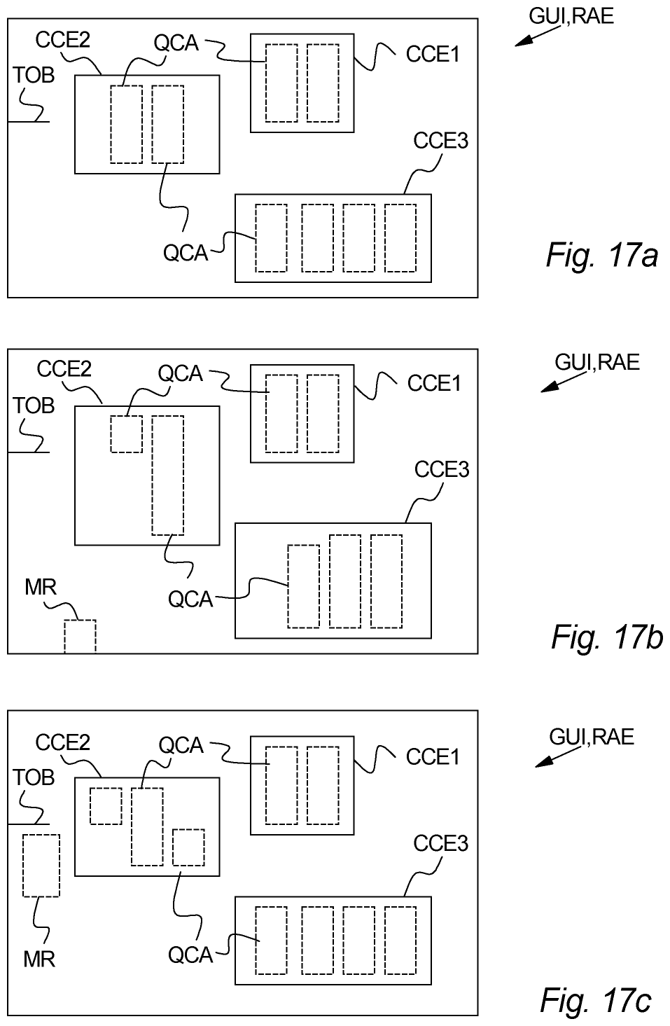

FIG. 17a-c illustrates solution to breakdown maintenance according to the invention.

As in FIGS. 5a-c and 13a-c, each subfigure 17a, 17b, and 17c shows a graphical user interface GUI showing a representation of a resource allocation environment RAE as a part of a container carrier terminal system.

In FIG. 17a, a three of container carrier entries CCE are shown in the graphical user interface GUI. A total of four cranes have been allocated to the container carrier entries CCE. Early in the plan, the four quay cranes are distributed across two container carrier entries CCE1, CCE2, and later, the quay cranes are allocated to one container carrier entry CCE3.

During operations of the container carrier associated with the second container carrier entry, one of the quay cranes (associated with the left-most quay crane allocation) undergoes a sudden breakdown and cannot be used further for operations. The point in time of this breakdown is indicated by a time of breakdown TOB, shown in all subfigures. The subfigures 17b and 17c show two possible outcome situations and corresponding solutions to this issue in the form of resource plans which may be obtained by embodiments of the invention.

In the situation illustrated in FIG. 17b, it is not possible to schedule maintenance immediately, which is indicated by the maintenance representation MR which is visible in the bottommost part of the graphical user interface GUI. Nevertheless, the quay crane which has undergone breakdown is inoperable, and hence, it is not allocated after the time of breakdown TOB. Optionally, the inoperability of the quay crane may be indicated in the user interface, for example through a label or a representation of inoperability/breakdown.

As a response to the breakdown, quay cranes have been reallocated via the container carrier terminal system, which is apparent by comparison of FIG. 17b with FIG. 17a. The allocation has been performed automatically along with validation by an optimization routine. Note particularly that the quay crane which undergoes maintenance is not allocated after the time of breakdown TOB. Hence, only three quay cranes are allocated to container carrier entries at any point in time after the time of breakdown.

The breakdown has let to later tentative departure times for the two later container carrier entries CCE2, CCE3, but nevertheless, the invention has permitted allocation of resources which takes breakdown/maintenance into account. Thus, a resource plan has been obtained which, at least partly, fulfils the required container operations in relation to berthing of the container carriers.

FIG. 17c illustrates an alternative situation than the one illustrated in FIG. 17b. In FIG. 17c, it is possible to schedule maintenance immediately. As a response to the breakdown, the maintenance is planned and quay cranes have been reallocated via the container carrier terminal system, which is apparent by comparison of FIG. 17c with FIG. 17a. The allocation has been performed automatically along with validation by an optimization routine. Due to the breakdown, the quay crane which undergoes maintenance is not allocated immediately after the time of breakdown TOB. However, due to the scheduled maintenance MR, it is allocated after that maintenance (to the latest container carrier entry CCE3). Furthermore, an additional quay crane allocation has been allocated to the second container carrier entry CCE2. As a result, the tentative departure times were not delayed, despite the sudden breakdown.

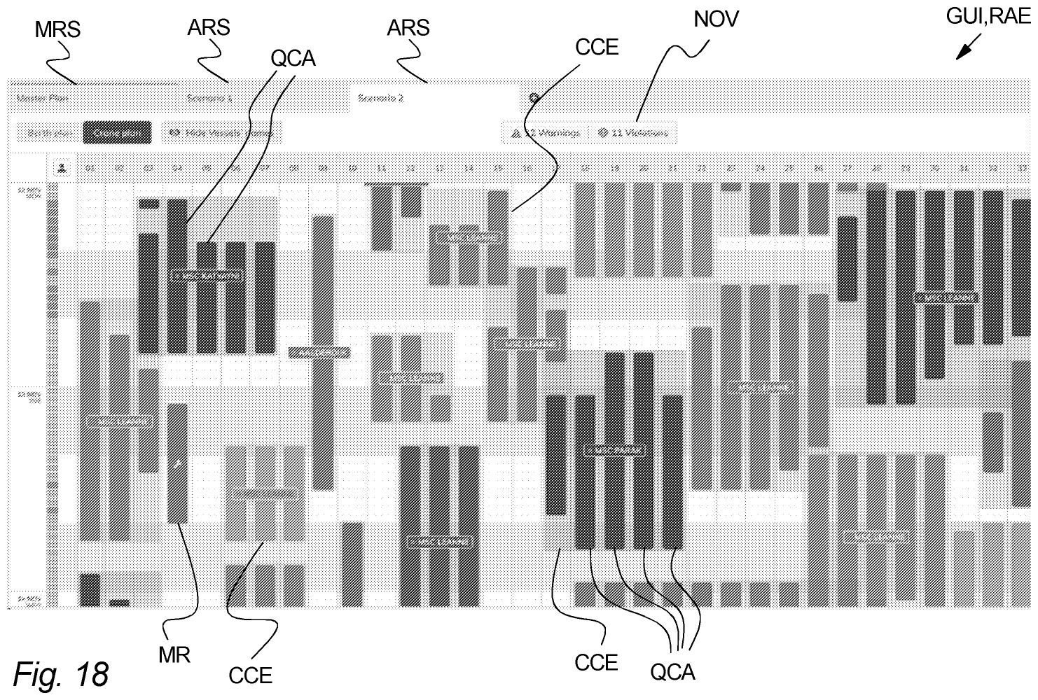

FIG. 18 illustrates an exemplary graphical user interface according to an embodiment of the invention.

As in some previous figures, the user interface GUI shows a representation of a resource allocation environment RAE which as a part of a container carrier terminal system according to an embodiment of the invention. In contrast to previous figures, the horizontal axis here does not correspond to the quay, but to crane number, as indicated by the crane numbers 01-33. Thus, every vertical column shows how a quay crane is allocated to one or more container carrier entries CCE. Each container carrier entry CCE is indicated with a shaded rectangular area.

The figure additionally shows the a crane (numbered “04”) is allocated for maintenance through a maintenance representation MR.

Additionally, the figure shows how a user interface may give access to multiple resource scenarios. The shown resource plan is one of several resource scenarios, namely an auxiliary resource scenario ARS. Another auxiliary resource scenarios and the master resource scenario may be accessed by a user via tabs, for example, via a mouse click on one of the tabs. Thus, the user may rapidly and efficiently compare various possible resource scenarios and update the master resource scenario for operation of the terminal whenever an improved resource plan has been established in an auxiliary resource scenario ARS. Preferably each scenario is validated by the configurator, i.e. the container carrier terminal system, before one is chosen to be activated and used.

Moreover, the user figure indicates one possible way to provide a notice of violation NOV according to the invention. In the present context all validation may be performed automatically unless specifically otherwise noted.

At least two principally different ways of initiating a validation may be applied within the scope of the invention. A fully automatic initiation which simply validates when instructed by the planning program logic. Such autonomous validation may not necessary be overruled by a semi-automatic validation which is automatically initiated when a user of a user interface provides inputs e.g. modification(s) of container carrier entries, additions or removals of container carrier entries, modifications of existing available terminal resources, additions or removals terminal resources, modifications of constraints such as maintenance etc.

A validation in the present context can for example involve an analysis of whether one, all, or a group of container carrier entries are “matched” with allocated terminal resources. In other words, are the demands related to the container carrier entries fulfilled by the terminal resources allocated to the container carrier entries already input and made active in the a preliminary PTRP or updated terminal resource plan UTRP. It may also refer to a non-validated terminal resource plan of ghost entries which is in its making e.g. on the basis of a modification of an active updated terminal resource plan UTRP. Such validation may thus be made on ghost data of one scenario based on a modification of an existing terminal resource plan, preliminary or updated terminal resource plan, but it may also be performed on several alternative scenarios of which a berth planner may choose to make one of these active as an updated terminal resource plan.

A validation may be performed if something has changed in the existing active distribution of container carrier entries vs respective allocated terminal resources and upon registration by manual input of this change by a user of the user interface or by an automatic registration of the change, an automatic validation is performed across all configured container carrier entries vs respective allocated terminal resources. Such a validation may in the present context not only just validate whether the allocation is OK, but it can optionally also result in a warning displayed or otherwise communicated to a user of the container carrier terminal system planning system (which may also be referred to and understood as a berth plan configurator), if the it turns out the present demands as expressed by the container carrier entries (and optional associated logic) are not met validly by the presently allocated terminal resources.

Factors relevant for such demands may e.g. refer to time, ETA and ETD, number of containers to be unloaded, which resources are available for the unloading, berth locations, cranes, crane gangs etc.

A validation may also be performed for the purpose of checking whether a auxiliary resource scenario is valid before implementing that scenario as the master resource scenario in an updated terminal resource plan UTRP. In other words, such a situation may occur upon a determination the existing berth plan/resource plan is not valid anymore (e.g. due to updated constraints or demands) and now the berth planner and/or an automatic routine are trying to figure out which adjustments to implement to ensure that allocated resources comply with demands once again. This may not always be an easy task and in an advantageous embodiment of the invention, changes of an existing and active berth plan are not made before the considered changes are validated by the system, e.g. as one or more alternatives which may be checked/validated before being made active as an updated terminal resource plan.

In other words, the container carrier terminal system enables that a user may validate a plan before making it active as well as validate the resource plan automatically if changes has occurred in relation to container carrier entries, allocated terminal resource, demands, or constraints such as maintenance.

It should be noted that the above changes may of course relate to if a container carrier entry is added or deleted, and if terminal resources are added or deleted, but the changes may preferably also include changes in demands, such as ETA and ETD, number of containers to be unloaded, and also whether the allocated resources has a modified performance, e.g. a part of the berth is not available, a crane is now non-available in relation to maintenance, a crane is now more or less efficient due to maintenance or availability of a more or less efficient gang, a crane is not applicable for certain berth positions due to another crane down for maintenance which is blocking the track, etc.

In other words, changes which preferably trigger automatic validation includes modified demand and modified resources.

A validation in the present context should preferably also result in a communication, e.g. by displaying, one or more factual conflicts/violations if such are available and the validation should preferably also result in the that such conflicts are categorized such that a manual operator of the configurator, i.e. the container carrier terminal system, is able to perceive the detected conflicts and make a modification of the berth plan on the basis of these. Such categorization of conflicts may include determination that specific cranes are now “double booked” or that specific cranes are already booked (if trying to validate a new container carrier entry) and the quantization could also include when the specific crane(s) are available or not.

This categorization may advantageously also be present and provided to a user upon a positive validation, i.e. if it turns out that the berth planner has succeeded in finding a new way of implementing allocations which comply with the demands. This may in particular be of user for a berth planner when the berth planner seeks to find more and alternative configurations to meet the same demand. This may e.g. be performed by working out separate resource scenarios and automatically having these validated. It may of course be very difficult to find a valid new configuration, e.g. if a demand it updated (e.g. a new ETA) or if a crane is requiring planned or acute maintenance, but it is even more difficult to find and optimize a new configuration where the allocated resources match the demand.

In an advantageous embodiment of the invention, the configurator, i.e. the container carrier terminal system, allows the planner to work with multiple alternative scenarios prior to making one of these active but the validation not only provides quantized (detailed) warning if a scenario is not valid, but also provides details if the scenario is valid. Such details could e.g. be an overall automatic calculation of the added cost in relation to gangs/workforce of a certain configuration is used. Several other parameters may also be outputted for the assisting of the berth planner to determine which valid scenario to choose and activate.

In a further embodiment of the invention, such classifications may be both shown (made available, e.g. be automatically displayed) to the berth planner. The respective quantization of the different scenarios may also be logged for the training of artificial intelligence to determine typical priorities made when a berth planner chooses one scenario over another. This may be used for an automatic computer-made choosing of one scenario over another/others scenario(s) or at least an automatic prioritizing of these scenarios which may be communicated to the berth planner for the assisting of the berth planner in choosing the optimal valid scenario among a number of valid scenarios.

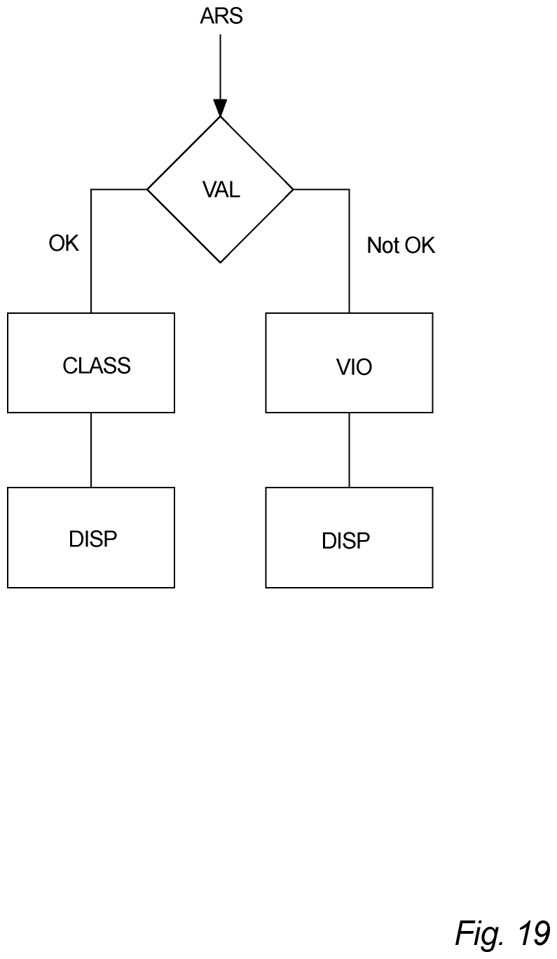

FIG. 19 illustrates a flow chart of a computer-implemented validation according to an embodiment of the invention, where an auxiliary resource scenario ARS is to be validated before being considered for activation and use as a master resource scenario/updated terminal resource plan. The auxiliary resource scenario may e.g. be established to figure out how to handle a planned maintenance or urgent breakdown maintenance in an optimal way.

The auxiliary scenario ARS is initially validated by a validation process by data processing equipment DPE (as shown in FIG. 3) in the process step VAL.

If outcome of the validation is that the auxiliary scenario is OK (e.g. no violations present, e.g. the allocated resources comply fully with the resource demand), the auxiliary scenario is then classified in a classification step CLASS. The classification involves that a number of different aspects, e.g. cost related to the specific maintenance used in the validated auxiliary scenario. Further costs may also be included in relation to the classification of the validated scenario, which may e.g. include classification of induced and required delays of container carrier entries involved in the establishment a new and valid berth plan, cost related to use of gangs in the scenario, priority given to certain container carrier operators etc.

Such classifications may then be stored and logged in a database and also displayed to a user in graphical user interface in the step DISP.

If, on the other hand the auxiliary scenario is turning out to be non-OK in the validation step VAL, the in-validity of the scenario is categorized in step VIO so as to allow the berth planner to find out where the conflicts are and preferably also the extent of the conflict. Such a validation step may for example be accompanied by a notice of violation.

The result is then displayed in a display step DISP and the result may also be stored and logged in a database.

The illustrated validation may be repeated for each auxiliary scenario and for each time an auxiliary scenario is updated with respect to demands and/or terminal resources.

### LIST OF REFERENCE SIGNS

ARS Auxiliary resource scenario
BP Berth planner
CAA Crane allocation axis
CADR Crane allocation data record
CC Container carrier
CCDR Container carrier data record
CCE Container carrier entry
CCEDR Container carrier entry data record
CCT Container carrier terminal
CCTDR Container carrier terminal data record
CCTS Container carrier terminal system
DCD Digital communication device
DPE Data processing equipment
GADR Gang allocation data record
GDR Gang data record
GUI Graphical user interface
MDR Maintenance data record
MR Maintenance representation
MRQ Maintenance request
MRS Master resource scenario
NOV Notice of violation
ORAR Optimized resource allocation representation
Q Quay
QC Quay crane
QCA Quay crane allocation
QCO Quay crane operator
QCR Quay crane data record
QL Quay length
RAE Resource allocation environment
RAP Resource allocation peak
RAR Resource allocation representation
SC Shipping container
SR Sailing route
TA Time axis
TAT Tentative arrival time
TOB Time of breakdown
TDT Tentative departure time
UQCL Unhealthy quay crane label

1-197. (canceled)

198. A method of operating a container carrier terminal, comprising the steps of:
providing a computer-implemented container carrier terminal system comprising a model of said container carrier terminal executed on data processing equipment, said model comprising representations of terminal resources and terminal constraints relating to said terminal resources,
wherein said terminal resources comprise a plurality of quay cranes;
said representations of terminal resources including representations of said plurality of quay cranes;
inputting, in said container carrier terminal system a plurality of container carrier entries, each container carrier entry relating to a container carrier and associated with a preliminary terminal resource demand including a tentative arrival time, wherein said tentative arrival time is indicative of arrival of said container carrier to said container carrier terminal; and
allocating a respective subset of said terminal resources to each container carrier entry of said plurality of container carrier entries to obtain a preliminary terminal resource plan of allocated terminal resources, wherein said step of allocating terminal resources comprises automatically validating said allocated terminal resources of the container carrier entries,
the allocated terminal resources including a subset of said plurality of quay cranes, wherein the validating includes automatically establishing whether the allocated terminal resources of the container carrier entries comply with said terminal constraints and said preliminary terminal resource demand associated with said plurality of container carrier entries, and wherein said terminal constraints comprises maintenance related to one or more of said terminal resources.

199. The method according to claim 198, wherein said maintenance is associated with a maintenance time period of said preliminary terminal resource plan.

200. The method according to claim 199, wherein said method comprises a step of planning said maintenance, and wherein said step of planning said maintenance comprises allocating said maintenance to said maintenance time period.

201. The method according to claim 200, wherein said method comprises a step of receiving a maintenance request related to one or more of said terminal resources, and wherein said step of planning said maintenance is based on said maintenance request.

202. The method according to claim 198, wherein said maintenance comprises quay crane maintenance, and wherein a quay crane representation of said representations of said plurality of quay cranes is associated with said quay crane maintenance.

203. The method according to claim 198, wherein said maintenance comprises one or more of quay maintenance, bollard maintenance, dredging maintenance, or cleaning maintenance.

204. The method according to claim 198, wherein said method comprises a step of recording maintenance data based on said maintenance, and wherein said maintenance data is added to a historic maintenance database.

205. The method according to claim 200, wherein said step of planning said maintenance is based on a historic maintenance database, and wherein said step of planning said maintenance is at least partly performed using a maintenance planning algorithm.

206. The method according claim 205, wherein said maintenance planning algorithm suggests maintenance based on said preliminary terminal resource plan.

207. The method according to claim 198, wherein said method further comprises a step of providing an updated terminal resource demand relating to at least one of said plurality of container carrier entries; and wherein said method further comprises a step of processing an updated terminal resource plan on the basis of said updated terminal resource demand by means of said computer implemented container carrier terminal system.

208. The method according to claim 207, wherein said updated terminal resource demand is provided based on output from one or more container carriers and/or provided based on output from a control center associated with at least one of said one or more container carriers.

209. The method according to claim 198, wherein said container carrier terminal system is associated with a database comprising at least one maintenance data record, and wherein each of said at least one maintenance data record is associated with maintenance of a respective quay crane of said plurality of quay cranes.

210. The method according to claim 198, wherein said container carrier entries are inputted in a resource allocation environment of said container carrier terminal system, and wherein said resource allocation environment is represented by a graphical user interface of said container carrier terminal system.

211. The method according to claim 198, wherein said representations of terminal resources comprises representations of any of one or more physical quay lengths, one or more physical bollards, and one or more physical gangs.

212. The method according to claim 198, wherein said preliminary terminal resource demand comprises one or more of a container carrier length, a tentative departure time, or an indication of a cargo capacity to be unloaded, loaded and/or redistributed from said container carrier to said container carrier terminal during said container carrier entry.

213. The method according to claim 198, wherein said method further comprises a step of updating said tentative arrival time and/or a tentative departure time based on said maintenance.

214. The method according to claim 198, wherein said terminal constraints comprises one or more of quay depth, quay crane move restrictions, or weather restrictions.

215. The method according to claim 198, wherein said step of allocating a respective subset of said terminal resources to each container carrier entry of said plurality of container carrier entries comprises allocating a respective quay position to each container carrier entry of said plurality of container carrier entries.

216. The method according to claim 198, wherein said automatically validating and/or distributing terminal resources is performed on the basis of an optimization routine, and wherein said optimization routine is arranged to distribute terminal resources to comply with said terminal constraints and said preliminary terminal resource demand and to optimize distribution of terminal resources with respect to one or more optimization targets.

217. A computer-implemented container carrier terminal system comprising data processing equipment configured to execute a model of a container carrier terminal, said model comprising representations of terminal resources and terminal constraints relating to said terminal resources; said terminal resources comprising a plurality of quay cranes and said representations of terminal resources including representations of said plurality of quay cranes;
the container carrier terminal system comprising an input configured to receive a plurality of container carrier entries, each container carrier entry relating to a container carrier and associated with a preliminary resource demand including a tentative arrival time, wherein said tentative arrival time is indicative of arrival of said container carrier to said container carrier terminal;
the container carrier terminal system being configured to allocate a respective subset of said terminal resources to each container carrier entry of said plurality of container carrier entries to obtain a preliminary terminal resource plan of allocated terminal resources, wherein said allocation comprises automatically validating and/or distributing terminal resources, including said plurality of quay cranes, to said plurality of container carrier entries to comply with said terminal constraints and said preliminary terminal resource demand associated with said plurality of container carrier entries, and wherein said terminal constraints comprises maintenance related to one or more of said terminal resources.
